(19) United States
(12) Patent Application Publication
(10) Pub. No.: US 2026/0197832 A1
(43) Pub. Date: Jul. 9, 2026

(54) UE REPORTING TRIGGERED BEAM SWITCHING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/422,318

(22) Filed: Dec. 16, 2025

Related U.S. Application Data
(60) Provisional application No. 63/742,746, filed on Jan. 7, 2025.
(60) Provisional application No. 63/744,676, filed on Jan. 13, 2025.
(60) Provisional application No. 63/746,091, filed on Jan. 16, 2025.
(60) Provisional application No. 63/747,578, filed on Jan. 21, 2025.
(60) Provisional application No. 63/756,546, filed on Feb. 10, 2025.

(51) Int. Cl. H04W 72/21; H04B 7/06

(52) U.S. Cl. CPC H04W 72/21; H04B 7/0626; H04B 7/06968

(57) ABSTRACT

Methods and apparatuses for user equipment (UE) reporting triggered beam switching. A method performed by a UE includes receiving first information related to UE-initiated beam switching, determining, based on the first information, a physical uplink control channel (PUCCH) resource to transmit a UE-initiated beam switching indicator, and transmitting the UE-initiated beam switching indicator on the PUCCH resource. The method further includes determining a physical uplink shared channel (PUSCH) resource to transmit a UE-initiated beam switching report, transmitting, on the PUSCH resource, the UE-initiated beam switching report including second information related to a transmission configuration indication (TCI) state, receiving a response to the UE-initiated beam switching report, and applying the TCI state.

### CROSS-REFERENCE TO RELATED AND CLAIM OF PRIORITY

The present application claims priority under 35 U.S.C. § 119(e) to U.S. Provisional Patent Application No. 63/742,746 filed on Jan. 7, 2025; U.S. Provisional Patent Application No. 63/744,676 filed on Jan. 13, 2025; U.S. Provisional Patent Application No. 63/746,091 filed on Jan. 16, 2025; U.S. Provisional Patent Application No. 63/747,578 filed on Jan. 21, 2025; and U.S. Provisional Patent Application No. 63/756,546 filed on Feb. 10, 2025, each of which are hereby incorporated by reference in their entirety.

### TECHNICAL FIELD

The present disclosure relates generally to wireless communication systems and, more specifically, the present disclosure relates to methods and apparatuses for user equipment (UE) reporting triggered beam switching.

### BACKGROUND

Wireless communication has been one of the most successful innovations in modem history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE reporting triggered beam switching.

In one embodiment, a user equipment (UE) is provided. The UE includes a transceiver configured to receive first information related to UE-initiated beam switching and a processor operably coupled with the transceiver. The processor is configured to determine, based on the first information, a physical uplink control channel (PUCCH) resource to transmit a UE-initiated beam switching indicator. The transceiver is further configured to transmit the UE-initiated beam switching indicator on the PUCCH resource. The processor is further configured to determine a physical uplink shared channel (PUSCH) resource to transmit a UE-initiated beam switching report. The transceiver is further configured to transmit, on the PUSCH resource, the UE-initiated beam switching report including second information related to a transmission configuration indication (TCI) state and receive a response to the UE-initiated beam switching report. The processor is further configured to apply the TCI state.

In another embodiment, a base station (BS) is provided. The BS includes a processor and a transceiver operably coupled with the transceiver. The transceiver is configured to transmit first information related to a UE-initiated beam switching, wherein the first information indicates a PUCCH resource for a UE-initiated beam switching indicator and receive the UE-initiated beam switching indicator on the PUCCH resource. The transceiver is configured to receive, on a PUSCH resource, a UE-initiated beam switching report including second information related to a TCI state and transmit a response to the UE-initiated beam switching report.

In yet another embodiment, a method performed by a UE is provided. The method includes receiving first information related to UE-initiated beam switching, determining, based on the first information, a PUCCH resource to transmit a UE-initiated beam switching indicator, and transmitting the UE-initiated beam switching indicator on the PUCCH resource. The method further includes determining a PUSCH resource to transmit a UE-initiated beam switching report, transmitting, on the PUSCH resource, the UE-initiated beam switching report including second information related to a TCI state, receiving a response to the UE-initiated beam switching report, and applying the TCI state.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIGS. 7A and 7B illustrate an example timeline for time window determination and its relation to a transmission configuration indication (TCI) state update according to embodiments of the present disclosure;

FIG. 8 illustrates an example of UE initiated report contents according to embodiments of the present disclosure; and

FIG. 9 illustrates an example method performed by a UE in a wireless communication system according to embodiments of the present disclosure.

### DETAILED DESCRIPTION

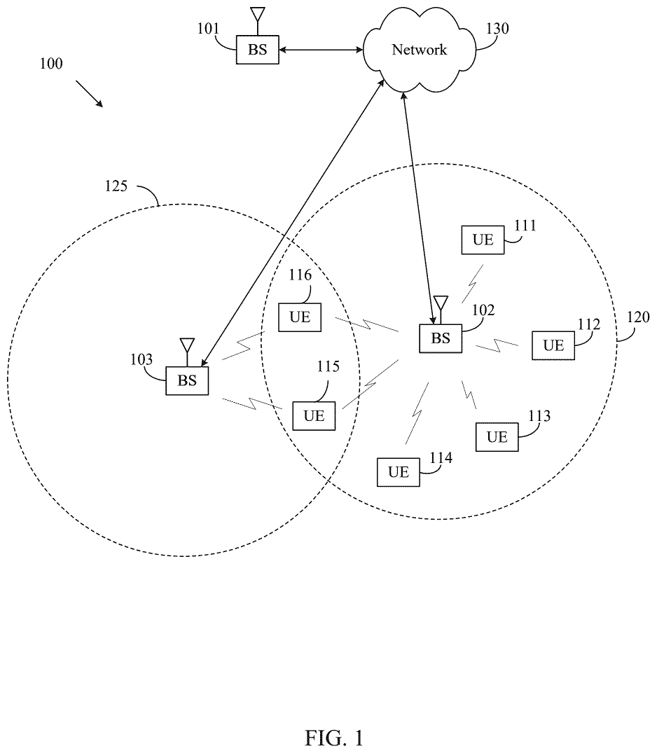

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1]3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical Layer Procedures for Control;” [REF 4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing UE reporting triggered beam switching. In certain embodiments, one or more of the BSs 101-103 include circuitry, programing, or a combination thereof to support UE reporting triggered beam switching.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

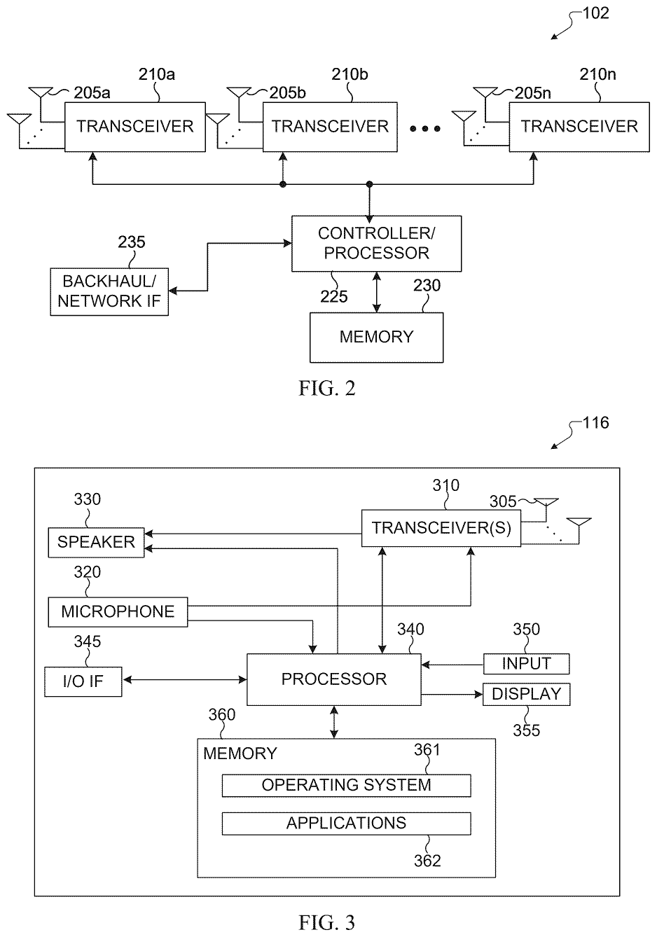

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting UE reporting triggered beam switching. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize UE reporting triggered beam switching as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

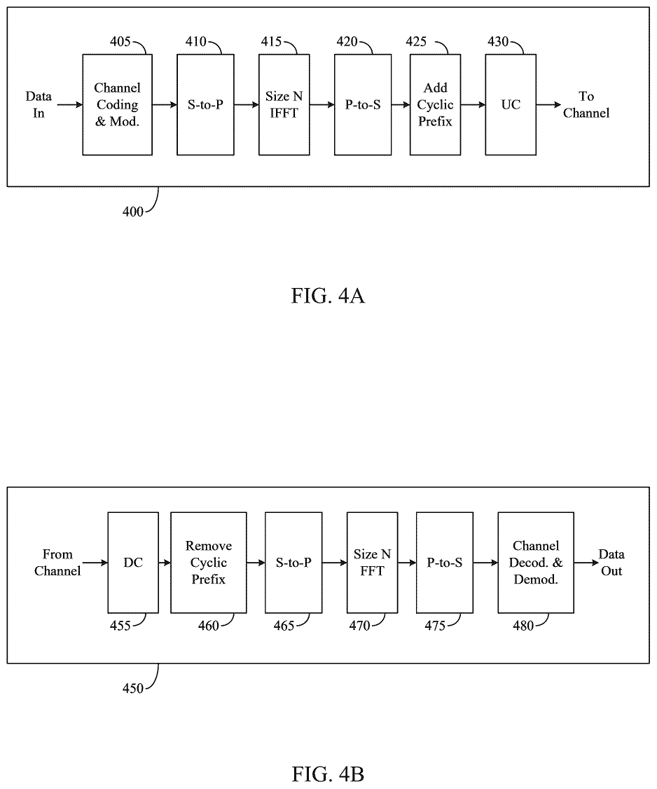

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support UE reporting triggered beam switching as described in embodiments of the present disclosure. In some embodiments, the receive path 450 is configured to support UE) reporting triggered beam switching as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

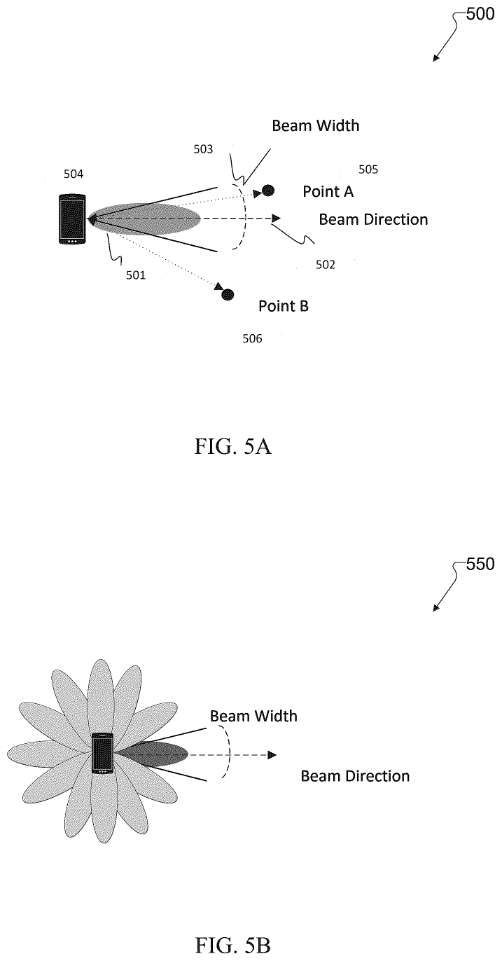

As illustrated in FIG. 5A, in a wireless system 500, a beam 501 for a device 504 can be characterized by abeam direction 502 and abeam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

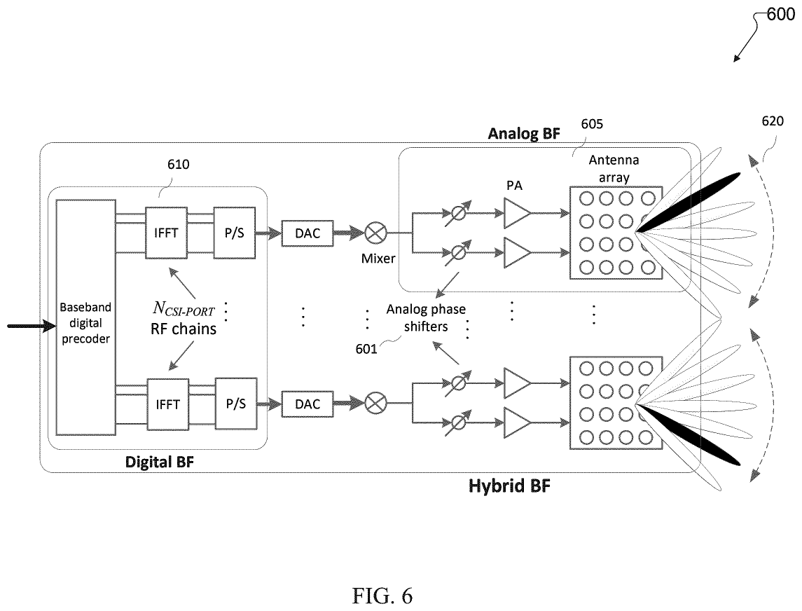

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (~10 dB additional loss per 100 m distance), a larger number and narrower analog beams (hence a larger number of radiators in the array) are needed to compensate for the additional path loss.

In this disclosure, a beam is determined by either of,
A transmission configuration indication (TCI) state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Embodiments of the present disclosure recognize that in (up to Rel.17) the NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Therefore, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), and/or multiple event types when a report type can be associated with an event (e.g., for beam report, the event can be beam failure, and for CSI, the event can be user throughput degradation or increasing retransmission rate).

The present disclosure provides various novel and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various resource allocation and association methods to enable the UE-initiated/event-driven beam reporting as well. Furthermore, the present disclosure provides various design aspects and therefore corresponding solutions for the case(s) where the UE receives the network's response(s) during the UE-initiated/event-driven beam operation/management process. In the present disclosure, the UE-initiated/event-driven beam operation/management process comprises UE reporting initiated/triggered beam switching.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g., NW/gNB (e.g., the network 130/the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g., channel quality indicator (CQI) report interval (CRI), SSB resource indicator (SSBRI)) and Jᵢ is a beam metric (e.g., L1-reference signal received power (RSRP), L1-signal-to-interference-plus-noise ratio (SINR)).
In one example, the content includes CSI-related quantity/quantities. For example, at least one of: rank indicator (RI), precoding matrix indicator (PMI), channel quality indicator (CQI), CQI report interval (CRI), layer index (LI).
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g., (auto-)correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either
      beam (TCI state) TCI states (e.g., DL TCI state, UL TCI state, or unified (joint) DL/UL TCI state), or
      panel(s) (e.g., UE panels for DL reception or/and UL transmission), or
      antenna(e) (e.g., UE antennae for DL reception or/and UL transmission), or
      antenna port(s) (e.g., UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g., this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based, i.e., the UE (e.g., the UE 116) can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| | | Trigger/pre-notification | |
| Event type | Type | message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/ | (A) | Yes (e.g., non-CSI-related event) | No |
| beam/TDCP | (B) | No | Yes |
| | (C) | Yes (e.g., non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g., beam-related event), | No |
| | content-specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g., beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g., CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g., from Type I to Type II or vice versa), or rank restriction (e.g., from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g., CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g., MCS, or number of CWs.
For another example, when there is no pre-notification message/trigger associated with a content, i.e., the report-type is (B), the content can be transmitted using UL resource(s) configured (e.g., configured-grant physical uplink shared channel (PUSCH)), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based LI signaling(s), based on/according to a corresponding UE's capability reporting: for example, the UE could receive from the network, e.g., via higher layer RRC signaling(s)/parameter(s) and/or MAC CE command(s) and/or dynamic DCI based LI signaling(s), a 2-bit indicator with ‘00’ indicating a UEI report comprising only a PN message, ‘01’ indicating a UEI report comprising only a content according to those specified herein in the present disclosure, ‘10’/‘1’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including physical uplink control channel(s) (PUCCH(s)), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based LI signaling(s), based on/according to a corresponding UE's capability reporting: for example, the UE could receive from the network, e.g., via higher layer RRC signaling(s)/parameter(s) and/or MAC CE command(s) and/or dynamic DCI based LI signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 10, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

A UE could receive from the network a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL BWPs, and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein all of the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, all of the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applylndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is configured/present and/or set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

That is, for PDSCH reception in a (single-DCI based) multi-TRP system, when a UE is configured with dl-OrJointTCU-StateList and is having two indicated TCI-states, if the UE does not report its capability indicating support of “two default beams for S-DCI based MTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE is configured with dl-OrJointTCJ-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI basedMTRP” in frequency range 2, or
If the UE does not report its capability indicating support of “two default beams for S-DCI basedMTRP” in frequency range 2 and if the scheduling offset between the reception of the scheduling DCI format 1_0/1_1/1_2 and the scheduled/activated PDSCH reception is equal to or larger than timeDurationForQCL
The UE can be configured by higher layer parameter applyIndicatedTClState to indicate whether the first, the second, or both of the indicated TCI-state(s) is/are applied to PDSCH reception scheduled or activated by DCI format 1_0. The UE can be configured with applyIndicatedTClState with value both only when the UE is configured with cjtSchemePDSCH and the UE reports its capability indicating support of two joint TCI states for PDSCH-CJT or the UE is configured with sfnSchemePdsch. In that case, the UE shall apply both indicated TCI-states to PDSCH reception scheduled or activated by DCI format 1_0 on a search space other than Type0/0A/2 CSS on CORESET #0.
If the UE is not configured with applyIndicatedTClState, the first indicated TCI-state is applied to PDSCH reception scheduled or activated by DCI format 1_0.
When the UE is configured with tciSelection-PresentInDCIjointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
If the DCI format 1_1/1_2 indicates codepoint “00” for the TCI selection field (or equivalently, the second indicator as specified herein in the present disclosure), the UE shall apply the first one of two indicated joint/DL TCI states to all PDSCH DM-RS port(s) of corresponding PDSCH transmission occasions(s) scheduled or activated by the DCI format 1_1/1_2.
If the DCI format 1_1/1_2 indicates codepoint “01” for the TCI selection field (or equivalently, the second indicator as specified herein in the present disclosure), the UE shall apply the second one of two indicated joint/DL TCI states to all PDSCH DM-RS port(s) of corresponding PDSCH transmission occasion(s) scheduled or activated by the DCI format 1_1/1_2.
If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
If the UE is not configured with tciSelection-PresentInDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applylndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting a third indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

The RS(s) or RS resource(s) or RS resource index(es) of/for a current serving beam—denoted by current serving beam RS(s) or RS resource(s) or RS resource index(es)—could be identified or determined according to or based on one or more network's responses (NWRs), if applicable (i.e., the current serving beam RS(s) or RS resource(s) or RS resource index(es) could be associated or corresponding or linked or mapped to the NWR(s) if applicable) according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the indicated TCI state could be regarded/referred to as a NWR.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the indicated TCI state could be regarded/referred to as a NWR.
(explicit configuration example-1): a set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure. For this design example, the set s̅₀ provided by currentServBeamRSList could be regarded/referred to as a NWR.
(explicit configuration example-2): a set s̅₀ of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure. For this design example, the set s̅₀ provided by currentServBeamRSList could be regarded/referred to as a NWR.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of all the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to or based on one or more NWRs, if applicable (i.e., the (candidate/actual) candidate/new beam RS(s) or RS resource(s) or RS resource index(es) could be associated or corresponding or linked or mapped to the NWR(s) if applicable) according to one or more of:
(explicit configuration example-A): a set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₁ provided by CandidateBeamRSList could be regarded/referred to as a NWR.
(explicit configuration example-B): a set s̅₁ of SS/PBCH block indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₁ provided by CandidateBeamRSList could be regarded/referred to as a NWR.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the one or more activated TCI states could be regarded/referred to as NWR(s).
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the one or more activated TCI states could be regarded/referred to as NWR(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the one or more configured/provided TCI states could be regarded/referred to as NWR(s).
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the one or more configured/provided TCI states could be regarded/referred to as NWR(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network a/the set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

When/if an activated TCI state is a joint/DL TCI state, a UE could determine or identify RS(s) or RS resource(s) or RS resource index(es) of/for the activated TCI state—denoted by activation beam RS(s) or RS resource(s) or RS resource index(es)—could be identified or determined according to or based on one or more NWRs, if applicable (i.e., the activation beam RS(s) or RS resource(s) or RS resource index(es) could be associated or corresponding or linked or mapped to the NWR(s) if applicable) according to one or more of:
(implicit determination example-i): One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the activated TCI state could be regarded/referred to as a NWR.
(implicit determination example-ii): One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the activated TCI state could be regarded/referred to as a NWR.
(explicit configuration example-i): a set s̅₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₂ provided by activationBeamRSList could be regarded/referred to as a NWR.
(explicit configuration example-ii): a set s̅₂ of SS/PBCH block indexes by activationBeamRSList (e.g., via higher layer RRC signalling(s)/parameter(s) and/or MAC CE command(s) and/or dynamic DCI based LI signaling(s)) for monitoring/assessing the radio link and/or beam qualities for the activation beam(s) according to those specified herein in the present disclosure. The activation beam(s) set s̅₂ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set ŝ₂ provided by activationBeamRSList could be regarded/referred to as a NWR.

In one example, when/if the one or more RSs/RS resources/RS resource indexes provided in/by the activated TCI state (e.g., of QCL-TypeD) correspond to CSI-RS(s) for beam management (e.g., CSI-RS(s) configured with repetition or with repetition set to ‘on’), the UE could follow those specified in the implicit determination example-i in the present disclosure to determine or identify the activation beam RS(s)/RS resource(s)/RS resource index(es). In another example, when/if the one or more RSs/RS resources/RS resource indexes provided in/by the activated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-i in the present disclosure to determine or identify the activation beam RS(s)/RS resource(s)/RS resource index(es), but instead, the UE could expect to be provided or configured or indicated by the network a/the set s̅₂ of (periodic) CSI-RS resource configuration indexes by activationBeamRSList (e.g., via higher layer RRC signalling(s)/parameter(s) and/or MAC CE command(s) and/or dynamic DCI based LI signaling(s)) for monitoring/assessing the radio link and/or beam qualities for the activation beam(s) according to those specified herein in the explicit configuration example-i in the present disclosure. Furthermore, the UE could assess or evaluate the radio link/beam quality(s), e.g., by measuring L1-RSRP(s)/L1-SINR(s), of an activation beam/TCI state based on or according to one or more of:
The UE could assess or evaluate the radio link/beam quality(s), e.g., by measuring L1-RSRP(s)/L1-SINR(s), of all the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting according to (or that has the same RS(s) or RS resource(s) or RS resource index(es) as to)
   one or more RSs or RS resources or RS resource indexes provided in/by an activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking reference signal (TRS)—e.g., a CSI-RS configured with trs-Info, a CSI-RS configured without repetition or with repetition set to ‘off’, and etc. Throughout the present disclosure, according to or following those specified or defined herein in the present disclosure, an indicated TCI state, an activation TCI state or a provided/configured TCI state could be regarded/referred to as a NWR, or a NWR could be in form of an indicated TCI state, an activation TCI state or a provided/configured TCI state as specified/defined herein in the present disclosure. Furthermore, according to or following those specified or defined herein in the present disclosure, a UE could determine or identify or derive measurement RS(s) or RS resource(s)—e.g., the current serving beam RS(s) or RS resource(s) or RS resource index(es) and/or the (candidate/actual) candidate/new beam RS(s) or RS resource(s) or RS resource index(es) and/or the activation beam RS(s) or RS resource(s) or RS resource index(es) as specified/defined herein in the present disclosure—for evaluating, assessing, detecting, declaring or determining the event(s) and/or event instance(s) as specified/defined herein in the present disclosure from or based on or according to one or more NWRs.

A UE could determine or identify an instance of a first event (or an Event-1 instance) according to or based on or corresponding to: the UE could determine or identify at least one (same) candidate/new beam or candidate/new beam RS/RS resource that has a beam quality/metric (e.g., a measured L1-RSRP/L1-SINR) a threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, and/or the UE has stored QCL properties of the determined or identified at least one (same) candidate/new beam or candidate/new beam RS/RS resource, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or an Event-2 instance) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or an Event-3 instance) according to or based on or corresponding to: the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states (or one or more NWRs in general) or one or more activation beam RSs/RS resources as specified/defined herein in the present disclosure; and/or the UE has stored QCL properties of the determined or identified at least one (same) candidate/new beam or candidate/new beam RS/RS resource, furthermore, e.g., when/if the NWR(s) corresponds to or is in form of one or more activated beams/TCI states, the UE could determine or identify the one or more activated beams/TCI states as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the one or more activation beam RSs or RS resources could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure. Here, the UE could determine or identify the value of m according to or based on: (i) a fixed value/rule in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M), (ii) network's configuration(s)/indication(s), e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M), and/or (iii) UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M). Additionally, the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a fourth event (or an Event-4 instance) according to or based on or corresponding to: the UE could determine or identify at least one (same) candidate/new beam or candidate/new beam RS/RS resource that has a beam quality/metric (e.g., a measured L1-RSRP/L1-SINR) greater than or equal to a threshold, and/or the UE has stored QCL properties of the determined or identified at least one (same) candidate/new beam or candidate/new beam RS/RS resource, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a fifth event (or an Event-5 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, and (2) at least one (same) candidate/new beam or candidate/new beam RS/RS resource that has a beam quality/metric (e.g., a measured L1-RSRP/L1-SINR) a second threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, and/or the UE has stored QCL properties of the determined or identified at least one (same) candidate/new beam or candidate/new beam RS/RS resource, wherein the UE could determine or identify the first and/or second threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a sixth event (or an Event-6 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, and (2) at least one (same) candidate/new beam or candidate/new beam RS/RS resource that has a beam quality/metric (e.g., a measured L1-RSRP/L1-SINR) greater than or equal to a second threshold, and/or the UE has stored QCL properties of the determined or identified at least one (same) candidate/new beam or candidate/new beam RS/RS resource, wherein the UE could determine or identify the first and/or second threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a seventh event (or an Event-7 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, (2) at least one (same) candidate/new beam or candidate/new beam RS/RS resource that has a beam quality/metric (e.g., a measured L1-RSRP/L1-SINR) a second threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, and (3) at least one (same) candidate/new beam or candidate/new beam RS/RS resource that has a beam quality/metric (e.g., a measured L1-RSRP/L1-SINR) greater than or equal to a third threshold, and/or the UE has stored QCL properties of the determined or identified at least one (same) candidate/new beam or candidate/new beam RS/RS resource, wherein the UE could determine or identify the first, second and/or third threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and the at least one (same) candidate/new beam or candidate/new beam RS/RS resource determined or identified in (2) could be identical to or same as the at least one (same) candidate/new beam or candidate/new beam RS/RS resource determined or identified in (3).

Throughout the present disclosure, when/if a UE has stored QCL properties of a RS or RS resource,
when/if the RS or RS resource is an SSB, the UE could have stored QCL properties of the SSB
when/if the RS or RS resource is an NZP CSI-RS, the UE could have stored QCL properties of SSB(s) that is QCL'ed—e.g. of QCL-TypeD—with the NZP CSI-RS
when/if the RS or RS resource is an NZP CSI-RS, the UE could have stored QCL properties of the NZP CSI-RS.

A UE could be provided or configured or indicated by the network, e.g., via/by/in higher layer RRC signaling(s)/parameter(s) including CSI-ReportConfig and/or UEI-ReportConfig that provides or configures necessary information and/or setting(s) for the UE-initiated/event-driven beam operations including beam(s) reporting, beam(s) switching/update, etc. as specified/defined herein in the present disclosure and/or MAC CE command(s) and/or dynamic DCI based L1 signaling(s) according to or based on corresponding UE's capability(s) or capability signaling(s), one or more indicators/parameters to enable one or more of the Event-1, Event-2, Event-3, Event-4, Event-5, Event-6 and Event-7 as specified/defined herein in the present disclosure. For instance, the UE could be provided or configured with a higher layer parameter eventType set to:
‘event-1’ to enable the Event-1
‘event-2’ to enable the Event-2
‘event-3’ to enable the Event-3
‘event-4’ to enable the Event-4
‘event-5’ to enable the Event-5
‘event-6’ to enable the Event-6
‘event-7’ to enable the Event-7
‘event-x-y’ to enable both the Event-x and Event-y, wherein x={1, . . . , 7}, y={1, . . . , 7}, and x≠y
‘event-x-y-z’ to enable the Event-x, Event-y and Event-z, wherein x={1, . . . , 7}, y={1, . . . , 7}, z={1, . . . , 7}, and x≠y≠z.

The corresponding UE's capability(s) or capability signaling(s) could comprise one or more of the following components:
‘event-1’—to indicate their support of Event-1
‘event-2’—to indicate their support of Event-2
‘event-3’—to indicate their support of Event-3
‘event-4’—to indicate their support of Event-4
‘event-5’—to indicate their support of Event-5
‘event-6’—to indicate their support of Event-6
‘event-7’—to indicate their support of Event-7
‘event-x-y’- to indicate their support of Event-x and Event-y, wherein x={1, . . . , 7}, y={1, . . . , 7}, and x≠y
‘event-x-y-z’ to—to indicate their support of Event-x, Event-y and Event-z, wherein x={1, . . . , 7}, y={1, . . . , 7}, z={1, . . . , 7}, and x≠y≠z.

According to or following those specified/defined herein in the present disclosure,
when/if an Event-x (wherein x={1, . . . , 7}) is enabled, (higher layer(s) of) a UE could determine, detect or declare the Event-x when/if (higher layer(s) of) the UE has determined or identified that the number of instance(s) of the x-th event (or equivalently, the number of the Event-x instance(s)) is greater than or equal to numberOfEventInstances 1 (higher layer configured) within a time window having a length/duration of timeWindowDuration (higher layer configured);
when/if an Event-x and an Event-y (wherein x={1, . . . , 7}, y={1, . . . , 7}, and x≠y) are enabled, (higher layer(s)) of a UE could determine, detect or declare both of the Event-x and Event-y when/if (higher layer(s) of) the UE has determined or identified that (1):
   the number of instance(s) of the x-th event (or equivalently, the number of the Event-x instance(s)) is greater than or equal to numberOfEventxInstances≥1 (higher layer configured) within a first time window having a length/duration of timeWindow1Duration (higher layer configured), and
   the number of instance(s) of the y-th event (or equivalently, the number of the Event-y instance(s)) is greater than or equal to numberOfEventyInstances≥1 (higher layer configured) within a second time window having a length/duration of timeWindow2Duration (higher layer configured), wherein the first symbol/slot/etc. of the first time window and the first symbol/slot/etc. of the second time window are expected to be later in time than the first symbol/slot/etc. of an overall time window having a length/duration of timeWindowDuration (higher layer configured), and the last symbol/slot/etc. of the first time window and the last symbol/slot/etc. of the second time window are expected to be earlier in time than the last symbol/slot/etc. of the overall time window; or (2): the number of instance(s) of the x-th event (or equivalently, the number of the Event-x instance(s)) is greater than or equal to numberOfEventxInstances≥1 (higher layer configured) and the number of instance(s) of the y-th event (or equivalently, the number of the Event-y instance(s)) is greater than or equal to numberOfEventyInstances≥1 (higher layer configured) within a time window having a length/duration of timeWindowDuration (higher layer configured); in this case, when/if the determination, detection or declaration of each of the Event-x and Event-y (e.g., Event-1, Event-4, and etc.) requires at least one new beam or new beam RS/RS resource to be determined or identified, the same/identical new beam(s) or new beam RS(s)/RS resource(s) could be expected to be determined/identified when determining, detecting or declaring the Event-x and Event-y.
when/if an Event-x, an Event-y and an Event-z (wherein x={1, . . . , 7}, y={1, . . . , 7}, z={1, . . . , 7}, and x≠y≠z) are enabled, (higher layer(s)) of a UE could determine, detect or declare both of the Event-x, Event-y and Event-z when/if (higher layer(s) of) the UE has determined or identified that (1):
   the number of instance(s) of the x-th event (or equivalently, the number of the Event-x instance(s)) is greater than or equal to numberOfEventxInstances≥1 (higher layer configured) within a first time window having a length/duration of timeWindow1Duration (higher layer configured), and
   the number of instance(s) of the y-th event (or equivalently, the number of the Event-y instance(s)) is greater than or equal to numberOfEventyInstances≥1 (higher layer configured) within a second time window having a length/duration of timeWindow2Duration (higher layer configured), and
   the number of instance(s) of the z-th event (or equivalently, the number of the Event-z instance(s)) is greater than or equal to numberOfEventzInstances≥1 (higher layer configured) within a third time window having a length/duration of timeWindow3Duration (higher layer configured),
wherein the first symbol/slot/etc. of the first time window, the first symbol/slot/etc. of the second time window and the first symbol/slot/etc. of the third time window are expected to be later in time than the first symbol/slot/etc. of an overall time window having a length/duration of timeWindowDuration (higher layer configured), and the last symbol/slot/etc. of the first time window, the last symbol/slot/etc. of the second time window and the last symbol/slot/etc. of the third time window are expected to be earlier in time than the last symbol/slot/etc. of the overall time window; or (2): the number of instance(s) of the x-th event (or equivalently, the number of the Event-x instance(s)) is greater than or equal to numberOfEventxInstances≥1 (higher layer configured), the number of instance(s) of the y-th event (or equivalently, the number of the Event-y instance(s)) is greater than or equal to numberOfEventyInstances≥1 (higher layer configured) and the number of instance(s) of the z-th event (or equivalently, the number of the Event-z instance(s)) is greater than or equal to numberOfEventzInstances≥1 (higher layer configured) within a time window having a length/duration of timeWindowDuration (higher layer configured); in this case, when/if the determination, detection or declaration of each of the Event-x, Event-y and Event-z (e.g., Event-1, Event-4, and etc.) requires at least one new beam or new beam RS/RS resource to be determined or identified, the same/identical new beam(s) or new beam RS(s)/RS resource(s) could be expected to be determined/identified when determining, detecting or declaring the Event-x, Event-y and Event-z.

As specified/defined in later part(s)/section(s) of the present disclosure, a UE could determine or identify the first and/or last symbol(s)/slot(s)/etc. of a time window for evaluating and/or assessing instance(s) of the event(s) and/or to detect, declare and/or determine the event(s) according to or following those specified herein in the present disclosure with a reference to or with respect to or according to transmission or transmission occasion of a PUCCH of a/the first UL channel as in Step-1 for Mode A, Mode B and/or Mode C as specified/defined herein in the present disclosure.

The RS(s) or RS resource(s) or RS resource (configuration) index(es) of/for a current serving beam—denoted by current serving beam RS(s) or RS resource(s) or RS resource index(es)—for event(s), e.g., Event-1 and/or Event-2 as specified/defined herein in the present disclosure, evaluation(s) and/or determination(s) could be identified or determined according to or based on one or more NWRs, if applicable (i.e., the current serving beam RS(s) or RS resource(s) or RS resource index(es) could be associated or corresponding or linked or mapped to the NWR(s) if applicable) according to one or more of:
Scheme-1: One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-2: One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For Scheme-1 and/or Scheme-2, the indicated TCI state could be regarded/referred to as a NWR, or a NWR could correspond to or could be in form of the indicated TCI state.

Candidate/new beam RS(s) or RS resource(s) or RS resource (configuration) index(es)—denoted by candidate/new beam RS(s) or RS resource(s) or RS resource (configuration) index(es)—for event(s), e.g., Event-1 and/or Event-3 as specified/defined herein in the present disclosure, evaluation(s) and/or determination(s) could be identified or determined according to a set of SS/PBCH block indexes provided by CSI-SSB-ResourceSet or a set of NZP CSI-RS resources provided by NZP-CSI-RS-ResourceSet (e.g., configured with ‘repetition’ or ‘repetition’ set to ‘enabled’ or ‘on’), wherein the candidate/new beam(s) set of SS/PBCH block indexes (CSI-SSB-ResourceSet) and/or NZP CSI-RS resources (NZP-CSI-RS-ResourceSet, e.g., configured with ‘repetition’ or ‘repetition’ set to ‘enabled’ or ‘on’) could be regarded/referred to as NWR(s) as well (or a NWR could be in form of configuration of the set of candidate/new beam RS(s)/RS resource(s)) and provided in or associated with higher layer parameter(s) CSI-ReportConfig, CSI-ResourceConfig associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

For evaluating, assessing or determining a given event (e.g., Event-1 as defined/specified herein in the present disclosure) and/or when/if a given event, e.g., Event-1 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the current serving beam RS(s) as SSB(s) according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the current serving beam RS(s) as NZP CSI-RS(s) or NZP CSI-RS resource(s) according to or following those specified or defined in Scheme-1.

For evaluating, assessing or determining a given event (e.g., Event-2 as defined/specified herein in the present disclosure) and/or when/if a given event, e.g., Event-2 as defined/specified herein in the present disclosure, is enabled or provided or configured,
In one example, when/if another or other event(s)—i.e., separate or different from the given event (e.g., Event-2), e.g., Event-1 and/or Event-3 as defined/specified herein in the present disclosure, is also or simultaneously (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2) enabled or provided or configured, and/or when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure—e.g., for evaluating, assessing or determining the another or other event(s), e.g., Event-1 and/or Event-3, the UE could determine or identify the current serving beam RS(s) as SSB(s) for evaluating, assessing or determining the given event, e.g., Event-2, according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s)—e.g., for evaluating, assessing or determining the another or other event(s), e.g., Event-1 and/or Event-3, the UE could determine or identify the current serving beam RS(s) as NZP CSI-RS(s) or NZP CSI-RS resource(s) for evaluating, assessing or determining the given event, e.g., Event-2, according to or following those specified or defined in Scheme-1.
In another example, when/if another or other event(s)—i.e., separate or different from the given event (e.g., Event-2), e.g., Event-1 and/or Event-3 as defined/specified herein in the present disclosure, is not enabled or provided or configured or is disabled or absent (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2), and/or
   for example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeCSIRS’ set to ‘off’ or ‘disabled’ or ‘false’, and/or when/if the higher layer parameter ‘currentBeamRStypeCSIRS’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1
   when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeSSB’ set to ‘off’ or ‘disabled’ or ‘false’, and/or when/if the higher layer parameter ‘currentBeamRStypeSSB’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as CSI-RS(s) for evaluating, assessing or determining the given event, e.g., Event-2, according to or following those specified or defined in Scheme-1
In another example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’; when/if the higher layer parameter ‘currentBeamRStype’ is set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2, and/or when/if the higher layer parameter ‘currentBeamRStype’ is set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1. For this design example, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any set(s) of candidate/new RS index(es)—e.g., SSB index(es) or periodic CSI-RS resource configuration index(es)—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s) and/or beam measurement/reporting, the UE could determine or identify the current serving beam RS(s) as SSB(s) for evaluating, assessing or determining the given event, e.g., Event-2, according to or following those specified or defined in Scheme-2, and/or when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of NZP CSI-RS resource or resource configuration index(es) as the candidate/new beam(s) set of RS index(es) for event(s) or event instance(s) evaluation(s) and/or beam measurement/reporting, the UE could determine or identify the current serving beam RS(s) as CSI-RS(s) for evaluating, assessing or determining the given event, e.g., Event-2, according to or following those specified or defined in Scheme-1. For this design example, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.

Furthermore, for evaluating, assessing or determining a given event (e.g., Event-2 as defined/specified herein in the present disclosure) and/or when/if a given event, e.g., Event-2 as defined/specified herein in the present disclosure, is enabled or provided or configured,
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ and set to ‘on’ or ‘enabled’ or ‘true’ or ‘SSB’ or ‘CSI-RS’, the UE could determine or identify whether the current serving beam RS(s) is SSB(s) or CSI-RS(s) for evaluating, assessing or determining the given event, e.g., Event-2, according to or based on the higher layer parameter ‘currentBeamRStype’ following those specified or defined herein in the present disclosure, regardless whether or not the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, candidate/new beam RS index(es)—e.g. in a resource set—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of candidate/new beam RS index(es)—e.g. a set of SSB index(es) or a set of periodic CSI-RS resource configuration index(es)—for event(s) or event instance(s) evaluation(s) and/or beam measurement/reporting, the UE could determine or identify whether the current serving beam RS(s) is SSB(s) or CSI-RS(s) for evaluating, assessing or determining the given event, e.g., Event-2, according to or based on whether the configured or provided candidate/new beam RS index(es) in the set is SSB index(es) or CSI-RS resource/resource configuration index(es) following those specified or defined herein in the present disclosure (e.g., those specified or defined in Scheme-1 and/or Scheme-2 in the present disclosure), regardless whether or not the aforementioned higher layer parameter ‘currentBeamRStype’ is present or provided or configured in the corresponding higher layer RRC signaling(s)/parameter(s), and/or regardless of the value(s) of the aforementioned higher layer parameter ‘currentBeamRStype’, if present/configured/provided.

For a NWR in form of an activated TCI state—e.g., a joint/DL TCI state, a UE could determine or identify RS(s) or RS resource(s) or RS resource index(es) of/for the activated TCI state (or in general, the NWR)—denoted by activation beam RS(s) or RS resource(s) or RS resource index(es) e.g. associated or corresponding or linked or mapped to the NWR in general if applicable—for event(s), e.g., Event-3 as specified/defined herein in the present disclosure, evaluation(s) and/or determination(s) according to one or more of:
Scheme-A: One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-B: One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For Scheme-A and/or Scheme-B, the activated TCI state could be regarded/referred to as a NWR, or a NWR could correspond to or could be in form of the activated TCI state.

For evaluating, assessing or determining a given event (e.g., Event-3 as defined/specified herein in the present disclosure) and/or when/if a given event, e.g., Event-3 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the activation beam RS(s) as SSB(s) according to or following those specified or defined in Scheme-B. Otherwise, i.e., when/if a UE is provided or configured a set of NZP CSI-RS resources provided by NZP-CSI-RS-Resource Set (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the activation beam RS(s) as NZP CSI-RS(s) or NZP CSI-RS resource(s) according to or following those specified or defined in Scheme-A.

Furthermore, in one example, for evaluating, assessing or determining given event(s)—e.g., Event-1 and/or Event-2 as defined/specified herein in the present disclosure—and/or when/if given event(s), e.g., Event-1 and/or Event-2 as defined/specified herein in the present disclosure, is/are enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in the indicated (joint/DL) TCI state (e.g., corresponding to the QCL RS)—or associated or linked or corresponding or mapped to a NWR in general (if applicable), the UE could determine or identify the current serving beam RS(s)/RS resource(s)/RS resource configuration index(es) for evaluating, assessing or determining the given event(s), e.g., Event-1 and/or Event-2,
as a SSB as specified or defined in Scheme-2 according to or following those specified or defined herein in the present disclosure—for example, when/if the Scheme-2 is enabled by the network such that the candidate/new beam RS(s)/RS resource(s)/RS resource configuration(s) is configured or provided as SSB(s); for another example, when/if the Scheme-2 is enabled by the network such that the higher layer parameter e.g. currentBeamRStype is set to ‘SSB’;
as a NZP CSI-RS as specified or defined in Scheme-1 according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-1 is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-1 is enabled by the network such that the higher layer parameter e.g. currentBeamRStype is set to ‘CSI-RS’.

In another example, for evaluating, assessing or determining a given event—e.g., Event-3 as defined/specified herein in the present disclosure—and/or when/if a given event, e.g., Event-3 as defined/specified herein in the present disclosure, is enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in an activated (joint/DL) TCI state (e.g., corresponding to the QCL RS)—or associated or linked or corresponding or mapped to a NWR in general (if applicable), the UE could determine or identify the activation beam RS(s)/RS resource(s)/RS resource configuration index(es) for evaluating, assessing or determining the given event, e.g., Event-3,
as a SSB as specified or defined in Scheme-B according to or following those specified or defined herein in the present disclosure—for example, when/if the Scheme-B is enabled by the network such that the candidate/new beam RS(s)/RS resource(s)/RS resource configuration(s) is configured or provided as SSB(s); for another example, when/if the Scheme-B is enabled by the network such that the higher layer parameter e.g. currentBeamRStype is set to ‘SSB’;
as a NZP CSI-RS as specified or defined in Scheme-A according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-A is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-A is enabled by the network such that the higher layer parameter e.g. currentBeamRStype is set to ‘CSI-RS’.

In one operation mode (Mode A), upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1s1 corresponds to 1 slot, Value 2s1 corresponds to 2 slots, and so on; Value msl corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger—in this case, the DCI could also be regarded/referred to as a NWR. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel kl slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel kl slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state sub-selection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel kl slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel kl slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state sub-selection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.

The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based LI signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1s1 corresponds to 1 slot, Value 2s1 corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C), upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1s1 corresponds to 1 slot, Value 2s1 corresponds to 2 slots, and so on; Value msl corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger—in this case, the DCI could also be regarded/referred to as a NWR. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel kl slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based LI signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state sub-selection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, ki, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel kl slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state sub-selection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap—within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q1 (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type1 and/or Type2 is (pre-)configured by the network for transmitting or sending the UEI report content(s)/quantity(s) as defined or specified herein in the present disclosure, the UE could (always) determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network in their capability signaling(s) one or more of:
Support of Mode A and therefore the corresponding operations
Support of Mode B and therefore the corresponding operations
Support of Mode C and therefore the corresponding operations

That is, a UE's capability or capability signaling could comprise one or more components each indicating support of:
{Mode A}
{Mode B}
{Mode C}
{Mode A, Mode B}
{Mode A, Mode C}
{Mode B, Mode C}

For Mode A, Mode B and/or Mode C as specified/defined herein in the present disclosure, a PN message/trigger could correspond to or could be equivalent to or could be replaced by/with or could be used in an exchangeable manner with transmission of a PN message/trigger, a PN message/trigger transmission, a PN message/trigger transmission occasion, a PUCCH resource of the first UL channel, a PN message/trigger transmission (occasion) via/in/by a PUCCH resource of the first UL channel and/or etc. throughout the present disclosure; and/or, UEI report content(s)/quantity(s) could correspond to or could be equivalent to or could be replaced by/with or could be used in an exchangeable manner with transmission of UEI report content(s)/quantity(s), UEI report content(s)/quantity(s) transmission, UEI report content(s)/quantity(s) transmission occasion, a PUSCH resource of the second UL channel, UEI report content(s)/quantity(s) transmission (occasion) via/in/by a PUSCH resource of the second UL channel and/or etc. throughout the present disclosure. For instance, UEI report content(s)/quantity(s) associated/specific to a PN message/trigger could be equivalent to a PUSCH resource of the second UL channel that carries or conveys the UEI report content(s)/quantity(s) associated/specific to a PUCCH resource of the first UL channel that carries or conveys the PN message/trigger, and/or UEI report content(s)/quantity(s) transmission occasion of a PUSCH resource of the second UL channel associated/specific to a/the PN message/trigger transmission occasion of a PUCCH resource of the first UL channel. Throughout the present disclosure, a PN message/trigger could also be referred to as a UEI transmission indication/indicator (UEITI), which could be a UCI type/parameter similar to HARQ-ACK, CSI and/or etc.

According to or following those specified herein in the present disclosure,
For Event-1 as specified/defined herein in the present disclosure, when/if (higher layer(s) of) a UE has determined or identified that a first Event-1 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of the current serving beam RS/RS resource as specified/defined herein in the present disclosure, and (higher layer(s) of) the UE has determined or identified that a second Event-1 instance is associated/specific to the (same) new/candidate beam RS/RS resource such that the UE could determine or identify that the candidate/new beam RS/RS resource has a beam quality/metric (e.g., a measured L1-RSRP/L1-SINR) the threshold value greater than or equal to the beam quality(s)/metric(s)—e.g., measured L1-RSRP(s)/L1-SINR(s)—of the current serving beam RS/RS resource, the first and second Event-1 instances could be associated/specific to the (same) new/candidate beam RS/RS resource.
For Event-2 as specified/defined herein in the present disclosure, when/if (higher layer(s) of) a UE has determined or identified that a first Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, and (higher layer(s) of) the UE has determined or identified that a second Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, the first and second Event-2 instances could be associated/specific to the current beam RS/RS resource.
For Event-3 as specified/defined herein in the present disclosure, (higher layer(s) of) a UE could determine or identify that a first Event-3 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a first activated beam/TCI state or a first activation beam RS/RS resource as specified/defined herein in the present disclosure; furthermore, the UE could determine or identify the first activated beam/TCI state as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the first activation beam RS or RS resource could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure, and (higher layer(s) of) the UE could determine or identify that a second Event-3 instance is associated/specific to the new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a second activated beam/TCI state or a second activation beam RS/RS resource as specified/defined herein in the present disclosure; furthermore, the UE could determine or identify the second activated beam/TCI state as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the second activation beam RS or RS resource could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure. In this case, the UE could determine or identify the first activation beam RS/RS resource (and therefore, the corresponding first activated beam/TCI state and the measurement result(s) including beam quality(s)/metric(s) such as L1-RSRP(s)/L1-SINR(s)) and the second activation beam RS/RS resource (and therefore, the corresponding second activated beam/TCI state and the measurement result(s) including beam quality(s)/metric(s) such as L1-RSRP(s)/L1-SINR(s)) from two separate MOs according to or following those specified herein in the present disclosure.
   When/if the first activation beam RS/RS resource (and the corresponding first activated beam/TCI state) is the same as or identical to the second activation beam RS/RS resource (and the corresponding second activated beam/TCI state), the UE could determine or identify or it could be said that the first and second Event-3 instances could be associated/specific to (a pair of) the (same) new/candidate beam RS/RS resource and the (same) activation beam RS/RS resource (or equivalently, the (same) activated beam/TCI state).
   When/if the first activation beam RS/RS resource (and the corresponding first activated beam/TCI state) is different or separate from the second activation beam RS/RS resource (and the corresponding second activated beam/TCI state), the UE could determine or identify or it could be said that the first and second Event-3 instances could be associated/specific (only) to the (same) new/candidate beam RS/RS resource.
For Event-4 as specified/defined herein in the present disclosure, when/if (higher layer(s) of) a UE has determined or identified that a first Event-4 instance is associated/specific to a new/candidate beam RS/RS resource such that the UE could determine or identify that the candidate/new beam RS/RS resource has a beam quality/metric (e.g., a measured L1-RSRP/L1-SINR) greater than or equal to a threshold value, and (higher layer(s) of) the UE has determined or identified that a second Event-2 instance is associated/specific to the (same) new/candidate beam RS/RS resource such that the UE could determine or identify that the candidate/new beam RS/RS resource has a beam quality/metric (e.g., a measured L1-RSRP/L1-SINR) greater than or equal to the threshold value, the first and second Event-4 instances could be associated/specific to the (same) new/candidate beam RS/RS resource.
For Event-5 as specified/defined herein in the present disclosure, when/if (higher layer(s) of) a UE has determined or identified that a first Event-5 instance is associated/specific to the current serving beam RS/RS resource and a new/candidate beam RS/RS resource such that the UE could determine or identify that (1) a beam quality/metric—e.g., a measured L1-RSRP/L1-SINR—of the current serving beam RS/RS resource is below or less than or equal to a first threshold, and (2) a candidate/new beam RS/RS resource that has a beam quality/metric (e.g., a measured L1-RSRP/L1-SINR) a second threshold value greater than or equal to the beam quality/metric—e.g., the measured L1-RSRP/L1-SINR—of the current serving beam RS/RS resource, and (higher layer(s) of) the UE has determined or identified that a second Event-5 instance is associated/specific to the current serving beam RS/RS resource and the (same) new/candidate beam RS/RS resource such that the UE could determine or identify that (1) a beam quality/metric—e.g., a measured L1-RSRP/L1-SINR—of the current serving beam RS/RS resource is below or less than or equal to the first threshold, and (2) the candidate/new beam RS/RS resource that has a beam quality/metric (e.g., a measured L1-RSRP/L1-SINR) the second threshold value greater than or equal to the beam quality/metric—e.g., the measured L1-RSRP/L1-SINR—of the current serving beam RS/RS resource, the first and second Event-5 instances could be associated/specific to the current serving beam RS/RS resource and the (same) new/candidate beam RS/RS resource.
For Event-6 as specified/defined herein in the present disclosure, when/if (higher layer(s) of) a UE has determined or identified that a first Event-6 instance is associated/specific to the current serving beam RS/RS resource and a new/candidate beam RS/RS resource such that the UE could determine or identify that (1) a beam quality/metric—e.g., a measured L1-RSRP/L1-SINR—of the current serving beam RS/RS resource is below or less than or equal to a first threshold, and (2) a candidate/new beam RS/RS resource that has a beam quality/metric (e.g., a measured L1-RSRP/L1-SINR) greater than or equal to a second threshold, and (higher layer(s) of) the UE has determined or identified that a second Event-6 instance is associated/specific to the current serving beam RS/RS resource and the (same) new/candidate beam RS/RS resource such that the UE could determine or identify that (1) a beam quality/metric—e.g., a measured L1-RSRP/L1-SINR—of the current serving beam RS/RS resource is below or less than or equal to the first threshold, and (2) the candidate/new beam RS/RS resource that has a beam quality/metric (e.g., a measured L1-RSRP/L1-SINR) greater than or equal to the second threshold, the first and second Event-6 instances could be associated/specific to the current serving beam RS/RS resource and the (same) new/candidate beam RS/RS resource.
For Event-7 as specified/defined herein in the present disclosure, when/if (higher layer(s) of) a UE has determined or identified that a first Event-7 instance is associated/specific to the current serving beam RS/RS resource and a new/candidate beam RS/RS resource such that the UE could determine or identify that (1) a beam quality/metric—e.g., a measured L1-RSRP/L1-SINR—of the current serving beam RS/RS resource is below or less than or equal to a first threshold, (2) a candidate/new beam RS/RS resource that has a beam quality/metric (e.g., a measured L1-RSRP/L1-SINR) a second threshold value greater than or equal to the beam quality/metric—e.g., the measured L1-RSRP/L1-SINR—of the current serving beam RS/RS resource, and (3) the (same) candidate/new beam RS/RS resource that has a beam quality/metric (e.g., a measured L1-RSRP/L1-SINR) greater than or equal to a third threshold, and (higher layer(s) of) the UE has determined or identified that a second Event-7 instance is associated/specific to the current serving beam RS/RS resource and the (same) new/candidate beam RS/RS resource such that the UE could determine or identify that (1) a beam quality/metric—e.g., a measured L1-RSRP/L1-SINR—of the current serving beam RS/RS resource is below or less than or equal to the first threshold, (2) the candidate/new beam RS/RS resource that has a beam quality/metric (e.g., a measured L1-RSRP/L1-SINR) the second threshold value greater than or equal to the beam quality/metric—e.g., the measured L1-RSRP/L1-SINR—of the current serving beam RS/RS resource, and (3) the (same) candidate/new beam RS/RS resource that has abeam quality/metric (e.g., a measured L1-RSRP/L1-SINR) greater than or equal to the third threshold, the first and second Event-7 instances could be associated/specific to the current serving beam RS/RS resource and the (same) new/candidate beam RS/RS resource.

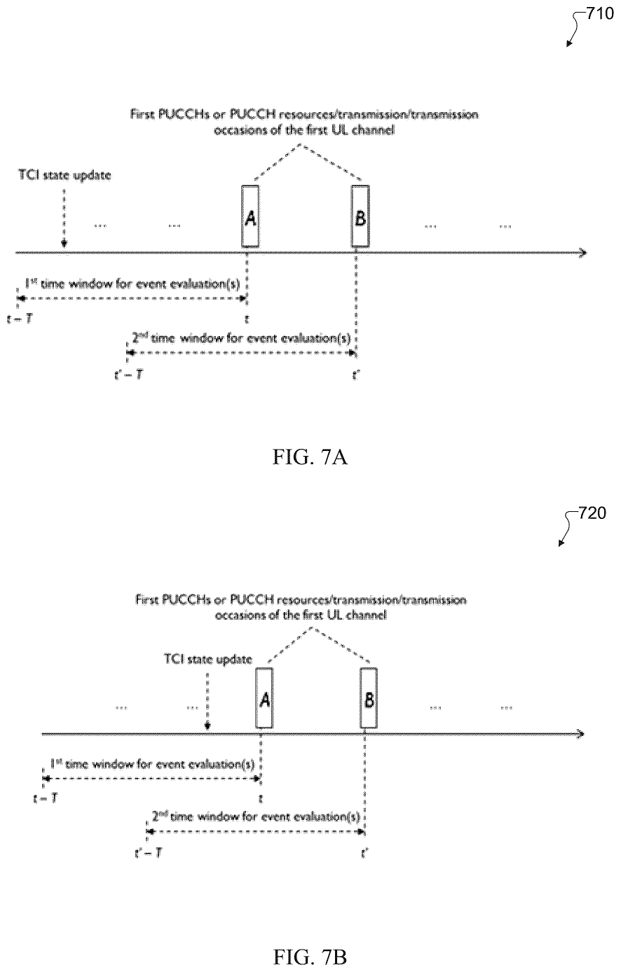

FIGS. 7A and 7B illustrate an example timeline 710 and 720 for time window determination and its relation to a transmission configuration indication (TCI) state update according to embodiments of the present disclosure. For example, timeline 710 and 720 can be followed by the UE 116 of FIG. 3. This example is for illustration only and other embodiments can be used without departing from the scope of the present disclosure.

With reference to FIG. 7A, the TCI state update within the first time window PUCCH A is not transmitted. No TCI state update within the second time window, PUCCH B can be transmitted, if event conditions are satisfied. With reference to FIG. 7B, TCI state update within the first and second time windows, both PUCCH A and PUCCH B are not transmitted.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. One conceptual example of the above described design example/procedure is presented in FIGS. 7A and 7B. The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based LI signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based LI signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. The aforementioned signal(s), channel(s), signaling(s), indication(s), configuration(s), command(s) and/or etc. that the UE receives or does not receive could also be regarded/referred to as NWR(s) in the present disclosure.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
associated/specific (only) to at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. The aforementioned signal(s), channel(s), signaling(s), indication(s), configuration(s), command(s) and/or etc. that the UE receives or does not receive could also be regarded/referred to as NWR(s) in the present disclosure.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure, and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based LI signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) qi, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based LI signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Furthermore, the reference beam RS or RS resource could be derived from an activated TCI state with the Q-th best beam quality e.g. L1-RSRP among all the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)
   The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based LI signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
The UE does not receive any of the NWR(s) and/or any form(s) of the NWR(s) as specified/defined throughout the present disclosure within the time window.

A/the new beam RS index q_new identified/determined from CBD/NBI RS (resource) set(s) q1, q10 and/or q11 for BFR does not change within the time window, the UE could transmit or trigger or initiate a transmission of the PN message/trigger over/on/via/in the PUCCH resource or transmission or transmission occasion of the first UL channel. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. Furthermore, the reference beam RS or RS resource could be derived from an activated TCI state with the Q-th best beam quality e.g. L1-RSRP among all the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B
   The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T−T_proc (e.g., in form of a slot or a symbol, i.e., slot or symbol t−T−T_proc or the (t−T−T_proc)-th slot or symbol) and ending at time t−T_proc is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Here, T_proc could be in slot, symbol, etc., which could represent processing time of PUCCH transmission(s) of the first UL channel including UCI bit(s) preparation and etc. The UE could determine or identify value(s) of T_proc according to or based on one or more of: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. When/if the UE could not determine or identify or declare an/the event within a first time window starting from time t−T−T_proc and ending at time t−T_proc according to or following those specified herein in the present disclosure: for example, when/if the UE could not identify or determine, within the first time window starting from time t−T−T_proc and ending at time t−T_proc, any candidate/new beam RS(s) or RS resource(s) that satisfies or achieves the event condition(s)—e.g., to satisfy the event condition(s) for a candidate/new beam RS or RS resource, the number/counting of event instance(s) within the first time window should be greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE does not receive a (unified) TCI state(s) activation/deactivation MAC CE within the first time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE does not receive any form/format of a beam failure recover response (BFRR) within the first time window
The UE or higher layer(s) of the UE does not start (or starts) a prohibit timer as defined/specified herein in the present disclosure within the first time window, and/or the prohibit timer expires (or does not expire) within the first time window
For Mode-A/Mode-B, the UE does not receive a DCI in Step-2 in response to the transmission of the PN message/trigger in Step-1 within the first time window
The UE does not receive reconfiguration/update/addition/removal/release (e.g., via/by/in upper layer(s) and/or RRC signaling(s) and/or MAC CE command(s) and/or dynamic DCI based LI signaling(s)) of new beam RS(s) or RS resource(s) within the first time window
The UE does not receive triggering of aperiodic or semi-persistent CSI measurement and/or reporting (e.g., via a CSI request field in a triggering DCI) within the first time window
The UE does not receive activation of semi-persistent CSI measurement and/or reporting (e.g., via SP CSI measurement and/or reporting activation MAC CE(s)) within the first time window
The current serving beam RS(s)/RS resource(s) as specified/defined herein in the present disclosure does not change within the first time window
   For Scheme-1 specified/defined herein in the present disclosure wherein CSI-RS(s) is the current serving beam RS(s)/RS resource(s), (i) the UE does not receive a TCI state update within the first time window, and/or (ii) the UE receives a TCI state update within the first time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the first time window, and/or (ii) the UE receives a TCI state update within the first time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the first time window
   For Scheme-A specified/defined herein in the present disclosure wherein CSI-RS(s) is the activation beam RS(s)/RS resource(s), (i) the UE does not receive an update to/of the corresponding activated TCI state within the first time window, and/or (ii) the UE receives an update to/of the corresponding activated TCI state within the first time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the first time window, and/or (ii) the UE receives an update to/of the corresponding activated TCI state within the first time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the first time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the first time window
A/the new beam RS index q_new identified/determined from CBD/NBI RS (resource) set(s) q1, q10 and/or q11 for BFR does not change within the first time window;
   and for another example, when/if one or more of the following conditions are achieved or satisfied:
The UE receives a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE receives a (unified) TCI state(s) activation/deactivation MAC CE within the first time window
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE receives a beam failure recover response (BFRR) within the first time window
The UE or higher layer(s) of the UE starts (or does not start) a prohibit timer as defined/specified herein in the present disclosure within the first time window, and/or the prohibit timer does not expire (or expires) within the first time window
For Mode-A/Mode-B, the UE receives a DCI in Step-2 in response to the transmission of the PN message/trigger in Step-1 within the first time window
The UE receives reconfiguration/update/addition/removal/release (e.g., via/by/in upper layer(s) and/or RRC signaling(s) and/or MAC CE command(s) and/or dynamic DCI based LI signaling(s)) of new beam RS(s) or RS resource(s) within the first time window
The UE receives triggering of aperiodic or semi-persistent CSI measurement and/or reporting (e.g., via a CSI request field in a triggering DCI) within the first time window
The UE receives activation of semi-persistent CSI measurement and/or reporting (e.g., via SP CSI measurement and/or reporting activation MAC CE(s)) within the first time window
The current serving beam RS(s)/RS resource(s) as specified/defined herein in the present disclosure changes within the first time window
   For Scheme-1 specified/defined herein in the present disclosure wherein CSI-RS(s) is the current serving beam RS(s)/RS resource(s), (i) the UE receives a TCI state update within the first time window, and/or (ii) the UE receives a TCI state update within the time window and the (QCL source) RS(s)/RS resource(s)—e.g., CSI-RS(s)—indicated in/by the TCI state changes (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE receives a TCI state update within the first time window, and/or (ii) the UE receives a TCI state update within the first time window and the SSB(s) QCL'ed with (e.g., of QCL-TypeD) the CSI-RS(s) indicated in/by the TCI state changes (in this case, the (QCL source) RS(s)/RS resource(s) of CSI-RS(s) indicated in/by the TCI state may or may not change)
The activation beam RS(s)/RS resource(s) as specified/defined herein in the present disclosure changes within the first time window
   For Scheme-A specified/defined herein in the present disclosure wherein CSI-RS(s) is the activation beam RS(s)/RS resource(s), (i) the UE receives an update to/of the corresponding activated TCI state within the first time window, and/or (ii) the UE receives an update to/of the corresponding activated TCI state within the first time window and the (QCL source) RS(s)/RS resource(s)—e.g., CSI-RS(s)—indicated in/by the activated TCI state changes (in this case, the SSB(s) QCL'ed with (e.g., of QCL-TypeD) the CSI-RS(s) indicated in/by the activated TCI state may nor may not change),
   For Scheme-B specified/defined herein in the present disclosure wherein SSB(s) is the activation beam RS(s)/RS resource(s), (i) the UE receives an update to/of the corresponding activated TCI state within the first time window, and/or (ii) the UE receives an update to/of the corresponding activated TCI state within the first time window and the SSB(s) QCL'ed with (e.g., of QCL-TypeD) the CSI-RS(s) indicated in/by the activated TCI state changes (in this case, the (QCL source) RS(s)/RS resource(s) of CSI-RS(s) indicated in/by the activated TCI state may or may not change)
The beam failure detection (BFD) RS(s)/RS resource(s) for BFR changes or the UE receives (re-)configuration(s) e.g. via RRC and/or update(s) e.g. via MAC CE to/of the BFD RS(s)/RS resource(s)—e.g., in BFD RS (resource) set(s) q0, q00 and/or q01—for BFR within the first time window
The candidate beam detection (CBD)/new beam identification (NBI) RS(s)/RS resource(s) for BFR changes or the UE receives (re-)configuration(s) e.g. via RRC and/or update(s) e.g. via MAC CE to/of the CBD/NBI RS(s)/RS resource(s)—e.g., in CBD/NBI RS (resource) set(s) q1, q10 and/or q11—for BFR within the first time window
A/the new beam RS index q_new identified/determined from CBD/NBI RS (resource) set(s) q1, q10 and/or q11 for BFR changes within the first time window
The UE does not receive any of the NWR(s) and/or any form(s) of the NWR(s) as specified/defined throughout the present disclosure within the first time window,
   the UE could determine or identify or declare an/the event when/if the number/counting of event instance(s) within a second time window starting from time t−T−T_proc−t_offset (e.g., in form of a slot or a symbol, i.e., slot or symbol t−T−T_proc−t_offset or the (t−T−T_proc−t_offset)-th slot or symbol) and ending at time t−T_proc−t_offset is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the second time window
The UE receives a TCI state update within the second time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the second time window
The UE does not receive a (unified) TCI state(s) activation/deactivation MAC CE within the second time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the second time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the second time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the second time window, wherein the UE could determine or identify the value of m according to or following those specified herein in the present disclosure
The UE does not receive any form/format of a beam failure recover response (BFRR) within the second time window
The UE or higher layer(s) of the UE does not start (or starts) a prohibit timer as defined/specified herein in the present disclosure within the second time window, and/or the prohibit timer expires (or does not expire) within the second time window
For Mode-A/Mode-B, the UE does not receive a DCI in Step-2 in response to the transmission of the PN message/trigger in Step-1 within the second time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the second time window
The UE does not receive triggering of aperiodic or semi-persistent CSI measurement and/or reporting (e.g., via a CSI request field in a triggering DCI) within the second time window
The UE does not receive activation of semi-persistent CSI measurement and/or reporting (e.g., via SP CSI measurement and/or reporting activation MAC CE(s)) within the second time window
The current serving beam RS(s)/RS resource(s) as specified/defined herein in the present disclosure does not change within the second time window
   For Scheme-1 specified/defined herein in the present disclosure wherein CSI-RS(s) is the current serving beam RS(s)/RS resource(s), (i) the UE does not receive a TCI state update within the second time window, and/or (ii) the UE receives a TCI state update within the second time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the second time window, and/or (ii) the UE receives a TCI state update within the second time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the second time window
   For Scheme-A specified/defined herein in the present disclosure wherein CSI-RS(s) is the activation beam RS(s)/RS resource(s), (i) the UE does not receive an update to/of the corresponding activated TCI state within the second time window, and/or (ii) the UE receives an update to/of the corresponding activated TCI state within the second time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the second time window, and/or (ii) the UE receives an update to/of the corresponding activated TCI state within the second time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the second time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the second time window
A/the new beam RS index q_new identified/determined from CBD/NBI RS (resource) set(s) q1, q10 and/or q11 for BFR does not change within the second time window
The UE does not receive any of the NWR(s) and/or any form(s) of the NWR(s) as specified/defined throughout the present disclosure within the second time window.

After the determination or identification or declaration of an/the event according to the second time window, the UE could transmit or trigger or initiate a transmission of the PN message/trigger over/on/via/in the PUCCH resource or transmission or transmission occasion of the first UL channel at time t. The UE could determine or identify value(s) of t_offset (e.g., in form/terms of symbol(s)/slot(s)/etc.) according to or based on: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. For example, candidate value(s) of t_offset could be {1, 2, . . . , 10, 20, 40, . . . } slot(s)/symbol(s)/ms/etc. For another example, t_offset could correspond to one or more of:
Periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
Periodicity of an event evaluation or event evaluation instance for determining an event instance according to or following those specified herein in the present disclosure
Periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). According to or following those specified herein in the present disclosure:
When/if the UE could determine or identify or declare an/the event within a k-th time window starting from time t−T−T_proc−k×t_offset and ending at time t−T_proc−k×t_offset according to or following those specified herein in the present disclosure, the UE could transmit or trigger or initiate a transmission of the PN message/trigger over/on/via/in the PUCCH resource or transmission or transmission occasion of the first UL channel at time t, and/or
When/if the UE could determine or identify or declare an/the event within a k-th time window starting from time t−T−T_proc−k×t_offset and ending at time t−T_proc−k×t_offset according to or following those specified herein in the present disclosure, the UE may not check or evaluate or assess whether the UE could determine or identify or declare an/the event within a (k+1)-th or (k−1)-th time window starting from time t−T−T_proc−(k+1)×t_offset and ending at time t−T_proc−(k+1)×t_offset according to or following those specified herein in the present disclosure, and/or
When/if the UE could not determine or identify or declare an/the event within a k-th time window starting from time t−T−T_proc−k×t_offset and ending at time t−T_proc−k×t_offset according to or following those specified herein in the present disclosure, the UE could further check or evaluate or assess whether the UE could determine or identify or declare an/the event within a (k+1)-th or (k−1)-th time window starting from time t−T−T_proc−(k+1)×t_offset and ending at time t−T_proc−(k+1)×t_offset according to or following those specified herein in the present disclosure.

In this case, k∈{0, . . . , Kmax}, wherein the UE could determine or identify value(s) of k and/or Kmax according to or based on: 1) fixed value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.
In one example, the starting time t−T−T_proc−(Kmax+1)×t_offset of the Kmax-th time window could be no earlier than t−2×T−T_proc, and/or the ending time t−Tproc−(Kmax+1)×t_offset of the Kmax-th time window could be no earlier than t−T−T_proc.
In another example, the ending time t−T_proc−(Kmax+1)×t_offset of the Kmax-th time window could be no earlier than t−T_pucch−T_proc, wherein T_pucch (e.g., in form/terms of symbol(s)/slot(s)/etc.) represents the periodicity of/for the PUCCH resource(s).

The (second) time window(s) here can also be referred to as sliding time window(s) with a time offset t_offset. The aforementioned signal(s), channel(s), signaling(s), indication(s), configuration(s), command(s) and/or etc. that the UE receives or does not receive could also be regarded/referred to as NWR(s) in the present disclosure.

In another example, when/if a UE has determined or identified or declared an event instance wherein:
for Event-1, the event instance could be associated/specific to at least one (same) new/candidate beam RS/RS resource according to or following those specified herein in the present disclosure
for Event-2, the event instance could be associated/specific to the current beam RS/RS resource according to or following those specified herein in the present disclosure
for Event-3, the event instance could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure
(higher layer(s) of) the UE could start a time window/timer;
according to or following those specified herein in the present disclosure, when/if (higher layer(s) of) the UE has determined or identified the aforementioned event instance before end of the time window and/or within the time window (e.g., before the last symbol/slot/etc. of the time window, wherein duration/length of the time window could be higher layer configured) and/or before the timer expires, (higher layer(s) of) the UE could increment an event instance count/counting for or of or specific to the new beam RS or RS resource by one;
before end of the time window and/or within the time window (e.g., before the last symbol/slot/etc. of the time window, wherein duration/length of the time window could be higher layer configured) and/or before the timer expires, when/if (higher layer(s) of) the UE has determined or identified that the number of the event instance(s) and/or the event instance count(s)/counting(s) is greater than or equal to maxCount (e.g., higher layer configured), (higher layer(s) of) the UE could determine or identify or declare a potential/candidate event occurrence.

For Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could first determine or identify a time duration starting from time t−T_du−T_proc (e.g., in form of a slot or a symbol, i.e., slot or symbol t−T_du−T_proc or the (t−T_du−T_proc)-th slot or symbol) and ending at time t−Tproc—e.g., the time duration here could be associated/specific/corresponding to the PUCCH resource or transmission or transmission occasion at time t. The UE (e.g., higher layer(s) of the UE) could determine or identify or declare an/the event when/if (higher layer(s) of) the UE could determine or identify or declare at least one potential/candidate event occurrence (or one or more potential/candidate event occurrence) according to or following those specified or described herein in the present disclosure within the aforementioned time duration associated/specific/corresponding to the PUCCH resource or transmission or transmission occasion at time t—for instance,
the start of the time window(s)/timer(s) used to determine or identify or declare the at least one (or the one or more) potential/candidate event occurrence(s) could be after or no earlier than the start of the time duration; and/or
the end of the time window(s) used to determine or identify or declare the at least one (or the one or more) potential/candidate event occurrence(s) could be before or no later than the end of the time duration, or the timer(s) used to determine or identify or declare the at least one (or the one or more) potential/candidate event occurrence(s) may not expire or may not be expired before or no later than the end of the time duration; and/or
the time window(s) used to determine or identify or declare the at least one (or the one or more) potential/candidate event occurrence(s) could be within the time duration
   and/or when/if one or more of the following conditions are achieved or satisfied:
The UE does not receive a TCI state update within the time duration
The UE receives a TCI state update within the time duration, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time duration
The UE does not receive a (unified) TCI state(s) activation/deactivation MAC CE within the time duration
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time duration
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time duration, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time duration, wherein the UE could determine or identify the value of m according to or following those specified herein in the present disclosure
The UE does not receive any form/format of a beam failure recover response (BFRR) within the time duration
The UE or higher layer(s) of the UE does not start (or starts) a prohibit timer as defined/specified herein in the present disclosure within the time duration, and/or the prohibit timer expires (or does not expire) within the time duration
For Mode-A/Mode-B, the UE does not receive a DCI in Step-2 in response to the transmission of the PN message/trigger in Step-1 within the time duration
The UE does not receive reconfiguration/update/addition/removal/release (e.g., via/by/in upper layer(s) and/or RRC signaling(s) and/or MAC CE command(s) and/or dynamic DCI based LI signaling(s)) of new beam RS(s) or RS resource(s) within the time duration
The UE does not receive triggering of aperiodic or semi-persistent CSI measurement and/or reporting (e.g., via a CSI request field in a triggering DCI) within the time duration
The UE does not receive activation of semi-persistent CSI measurement and/or reporting (e.g., via SP CSI measurement and/or reporting activation MAC CE(s)) within the time duration
The current serving beam RS(s)/RS resource(s) as specified/defined herein in the present disclosure does not change within the time duration
   For Scheme-1 specified/defined herein in the present disclosure wherein CSI-RS(s) is the current serving beam RS(s)/RS resource(s), (i) the UE does not receive a TCI state update within the time duration, and/or (ii) the UE receives a TCI state update within the time duration but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time duration, and/or (ii) the UE receives a TCI state update within the time duration but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time duration
   For Scheme-A specified/defined herein in the present disclosure wherein CSI-RS(s) is the activation beam RS(s)/RS resource(s), (i) the UE does not receive an update to/of the corresponding activated TCI state within the time duration, and/or (ii) the UE receives an update to/of the corresponding activated TCI state within the time duration but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time duration, and/or (ii) the UE receives an update to/of the corresponding activated TCI state within the time duration but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time duration
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time duration
A/the new beam RS index q_new identified/determined from CBD/NBI RS (resource) set(s) q1, q10 and/or q11 for BFR does not change within the time duration
The UE does not receive any of the NWR(s) and/or any form(s) of the NWR(s) as specified/defined throughout the present disclosure within the time duration.

After the determination or identification or declaration of an/the event according to the time duration, the UE could transmit or trigger or initiate a transmission of the PN message/trigger over/on/via/in the PUCCH resource or transmission or transmission occasion of the first UL channel at time t. Here, the UE could determine or identify value(s) of the time duration and/or T_du according to or following: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
For example, T_du could correspond to or higher layer configured as T_pucch, wherein T_pucch represents the periodicity of the PUCCH resource(s)/transmission(s)/transmission occasion(s) of the first UL channel.
For another example, T_du could correspond to or higher layer configured as 0 or T_pucch or a value (e.g., in form/terms of number of symbol(s)/slot(s)/ms/etc.) in the range of [0, T_pucch], wherein T_pucch represents the periodicity of the PUCCH resource(s)/transmission(s)/transmission occasion(s) of the first UL channel.
For another example, T_du could correspond to or higher layer configured as the periodicity of an event evaluation or event evaluation instance for determining an event instance according to or following those specified herein in the present disclosure
For another example, T_du could correspond to or higher layer configured as the periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
For another example, T_du could correspond to or higher layer configured as min{periodicity of a first MO, periodicity of a second MO}
For another example, T_du could correspond to or higher layer configured as max{periodicity of a first MO, periodicity of a second MO}
For another example, T_du could correspond to or higher layer configured as max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Furthermore, according to or following those specified herein in the present disclosure, i.e., for the operation(s) in Mode-A, Mode-B and/or Mode-C as specified/defined herein in the present disclosure, the UE could send or transmit to the network beam report(s)—e.g., via/in/by the (CG/DG) PUSCH resource(s) of the second UL channel—associated/specific to the transmission or triggering or initiation of the transmission of the PN message/trigger over/on/via/in the PUCCH resource or transmission or transmission occasion of the first UL channel at time t. In this case, the UE could determine or identify report content(s)/quantity(s) including at least SSBRI(s)/CRI(s) and/or L1-RSRP(s)/L1-SINR(s) of the beam report(s) based on or according to at least the new/candidate beam RS(s)/RS resource(s) associated or specific or corresponding to the potential/candidate event occurrence(s) determined or identified or declared by (higher layer(s) of) the UE within the time duration specific/corresponding/associated to the PUCCH resource or transmission or transmission occasion of the first UL channel at time t. For this design example, the time window(s) associated/specific to the event instance(s) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,

could correspond to or could be sliding time window(s) as specified/defined herein in the present disclosure. The aforementioned signal(s), channel(s), signaling(s), indication(s), configuration(s), command(s) and/or etc. that the UE receives or does not receive could also be regarded/referred to as NWR(s) in the present disclosure.

Throughout the present disclosure, when/if (higher layer(s) of) the UE starts a time window/timer of or for or specific to a new/candidate beam RS/RS resource for determining or identifying or declaring event instance(s) according to or following those specified herein in the present disclosure,
In one example, before the end of the time window or before the timer expires, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may start another time window/timer of or for or specific to a/the same new/candidate beam RS/RS resource for determining or identifying or declaring event instance(s) according to or following those specified herein in the present disclosure no earlier than the end of the time window or the expiration of the timer.
In another example, after (higher layer(s)) of the UE has started the time window/timer, (higher layer(s) of) the UE could start a prohibit timer specific/corresponding/associated to the time window/timer. In this case, when/if the prohibit timer is running, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may not start another time window/timer of or for or specific to a/the same new/candidate beam RS/RS resource for determining or identifying or declaring event instance(s) according to or following those specified herein in the present disclosure before the expiration of the prohibit timer. The UE could determine or identify value(s)/duration(s)/length(s) of the prohibit timer (e.g., in slot(s)/symbol(s)/ms/etc.) based on or according to: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based LI signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Throughout the present disclosure, a time duration, a time window, a time offset, a time gap and/or etc. could be equivalent such that they can be used in an exchangeable manner.

Throughout the present disclosure, any time duration, time length, time window, time gap or time offset could be in form/terms of (number of) slot(s)/symbol(s) or milli-second, i.e., ms. Furthermore, throughout the present disclosure, within a time window/duration as specified/defined herein in the present disclosure, (higher layer(s) of) the UE could reset the counting of event instance(s), e.g., to zero, when/if one or more of the following conditions are achieved or satisfied:
The UE receives a TCI state update within the time window/duration
The UE receives a TCI state update within the time window/duration, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based LI signaling(s)) of the (measured) current beam RS/RS resource associated/specific to or determined/identified based on or according to the indicated TCI state according to or following those specified herein in the present disclosure within the time window/duration
The UE receives a (unified) TCI state(s) activation/deactivation MAC CE within the time window/duration
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window/duration
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window/duration, wherein the UE could determine or identify the value of m according to or following those specified herein in the present disclosure
The UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window/duration, wherein the UE could determine or identify the value of m according to or following those specified herein in the present disclosure
The UE receives a beam failure recover response (BFRR) within the time window/duration
The UE or higher layer(s) of the UE starts (or does not start) a prohibit timer as defined/specified herein in the present disclosure within the time window/duration, and/or the prohibit timer does not expire (or expires) within the time window/duration
For Mode-A/Mode-B, the UE receives a DCI in Step-2 in response to the transmission of the PN message/trigger in Step-1 within the time window/duration
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window/duration
The UE receives triggering of aperiodic or semi-persistent CSI measurement and/or reporting (e.g., via a CSI request field in a triggering DCI) within the time window/duration
The UE receives activation of semi-persistent CSI measurement and/or reporting (e.g., via SP CSI measurement and/or reporting activation MAC CE(s)) within the time window/duration
The current serving beam RS(s)/RS resource(s) as specified/defined herein in the present disclosure changes within the time window/duration
   For Scheme-1 specified/defined herein in the present disclosure wherein CSI-RS(s) is the current serving beam RS(s)/RS resource(s), (i) the UE receives a TCI state update within the time window/duration, and/or (ii) the UE receives a TCI state update within the time window/duration and the (QCL source) RS(s)/RS resource(s)—e.g., CSI-RS(s)—indicated in/by the TCI state changes (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE receives a TCI state update within the time window/duration, and/or (ii) the UE receives a TCI state update within the time window/duration and the SSB(s) QCL'ed with (e.g., of QCL-TypeD) the CSI-RS(s) indicated in/by the TCI state changes (in this case, the (QCL source) RS(s)/RS resource(s) of CSI-RS(s) indicated in/by the TCI state may or may not change)
The activation beam RS(s)/RS resource(s) as specified/defined herein in the present disclosure changes within the time window/duration
   For Scheme-A specified/defined herein in the present disclosure wherein CSI-RS(s) is the activation beam RS(s)/RS resource(s), (i) the UE receives an update to/of the corresponding activated TCI state within the time window/duration, and/or (ii) the UE receives an update to/of the corresponding activated TCI state within the time window/duration and the (QCL source) RS(s)/RS resource(s)—e.g., CSI-RS(s)—indicated in/by the activated TCI state changes (in this case, the SSB(s) QCL'ed with (e.g., of QCL-TypeD) the CSI-RS(s) indicated in/by the activated TCI state may nor may not change),
   For Scheme-B specified/defined herein in the present disclosure wherein SSB(s) is the activation beam RS(s)/RS resource(s), (i) the UE receives an update to/of the corresponding activated TCI state within the time window/duration, and/or (ii) the UE receives an update to/of the corresponding activated TCI state within the time window/duration and the SSB(s) QCL'ed with (e.g., of QCL-TypeD) the CSI-RS(s) indicated in/by the activated TCI state changes (in this case, the (QCL source) RS(s)/RS resource(s) of CSI-RS(s) indicated in/by the activated TCI state may or may not change)
The beam failure detection (BFD) RS(s)/RS resource(s) for BFR changes or the UE receives (re-)configuration(s) e.g. via RRC and/or update(s) e.g. via MAC CE to/of the BFD RS(s)/RS resource(s)—e.g., in BFD RS (resource) set(s) q0, q00 and/or q01—for BFR within the time window/duration
The candidate beam detection (CBD)/new beam identification (NBI) RS(s)/RS resource(s) for BFR changes or the UE receives (re-)configuration(s) e.g. via RRC and/or update(s) e.g. via MAC CE to/of the CBD/NBI RS(s)/RS resource(s)—e.g., in CBD/NBI RS (resource) set(s) q1, q10 and/or q11—for BFR within the time window/duration
A/the new beam RS index q_new identified/determined from CBD/NBI RS (resource) set(s) q1, q10 and/or q11 for BFR changes within the time window/duration
The UE receives from the network a NWR (in any form(s)) as specified/defined throughout the present disclosure within the time window/duration,
   wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure.

The aforementioned signal(s), channel(s), signaling(s), indication(s), configuration(s), command(s) and/or etc. that the UE receives or does not receive could also be regarded/referred to as NWR(s) in the present disclosure.

For the (above) described or specified design examples in the present disclosure, the UE could perform or conduct or carry out or do the aforementioned determination or identification or declaration of an/the event, and/or instance(s) of the aforementioned determination or identification or declaration of an/the event could be:
for each periodic PUCCH resource or transmission or transmission occasion of the first UL channel
based on or according to (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling
with a periodicity, wherein
   the periodicity could be the same as the periodicity of the PUCCH resource(s)/transmission(s)/transmission occasion(s) of the first UL channel
   the periodicity could be a fixed value in system specification(s) and/or per RRC (re-)configuration
   the periodicity could be determined by the UE and subject to a corresponding UE's capability/capability signaling
   the periodicity could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling
with a (minimum) time gap/offset between two adjacent or neighboring instances of determination or identification or declaration of an/the event, wherein
   the (minimum) time gap/offset could be the same as the periodicity of the PUCCH resource(s)/transmission(s)/transmission occasion(s) of the first UL channel
   the (minimum) time gap/offset could be a fixed value in system specification(s) and/or per RRC (re-)configuration
   the (minimum) time gap/offset could be determined by the UE and subject to a corresponding UE's capability/capability signaling
   the (minimum) time gap/offset could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling

For the (above) described or specified design examples in the present disclosure, within the time window, when/if the UE
receives a TCI state update
receives a TCI state update, and the (measured) current beam RS/RS resource associated/specific to or determined/identified based on or according to the TCI state update or updated TCI state according to or following those specified herein in the present disclosure is updated/changed in contrast to or different from the previous one
receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure
receives a (unified) TCI state(s) activation/deactivation MAC CE
receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure
receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure
receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the UE could determine or identify the value of m according to or following those specified herein in the present disclosure
receives a beam failure recover response (BFRR)
starts (or does not start) a prohibit timer as defined/specified herein in the present disclosure, and/or the prohibit timer does not expire (or expires)
for Mode-A/Mode-B, receives a DCI in Step-2 in response to the transmission of the PN message/trigger in Step-1
receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
receives triggering of aperiodic or semi-persistent CSI measurement and/or reporting (e.g., via a CSI request field in a triggering DCI)
receives activation of semi-persistent CSI measurement and/or reporting (e.g., via SP CSI measurement and/or reporting activation MAC CE(s))
receives a change/update to/of the current serving beam RS(s)/RS resource(s) as specified/defined herein in the present disclosure
   For Scheme-1 specified/defined herein in the present disclosure wherein CSI-RS(s) is the current serving beam RS(s)/RS resource(s), the UE receives (i) a TCI state update, and/or (ii) a TCI state update with a change/update to/of the (QCL source) RS(s)/RS resource(s)—e.g., CSI-RS(s)—indicated in/by the TCI state (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), the UE receives (i) a TCI state update, and/or (ii) a TCI state update with a change/update to/of the SSB(s) QCL'ed with (e.g., of QCL-TypeD) the CSI-RS(s) indicated in/by the TCI state (in this case, the (QCL source) RS(s)/RS resource(s) of CSI-RS(s) indicated in/by the TCI state may or may not change)
receives a change/update to/of the activation beam RS(s)/RS resource(s) as specified/defined herein in the present disclosure changes
   For Scheme-A specified/defined herein in the present disclosure wherein CSI-RS(s) is the activation beam RS(s)/RS resource(s), the UE receives (i) an update to/of the corresponding activated TCI state, and/or (ii) an update to/of the corresponding activated TCI state with a change/update to/of the (QCL source) RS(s)/RS resource(s)—e.g., CSI-RS(s)—indicated in/by the activated TCI state (in this case, the SSB(s) QCL'ed with (e.g., of QCL-TypeD) the CSI-RS(s) indicated in/by the activated TCI state may nor may not change),
   For Scheme-B specified/defined herein in the present disclosure wherein SSB(s) is the activation beam RS(s)/RS resource(s), the UE receives (i) an update to/of the corresponding activated TCI state, and/or (ii) an update to/of the corresponding activated TCI state with a change/update to/of the SSB(s) QCL'ed with (e.g., of QCL-TypeD) the CSI-RS(s) indicated in/by the activated TCI state (in this case, the (QCL source) RS(s)/RS resource(s) of CSI-RS(s) indicated in/by the activated TCI state may or may not change)
receives (re-)configuration(s) e.g. via RRC and/or update(s) e.g. via MAC CE and/or change(s) to/of the beam failure detection (BFD) RS(s)/RS resource(s)—e.g., in BFD RS (resource) set(s) q0, q00 and/or q01—for BFR
receives (re-)configuration(s) e.g. via RRC and/or update(s) e.g. via MAC CE and/or change(s) to/of the candidate beam detection (CBD)/new beam identification (NBI) RS(s)/RS resource(s)—e.g., in CBD/NBI RS (resource) set(s) q1, q10 and/or q11—for BFR
receives a change/update to/of a/the new beam RS index q_new identified/determined from CBD/NBI RS (resource) set(s) q1, q10 and/or q11 for BFR
receives an NWR (in any form(s)) as specified/defined throughout the present disclosure the UE could reset the number/counting of the event instance(s) determined or identified or declared
within the corresponding time window
before the reception of the TCI state update
before the reception of the (unified) TCI state(s) activation/deactivation MAC CE
for Mode-A/Mode-B, before the reception of the DCI in Step-2 in response to the transmission of the PN message/trigger in Step-1
before the reception of the reconfiguration of new beam RS(s) or RS resource(s)
before the reception of the triggering of aperiodic or semi-persistent CSI measurement and/or reporting (e.g., via a CSI request field in a triggering DCI)
before the reception of the activation of semi-persistent CSI measurement and/or reporting (e.g., via SP CSI measurement and/or reporting activation MAC CE(s)) to zero, wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure.

The aforementioned signal(s), channel(s), signaling(s), indication(s), configuration(s), command(s) and/or etc. that the UE receives or does not receive could also be regarded/referred to as NWR(s) in the present disclosure.

In one example, for one or more RSs or RS resources each corresponding to one or more of: (1) a (same) new/candidate beam RS/RS resource (e.g., for Event-1 or Event-3 or Event-4 or Event-5 or Event-6 or Event-7), (2) the current beam RS/RS resource (e.g., for Event-2 or Event-5 or Event-6 or Event-7), (3) (a pair of) a (same) new/candidate beam RS/RS resource and a (same) activation beam RS/RS resource (or equivalently, a (same) activated beam/TCI state)—e.g., for Event-3, the MAC entity of/for a UE could or shall for each Serving Cell configured/enabled for UE-initiated/event-driven beam reporting according to those specified herein in the present disclosure:
1> to initiate or trigger a UEI/event-driven beam reporting based on or according to detection or declaration or determination of an event (e.g., Event-1, Event-2, Event-3, Event-4, Event-5, Event-6 and/or Event-7 in the present disclosure), e.g., to transmit or trigger or initiate a transmission of the PN message/trigger over/on/via/in the PUCCH resource or PUCCH transmission or PUCCH transmission occasion of the first UL channel in Mode A and/or Mode B and/or Mode C at time t:
   2> if an indication for an event instance (e.g., an Event-1 instance or an Event-2 instance or an Event-3 instance or an Event-4 instance or an Event-5 instance or an Event-6 instance or an Event-7 instance) associated/specific to the one or more RSs or RS resources determined or identified according to or following those specified herein in the present disclosure has been received from lower layers:
      3> start or restart an EventlnstanceDetectionTimer (higher layer configured for the event—when/if applicable), e.g., associated/specific to the one or more RSs or RS resources;
      3> increment an EventInstanceCounter (higher layer configured for the event—when/if applicable), e.g., associated/specific to the one or more RSs or RS resources by 1;
      3> if EventInstanceCounter>=EventInstanceMaxCount (higher layer configured for the event—when/if applicable), identify or determine or detect or declare a first potential/candidate event occurrence, e.g., associated/specific to the one or more RSs or RS resources, according to or following those specified herein in the present disclosure:
         4> if the identification or determination or detection or declaration of the first potential/candidate event occurrence is within a time duration starting from time t−T_du−T_proc (e.g., in form of a slot or a symbol, i.e., slot or symbol t−T_du−T_proc or the (t−T_du−T_proc)-th slot or symbol) and ending at time t−Tproc—e.g., the time duration here could be associated/specific/corresponding to the PUCCH resource or transmission or transmission occasion of the first UL channel in Mode-A and/or Mode-B and/or Mode-C at time t, wherein T_du, T_proc and/or etc. could be determine or identified according to or following those specified herein in the present disclosure, and/or
         4> if there is no other potential/candidate event occurrence(s), e.g., associated/specific to the same one or more RSs or RS resources, identified or determined within the aforementioned time window starting from time t−T_du−T_proc (e.g., in form of a slot or a symbol, i.e., slot or symbol t−T_du−T_proc or the (t−T_du−T_proc)-th slot or symbol) and ending at time t−T_proc and later in time than the identification or determination or detection of the first potential/candidate event occurrence
         5> trigger or initiate a transmission of the PN message/trigger over/on/via/in the PUCCH resource or PUCCH transmission or PUCCH transmission occasion of the first UL channel at time t according to or based on (identification, determination, detection or declaration of) at least the first potential/candidate event occurrence, wherein the report content(s)/quantity(s) in the UEI beam report(s) could be determined or identified according to or based on (identification, determination, detection or declaration of) at least the first potential/candidate event occurrence (hence, the one or more RSs or RS resources associated/specific to the first potential/candidate event occurrence);
   2> if one or more of the following conditions are satisfied or achieved:
      the EventlnstanceDetectionTimer, e.g., associated/specific to the one or more RSs or RS resources, expires
      the UE receives a TCI state update
      the UE receives a (unified) TCI state(s) activation/deactivation MAC CE
      the UE receives a (unified) TCI state(s) activation/deactivation MAC CE that activates or updates the activation beam RS(s)/RS resource(s), and therefore, the corresponding activated beam(s)/TCI state(s), used for determining or identifying the first candidate/potential event occurrence according to or following those specified herein in the present disclosure
      the UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command used for determining or identifying the first candidate/potential event occurrence according to or following those specified herein in the present disclosure, wherein the UE could determine or identify the value of m according to or following those specified herein in the present disclosure
      the UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure—used for determining or identifying the first candidate/potential event occurrence, wherein the UE could determine or identify the value of m according to or following those specified herein in the present disclosure
      the UE receives a beam failure recover response (BFRR)
      for Mode-A/Mode-B, the UE receives a DCI in Step-2 in response to the transmission of the PN message/trigger in Step-1
      the UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
      the UE receives reconfiguration/update/addition/removal/release (e.g., via/by/in upper layer(s) and/or RRC signaling(s) and/or MAC CE command(s) and/or dynamic DCI based LI signaling(s)) of the one or more RSs or RS resources
      the UE receives triggering of aperiodic or semi-persistent CSI measurement and/or reporting (e.g., via a CSI request field in a triggering DCI)
      the UE receives activation of semi-persistent CSI measurement and/or reporting (e.g., via SP CSI measurement and/or reporting activation MAC CE(s))
      the current serving beam RS(s)/RS resource(s) as specified/defined herein in the present disclosure changes
      For Scheme-1 specified/defined herein in the present disclosure wherein CSI-RS(s) is the current serving beam RS(s)/RS resource(s), (i) the UE receives a TCI state update, and/or (ii) the UE receives a TCI state update and the (QCL source) RS(s)/RS resource(s)—e.g., CSI-RS(s)—indicated in/by the TCI state changes (in this case, the SSB(s) QCL'ed with (e.g., of QCL-TypeD) the CSI-RS(s) indicated in/by the TCI state may or may not change),
      For Scheme-2 specified/defined herein in the present disclosure wherein SSB(s) is the current serving beam RS(s)/RS resource(s), (i) the UE receives a TCI state update, and/or (ii) the UE receives a TCI state update and the SSB(s) QCL'ed with (e.g., of QCL-TypeD) the CSI-RS(s) indicated in/by the TCI state changes (in this case, the (QCL source) RS(s)/RS resource(s) of CSI-RS(s) indicated in/by the TCI state may or may not change)
      the activation beam RS(s)/RS resource(s) as specified/defined herein in the present disclosure changes
      For Scheme-A specified/defined herein in the present disclosure wherein CSI-RS(s) is the activation beam RS(s)/RS resource(s), (i) the UE receives an update to/of the corresponding activated TCI state, and/or (ii) the UE receives an update to/of the corresponding activated TCI state and the (QCL source) RS(s)/RS resource(s)—e.g., CSI-RS(s)—indicated in/by the activated TCI state changes (in this case, the SSB(s) QCL'ed with (e.g., of QCL-TypeD) the CSI-RS(s) indicated in/by the activated TCI state may nor may not change),
      For Scheme-B specified/defined herein in the present disclosure wherein SSB(s) is the activation beam RS(s)/RS resource(s), (i) the UE receives an update to/of the corresponding activated TCI state, and/or (ii) the UE receives an update to/of the corresponding activated TCI state and the SSB(s) QCL'ed with (e.g., of QCL-TypeD) the CSI-RS(s) indicated in/by the activated TCI state changes (in this case, the (QCL source) RS(s)/RS resource(s) of CSI-RS(s) indicated in/by the activated TCI state may or may not change)
      the beam failure detection (BFD) RS(s)/RS resource(s) for BFR changes or the UE receives (re-)configuration(s) e.g. via RRC and/or update(s) e.g. via MAC CE to/of the BFD RS(s)/RS resource(s)—e.g., in BFD RS (resource) set(s) q0, q00 and/or q01—for BFR
      the candidate beam detection (CBD)/new beam identification (NBI) RS(s)/RS resource(s) for BFR changes or the UE receives (re-)configuration(s) e.g. via RRC and/or update(s) e.g. via MAC CE to/of the CBD/NBI RS(s)/RS resource(s)—e.g., in CBD/NBI RS (resource) set(s) q1, q10 and/or q11—for BFR
      a/the new beam RS index q_new identified/determined from CBD/NBI RS (resource) set(s) q1, q10 and/or q11 for BFR changes
      The UE receives from the network a NWR (in any form(s)) as specified/defined throughout the present disclosure
      3> set EventInstanceCounter, e.g., associated/specific to the one or more RSs or RS resources, to 0.

The one or more RSs or RS resources could belong to or could be a subset of or one(s) of all the RS(s) or RS resource(s) configured, provided, determined or identified for event evaluation(s) according to or following those specified/described herein in the present disclosure, wherein one or more of or each of the RS(s) or RS resource(s) configured, provided, determined or identified for event evaluation(s) could correspond to one or more of:
the current beam RS/RS resource
new/candidate beam RS(s)/RS resource(s) in the corresponding resource set
activation beam RS(s)/RS resource(s) in the corresponding activated TCI state(s), e.g., provided/indicated in a (unified) TCI state(s) activation/deactivation MAC CE
Pair(s) of new/candidate beam RS(s)/RS resource(s) in the corresponding resource set and activation beam RS(s)/RS resource(s) in the corresponding activated TCI state(s), e.g., provided/indicated in a (unified) TCI state(s) activation/deactivation MAC CE

According to or following those specified herein in the present disclosure, a UE or higher layer(s) of the UE could trigger or initiate a transmission of the PN message/trigger over/on/via/in the PUCCH resource or PUCCH transmission or PUCCH transmission occasion of the first UL channel in Mode A and/or Mode B and/or Mode C according to or based on (identification, determination, detection or declaration of) one or more potential/candidate event occurrences, wherein each of the one or more potential/candidate event occurrences could be associated/specific to different/separate (sets of) RSs or RS resources. In this case, the corresponding UEI/event-driven beam report(s)—e.g., carried or conveyed or transmitted or sent via PUSCH resource(s) of the second UL channel in Mode A and/or Mode B and/or Mode C associated/specific to the transmission of the PN message/trigger over/on/via/in the PUCCH resource or PUCCH transmission or PUCCH transmission occasion of the first UL channel in Mode A and/or Mode B and/or Mode C—could comprise or include or contain report content(s)/quantity(s) including resource indicator(s) such as SSBRI(s)/CRI(s) and beam metric(s) such as L1-RSRP(s)/L1-SINR(s) determined or identified according to or based on (identification, determination, detection or declaration of) the one or more potential/candidate event occurrences (hence, the RS(s) or RS resource(s) associated/specific to the potential/candidate event occurrence(s)).

A UE or higher layer(s) of a UE could start a prohibit timer (duration, length and/or etc. of the prohibit timer and/or how/when the prohibit timer would expire could be higher layer configured)
after the last symbol/slot/etc. of transmitting a PN message/trigger on/over/in a PUCCH resource or a PUCCH transmission/transmission occasion of the first UL channel of Mode A and/or Mode B and/or Mode C, and/or
after the last symbol/slot/etc. of receiving the UL grant DCI in Step-2 of Mode A and/or Mode C, and/or
after the last symbol/slot/etc. of when the UL grant DCI received in Step-2 of Mode A and/or Mode C has become applicable, and/or
° after the last symbol/slot/etc. of transmitting a beam report on/over/in (DG and/or CG e.g. Type1 CG) PUSCH resource(s) of the second UL channel of Mode A and/or Mode B and/or Mode C.

When a prohibit timer is running, the UE or higher layer(s) of the UE may not transmit any PN message(s)/trigger(s)/notification(s) on/over/in a PUCCH resource or a PUCCH transmission/transmission occasion of the first UL channel (e.g., in Mode A, Mode B and/or Mode C). That is, only when there is no prohibit timer running, the UE or higher layer(s) of the UE could transmit a PN message/trigger on/over/in a PUCCH resource or a PUCCH transmission/transmission occasion of the first UL channel (e.g., in Mode A, Mode B and/or Mode C). In addition, when/if a prohibit timer is running, and/or when/if the duration, length and/or etc. of the prohibit timer is less/smaller (or larger/greater) than or equal to a threshold,
in one example, the UE or higher layer(s) of the UE could continue performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE may not reset the number/counting of the event instance(s), e.g., to zero, and could continue/keep incrementing the number/counting of the (same) event instance(s) counted before the prohibit timer starts according to or following those specified herein in the present disclosure;
   for another example, when/if the UE or higher layer(s) of the UE starts the prohibit timer, the UE or higher layer(s) of the UE could or may reset the number/counting of the event instance(s), e.g., to zero;
   for another example, when/if or after the prohibit timer expires, the UE or higher layer(s) of the UE could or may reset the number/counting of the event instance(s), e.g., to zero;
in another example, the UE or higher layer(s) of the UE could stop performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE could or may reset the number/counting of the event instance(s), e.g., to zero;
   for another example, when/if the UE or higher layer(s) of the UE starts the prohibit timer, the UE or higher layer(s) of the UE may not reset the number/counting of the event instance(s), e.g., to zero, and when/if or after the prohibit timer expires, the UE or higher layer(s) of the UE could continue/keep incrementing the number/counting of the (same) event instance(s) counted before the prohibit timer starts according to or following those specified herein in the present disclosure

The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n times with n=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Otherwise, e.g., when/if a prohibit timer is running, and/or when/if the duration, length and/or etc. of the prohibit timer is larger/greater (or less/smaller) than or equal to the threshold specified herein in the present disclosure,
the UE or higher layer(s) of the UE could stop performing or conducting the event evaluation(s) including counting of the event instance(s) according to or following those specified herein in the present disclosure, and/or
when/if the UE or higher layer(s) of the UE starts the prohibit timer, the UE or higher layer(s) of the UE could or may reset the number/counting of the event instance(s), e.g., to zero, and/or
when/if or after the prohibit timer expires, the UE or higher layer(s) of the UE could or may reset the number/counting of the event instance(s), e.g., to zero, and/or
when/if or after the prohibit timer expires, the UE or higher layer(s) of the UE may not continue/keep incrementing the number/counting of the (same) event instance(s) counted before the prohibit timer starts according to or following those specified herein in the present disclosure.

Regarding the event instance(s) specified/discussed herein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure.

In addition, UE could determine or identify the value of n according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The aforementioned signal(s), channel(s), signaling(s), indication(s), configuration(s), command(s) and/or etc. that the UE receives or does not receive could also be regarded/referred to as NWR(s) in the present disclosure.

According to or following those specified herein in the present disclosure, when/if a UE or higher layer(s) of a UE has determined or detected or declared an event and there is no prohibit timer running, the UE could transmit a PN message/trigger on/over/in/by a first PUCCH resource or a first PUCCH transmission/transmission occasion (of the first UL channel) at time t, wherein the UE could determine or identify association(s)/linkage(s)/correspondence(s)—e.g., in terms of their timing relations—between the determination or detection or declaration of the event and the first PUCCH resource or first PUCCH transmission or first PUCCH transmission occasion at time t according to or following those specified herein in the present disclosure. When/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′ to transmit a PN message/trigger based on the determination, detection or declaration of the event according to or following those specified herein in the present disclosure, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′.

Furthermore, delta_t=t′−t could be smaller/less (or larger/greater) than or equal to a threshold. The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n′ times with n′=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). In addition, the UE could determine or identify the value of n′ according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Alternatively, when/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′. When/if delta_t=t′−t is greater/larger (or less/smaller) than or equal to the threshold specified herein in the present disclosure, the UE may not transmit a PN message/trigger on/over/in/by the second PUCCH resource or second PUCCH transmission/transmission occasion of the first UL channel at time t′ based on the determination, detection or declaration of the event according to or following those specified herein in the present disclosure, and/or
the UE may not transmit any PN message(s)/trigger(s) on/over/in/by any PUCCH resource(s) or any PUCCH transmission(s)/transmission occasion(s) of the first UL channel based on the determination, detection or declaration of the event according to or following those specified herein in the present disclosure.

According to or following those specified herein in the present disclosure, a UE could perform or conduct event(s) evaluation(s) and/or event instance(s) evaluation(s) in MAC/L2/L3/upper layer(s) and/or PHY/L1/lower layer(s). The UE could determine or identify MAC/L2/L3/upper layer(s) and/or PHY/L1/lower layer(s) to evaluate the event(s) or the event instance(s) according to or following those specified herein in the present disclosure according to or based on: fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In one example, when/if Mode A (or Mode C) is enabled, the UE could perform or conduct event(s) evaluation(s) and/or event instance(s) evaluation(s) in MAC/L2/L3/upper layer(s); otherwise, i.e., when/if Mode B (or Mode C) is enabled, the UE could perform or conduct event(s) evaluation(s) and/or event instance(s) evaluation(s) in PHY/L1/lower layer(s).
In another example, when/if a (dedicated) SR (e.g., the corresponding SR configuration is associated with a SR ID or SR configuration ID) is used as the first UL channel, the UE could perform or conduct event(s) evaluation(s) and/or event instance(s) evaluation(s) in MAC/L2/L3/upper layer(s); otherwise, e.g., when/if a UCI (e.g., having a PUCCH resource configuration not associated with a SR ID or SR configuration ID) is used as the first UL channel, the UE could perform or conduct event(s) evaluation(s) and/or event instance(s) evaluation(s) in PHY/L1/lower layer(s).

Supporting evaluation(s) of event(s)/event instance(s) in MAC/L2/L3/upper layer(s) (and/or in PHY/L1/lower layer(s)) could be a basic UE feature such that when/if a UE supports the UE-initiated/event-driven beam reporting/management (or for a UE supporting the UE-initiated/event-driven beam reporting/management), the UE could or would need to support at least evaluation(s) of event(s)/event instance(s) in MAC/L2/L3/upper layer(s) (and/or in PHY/L1/lower layer(s)). Supporting evaluation(s) of event(s)/event instance(s) in PHY/L1/lower layer(s) (and/or in MAC/L2/L3/upper layer(s)) could be optional for a UE supporting the UE-initiated/event-driven beam reporting/management; in this case, the UE could indicate to the network in their capability signaling(s) one or more of:
Support of event(s)/event instance(s) evaluation(s) in MAC/L2/L3/upper layer(s)
Support of event(s)/event instance(s) evaluation(s) in PHY/LI/lower layer(s)

That is, a UE's capability or capability signaling could comprise one or more components each indicating support of:
{event(s)/event instance(s) evaluation(s) in MAC/L2/L3/upper layer(s)}
{event(s)/event instance(s) evaluation(s) in PHY/L1/lower layer(s)}
{event(s)/event instance(s) evaluation(s) in MAC/L2/L3/upper layer(s), event(s)/event instance(s) evaluation(s) in PHY/L1/lower layer(s)}

Throughout the present disclosure, the aforementioned signal(s), channel(s), signaling(s), indication(s), configuration(s), command(s) and/or etc. that the UE receives or does not receive for evaluating, assessing, detecting, declaring or determining the event(s) and/or event evaluation(s) and/or triggering or initiating the UE-initiated/event-driven beam reporting (e.g., triggering or initiating transmission(s) of the PN message/trigger via/in/by the PUCCH(s)/PUCCH resource(s) of the first UL channel as in Step-1 for Mode A, Mode B and/or Mode C according to or following those specified herein in the present disclosure) could also be regarded/referred to as NWR(s) in the present disclosure.

According to or following those specified herein in the present disclosure, when/if one or more of the events as specified/defined herein in the present disclosure including e.g.,
Event-1,
Event-2,
Event-4,
Event-5,
Event-6, and
Event-7,
   are enabled according to or following those specified/defined herein in the present disclosure, UE reporting initiated or triggered beam(s)/TCI state(s) switching or update is enabled, wherein:
A UE could indicate to the network, in UEI report(s) or UEI report content(s)/quantity(s), information related to one or more TCI states—e.g., in form/terms of the corresponding TCI state ID(s)/index(es) and/or resource indicator(s) such as SSBRI(s) and/or CRI(s) corresponding to RS(s)/RS resource(s)—determined or identified or selected from the candidate/new beam RS(s)/RS resource(s)—associated or specific to the one or more TCI states, if any/configured/provided, for determining, detecting or declaring the corresponding event(s) according to or following those specified herein in the present disclosure—that they would apply or use for determining or identifying (spatial domain) transmit and/or receive filter(s) to transmit and/or receive various UL and/or DL channels/signals;
The UE could receive from the network one or more NWRs to acknowledge network's reception(s) of the indication of the one or more TCI states;
The UE could apply the one or more TCI states, e.g., by setting the (spatial domain) transmit and/or receive filter(s) for transmitting and/or receiving various UL and/or DL channels/signals according to or based the one or more TCI states (or equivalently, the RS(s) or RS resource(s) associated or specific to the one or more TCI states), after a beam application time starting from the last (or first) symbol/slot/etc. of receiving or reception of the one or more NWRs.

In one embodiment, according to or following those specified herein in the present disclosure, for Mode A, Mode B and/or Mode C, a PN message/trigger or a PN message/trigger transmission occasion via/by PUCCH resource(s) of the first UL channel as in Step-1 could be to (i) request UL (PUSCH) resource(s) or resource allocation(s)/grant(s) of the second UL channel for carrying or conveying UEI report content(s)/quantity(s) associated/specific to the PN message/trigger—e.g., in Mode A and/or Mode C, and/or (ii) notify transmission(s) of UEI report content(s)/quantity(s) via/by (pre-)configured or (pre-configured) grant PUSCH resource(s) of the second UL channel associated/specific to the PN message/trigger—e.g., in Mode B. In addition to (i) and/or (ii), the PN message/trigger or the PN message/trigger transmission occasion via/by PUCCH resource(s) of the first UL channel as in Step-1 could also be to (iii) trigger or initiate or notify or indicate TCI state(s)/beam(s) switching; for instance, the PN message/trigger or the PN message/trigger transmission occasion via/by PUCCH resource(s) of the first UL channel as in Step-1 could be to notify or indicate to the network that one or more of the reported beams or contents or quantities could be for beam(s)/TCI state(s) switching or update—also referred to as UE reporting initiated or triggered beam(s)/TCI state(s) switching or update.
In one example, the UE could determine or identify the first UL channel configuration(s) and/or the PUCCH resource configuration(s) of the first UL channel that can be used to carry or convey the PN message/trigger for the aforementioned (iii) according to or based on fixe rule(s) in system specification(s) and/or per RRC (re-)configuration. For example, the first UL channel configuration(s) and/or the PUCCH resource configuration(s) of the first UL channel that can be used to carry or convey the PN message/trigger for the aforementioned (iii) could correspond to that/those configured or associated with the lowest (or highest) configuration ID(s)/index(es) among all the first UL channel configurations and/or the PUCCH resource configurations of the first UL channel configured/provided for the UE-initiated/event-driven beam reporting as specified/defined herein in the present disclosure. For another example, the UE could be configured, provided and/or indicated by the network, e.g., via higher layer RRC signaling(s)/parameter(s) and/or MAC CE command(s) and/or dynamic DCI based L1 signaling(s) based on or according to a corresponding UE's capability or capability signaling, the first UL channel configuration(s) and/or the PUCCH resource configuration(s) of the first UL channel to use for carrying or conveying the PN message/trigger for the aforementioned (iii)—e.g., in terms/form of the corresponding configuration ID(s)/index(es)—among all the first UL channel configurations and/or the PUCCH resource configurations of the first UL channel configured/provided for the UE-initiated/event-driven beam reporting as specified/defined herein in the present disclosure.
In another example, the UE could be configured or provided or indicated by the network, e.g., via higher layer RRC signaling(s)/parameter(s) and/or MAC CE command(s) and/or dynamic DCI based L1 signaling(s) based on or according to a corresponding UE's capability or capability signaling, one or more indicators to enable the UE reporting initiated or triggered beam(s)/TCI state(s) switching or update. For instance, the UE could be provided or configured with a higher layer parameter ueInitiatedBeamSwitching, and/or the higher layer parameter ueInitiatedBeamSwitching could be set to ‘enabled’; in this case, when/if the UE transmits or sends a PN message/trigger or a PN message/trigger transmission occasion over/by/on PUCCH resource(s) of the first UL channel as in Step-1 for Mode A, Mode B and/or Mode C, the PN message/trigger is for the aforementioned (iii)—i.e., the UE reporting initiated or triggered beam(s)/TCI state(s) switching or update.
In another example, according to or following those specified herein in the present disclosure, the PN message/trigger (or the UEITI as specified/defined herein in the present disclosure) could be a one-bit indicator; for this design example, when/if the 1-bit PN message/trigger is set to ‘i’ or ‘positive’ (or ‘0’ or ‘negative’), the 1-bit PN message/trigger is for the aforementioned (iii)—i.e., the UE reporting initiated or triggered beam(s)/TCI state(s) switching or update; otherwise, e.g., when/if the 1-bit PN message/trigger is set to ‘0’ or ‘negative’ (or ‘I’ or ‘positive’), the 1-bit PN message/trigger could be for the UE-initiated/event-driven beam reporting as specified/defined herein in the present disclosure.
In another example, the PN message/trigger (or the UEITI as specified/defined herein in the present disclosure) could comprise a one-bit indicator; for this design example, when/if the 1-bit indicator is set to ‘1’ or ‘positive’ (or ‘0’ or ‘negative’), the PN message/trigger is for the aforementioned (iii)—i.e., the UE reporting initiated or triggered beam(s)/TCI state(s) switching or update; otherwise, e.g., when/if the 1-bit indicator is set to ‘0’ or ‘negative’ (or ‘1’ or ‘positive’), the PN message/trigger could be for the UE-initiated/event-driven beam reporting as specified/defined herein in the present disclosure.

For the above described or specified design examples, when/if the UE reporting initiated or triggered beam(s)/TCI state(s) switching or update is enabled according to or following those specified/defined herein in the present disclosure, all of the UEI report content(s)/quantity(s)—carried or conveyed by/in/over PUSCH resource(s) of the second UL channel—associated/specific to the PN message/trigger as specified/defined herein in the present disclosure could be for the UE reporting initiated or triggered beam(s)/TCI state(s) switching or update. Optionally, when/if the UE reporting initiated or triggered beam(s)/TCI state(s) switching or update is enabled according to or following those specified/defined herein in the present disclosure, the PN message/trigger or the UEITI could indicate which one or more of the UEI report content(s)/quantity(s)—carried or conveyed by/in/over PUSCH resource(s) of the second UL channel—associated/specific to the PN message/trigger as specified/defined herein in the present disclosure could be for the UE reporting initiated or triggered beam(s)/TCI state(s) switching or update.
For example, the PN message/trigger (or the UEITI) could correspond to or could comprise a bitmap (e.g., having the same number of entries/bit positions of/in the bitmap as the number of reported beams—e.g., in terms/form their corresponding resource indicators including SSBRI(s) and/or CRI(s) and/or TCI state IDs/indexes—in the UEI report) with each entry/bit position of the bitmap associated or corresponding a reported beam in the UEI report. In this case, when/if an entry/bit position of the bitmap is set to ‘1’(or ‘0’), the corresponding/associated reported beam e.g. in terms/form the corresponding resource indicator e.g. a SSBRI or a CRI and/or TCI state ID/index could be for the UE reporting initiated or triggered beam(s)/TCI state(s) switching or update; otherwise, e.g., when/if an entry/bit position of the bitmap is set to ‘0’ (or ‘1’), the corresponding/associated reported beam e.g. in terms/form the corresponding resource indicator e.g. a SSBRI or a CRI and/or TCI state ID/index could be for the UE-initiated/event-driven beam reporting as specified/defined herein in the present disclosure.
For another example, the PN message/trigger (or the UEITI) could correspond to or could comprise a bitmap (e.g., having the same number of entries/bit positions of/in the bitmap as the number of reported resource indicators including SSBRI(s) and/or CRI(s) in the UEI report) with each entry/bit position of the bitmap associated or corresponding a reported resource indicator in the UEI report. In this case, when/if an entry/bit position of the bitmap is set to ‘1’(or ‘0’), the corresponding/associated reported beam in terms/form the corresponding resource indicator could be for the UE reporting initiated or triggered beam(s)/TCI state(s) switching or update; otherwise, e.g., when/if an entry/bit position of the bitmap is set to ‘0’ (or ‘1’), the corresponding/associated reported beam in terms/form the corresponding resource indicator could be for the UE-initiated/event-driven beam reporting as specified/defined herein in the present disclosure. In this case, when/if a reported beam is in form/terms of a TCI state ID/index, it is for the UE reporting initiated or triggered beam(s)/TCI state(s) switching or update.

In addition, the UEI report content(s)/quantity(s) conveyed or carried via/by PUSCH resource(s) of the second UL channel as in Step-2 of Mode A, Mode B and/or Mode C could comprise one or more first indicators to notify or indicate to the network that one or more of the reported beams or contents or quantities could be for the UE reporting initiated or triggered beam(s)/TCI state(s) switching or update. In this case, for instance, the one or more first indicators provided, indicated or comprised in the UEI report content(s)/quantity(s) as specified/defined herein could correspond to or could be in form/term of a one-bit indicator; when/if the 1-bit indicator is set to ‘1’ or ‘positive’ (or ‘0’ or ‘negative’), all of the UEI report content(s)/quantity(s)—carried or conveyed by/in/over PUSCH resource(s) of the second UL channel—associated/specific to a/the PN message/trigger as specified/defined herein in the present disclosure could be for the UE reporting initiated or triggered beam(s)/TCI state(s) switching or update; otherwise, e.g., when/if the 1-bit indicator is set to ‘0’ or ‘negative’ (or ‘1’ or ‘positive’), all of the UEI report content(s)/quantity(s)—carried or conveyed by/in/over PUSCH resource(s) of the second UL channel—associated/specific to a/the PN message/trigger as specified/defined herein in the present disclosure could be for the UE-initiated/event-driven beam reporting as specified/defined herein in the present disclosure. Optionally, when/if the UE reporting initiated or triggered beam(s)/TCI state(s) switching or update is enabled according to or following those specified/defined herein in the present disclosure, the UEI report content(s)/quantity(s) could comprise one or more second indicators to indicate which one or more of the UEI report content(s)/quantity(s)—carried or conveyed by/in/over PUSCH resource(s) of the second UL channel—associated/specific to a/the PN message/trigger as specified/defined herein in the present disclosure could be for the UE reporting initiated or triggered beam(s)/TCI state(s) switching or update.
For example, the one or more second indicators could correspond to or could be in form/terms of a bitmap (e.g., having the same number of entries/bit positions of/in the bitmap as the number of reported beams—e.g., in terms/form their corresponding resource indicators including SSBRI(s) and/or CRI(s) and/or TCI state IDs/indexes—in the UEI report) with each entry/bit position of the bitmap associated or corresponding a reported beam in the UEI report. In this case, when/if an entry/bit position of the bitmap is set to ‘1’ (or ‘0’), the corresponding/associated reported beam e.g. in terms/form the corresponding resource indicator e.g. a SSBRI or a CRI and/or TCI state ID/index could be for the UE reporting initiated or triggered beam(s)/TCI state(s) switching or update; otherwise, e.g., when/if an entry/bit position of the bitmap is set to ‘0’ (or ‘1’), the corresponding/associated reported beam e.g. in terms/form the corresponding resource indicator e.g. a SSBRI or a CRI and/or TCI state ID/index could be for the UE-initiated/event-driven beam reporting as specified/defined herein in the present disclosure.
For another example, the one or more second indicators could correspond to or could be in form/terms of a bitmap (e.g., having the same number of entries/bit positions of/in the bitmap as the number of reported resource indicators including SSBRI(s) and/or CRI(s) in the UEI report) with each entry/bit position of the bitmap associated or corresponding a reported resource indicator in the UEI report. In this case, when/if an entry/bit position of the bitmap is set to ‘1’ (or ‘0’), the corresponding/associated reported beam in terms/form the corresponding resource indicator could be for the UE reporting initiated or triggered beam(s)/TCI state(s) switching or update; otherwise, e.g., when/if an entry/bit position of the bitmap is set to ‘0’ (or ‘1’), the corresponding/associated reported beam in terms/form the corresponding resource indicator could be for the UE-initiated/event-driven beam reporting as specified/defined herein in the present disclosure. In this case, when/if a reported beam is in form/terms of a TCI state ID/index, it is for the UE reporting initiated or triggered beam(s)/TCI state(s) switching or update.

For the above described or specified design examples, when/if the UE reporting initiated or triggered beam(s)/TCI state(s) switching or update is enabled according to or following those specified/defined herein in the present disclosure, and/or when/if all of the reported beams in a UEI report and/or in part of the UEI report content(s)/quantity(s)—conveyed or carried over/by/on PUSCH resource(s) of the second UL channel according to or following those specified herein in the present disclosure—are in form/terms of TCI state ID/indexes, all of the reported beams and/or all of the UEI report content(s)/quantity(s) in the UEI report could be for the UE reporting initiated or triggered TCI state(s)/beam(s) switching or update; in this case, the aforementioned indicator(s)—e.g., indicated by or comprised in a/the PN message/trigger and/or the corresponding UEI report content(s)/quantity(s)—used or applied to indicate which one or more of the UEI report content(s)/quantity(s)—carried or conveyed by/in/over PUSCH resource(s) of the second UL channel—associated/specific to a/the PN message/trigger as specified/defined herein in the present disclosure could be for the UE reporting initiated or triggered beam(s)/TCI state(s) switching or update could be absent or no longer needed.

According to or following those specified or defined herein in the present disclosure, after the UE has transmitted or sent to the network the UEI report—i.e., the UEI report content(s)/quantity(s) as specified/defined herein in the present disclosure—over/by/on PUSCH resource(s) of the second UL channel as in Step-3 of Mode A and/or Mode C and/or Step-2 of Mode B, wherein at least part of, e.g., one or more reported beams in terms/form of the corresponding resource indicator(s) such as SSBRI(s) and/or CRI(s) and/or TCI state ID(s)/index(es) provided, comprised or indicated therein, the UEI report hence the UEI report content(s)/quantity(s) could be for the UE reporting initiated or triggered beam(s)/TCI state(s) switching or update according to or following those in the present disclosure,
In one example, the UE may expect to receive an NWR to the UEI report, or more specifically, to the UE reporting initiated or triggered beam(s)/TCI state(s) switching or update,
   no earlier than X1 symbol(s)/slot(s)/etc. and/or no later than X2 symbol(s)/slot(s)/etc. starting from or after a last (or first) symbol/slot/etc. of the PUSCH or PUSCH resource(s) of the second UL channel that carries or conveys the UEI report content(s)/quantity(s), or
   starting from a/the first symbol/slot/etc. that is at least X3 symbol(s)/slot(s) after a/the last (or first) symbol/slot/etc. of the PUSCH or PUSCH resource(s) of the second UL channel that carries or conveys the UEI report content(s)/quantity(s).
For this design example, the NWR could correspond to or could be in form of:
   A one-bit ACK/NACK indicator in response to a/the reported beam e.g. in terms/form of a resource indicator such as a SSBRI or a CRI or a TCI state ID/index for the UE reporting initiated or triggered beam(s)/TCI state(s) switching or update according to or following those specified herein in the present disclosure—e.g., when/if the UEI report content(s)/quantity(s) indicates or comprises only one reported beam e.g. in terms/form of a resource indicator such as a SSBRI or a CRI or a TCI state ID/index for the UE reporting initiated or triggered beam(s)/TCI state(s) switching or update according to or following those specified herein in the present disclosure
   One or more TCI states—e.g., activated/indicated by one or more TCI codepoints in/of a (unified) TCI state(s) activation/deactivation MAC CE command and/or a/the TCI field of a/the beam indication DCI e.g. of format(s) 1_1/1_2 with or without DL assignment—in terms/form the corresponding TCI state ID(s)/index(es); in this case,
      for example, each of the one or more TCI states could have a/the same TCI state ID/index as that of a TCI state reported (as a reported beam) in (part of) the UEI report or UEI report content(s)/quantity(s) for the UE reporting initiated or triggered beam(s)/TCI state(s) switching or update according to or following those specified herein in the present disclosure;
      for another example, the RS(s) or RS resource(s) associated or specific to each of the one or more TCI states could be configured with or could have a/the same RS/resource ID/index as the RS or RS resource associated with a reported beam e.g. in terms/form of a resource indicator such as a SSBRI or a CRI for the UE reporting initiated or triggered beam(s)/TCI state(s) switching or update according to or following those specified herein in the present disclosure;
      for another example, the RS(s) or RS resource(s) associated or specific to each of the one or more TCI states could be configured with or could have a/the same RS/resource ID/index as the RS or RS resource associated or specific to a TCI state reported (the TCI state ID/index of the TCI state as a reported beam) in (part of) the UEI report or UEI report content(s)/quantity(s) for the UE reporting initiated or triggered beam(s)/TCI state(s) switching or update according to or following those specified herein in the present disclosure.

In this case, the UEI report content(s)/quantity(s) could indicate or comprise multiple (or more than one) reported beams e.g. in terms/form of their corresponding resource indicators such as SSBRI(s) and/or CRI(s) or their corresponding TCI state IDs/indexes for the UE reporting initiated or triggered beam(s)/TCI state(s) switching or update according to or following those specified herein in the present disclosure, and each of the one or more TCI states could act or serve or could be considered or regarded as an ACK in response to a corresponding/associated reported beam—e.g., in terms/form of a resource indicator such as a SSBRI or a CRI or a TCI state ID/index—in (part of) the UEI report or UEI report content(s)/quantity(s) for the UE reporting initiated or triggered beam(s)/TCI state(s) switching or update.
One or more RSs or RS resources in terms/form the corresponding RS/resource ID(s)/index(es): in this case,
   for example, each of the one or more RSs or RS resources could be configured with or could have a/the same RS/resource ID/index as the RS or RS resource associated with a reported beam e.g. in terms/form of a resource indicator such as a SSBRI or a CRI for the UE reporting initiated or triggered beam(s)/TCI state(s) switching or update according to or following those specified herein in the present disclosure;
   for another example, each of the one or more RSs or RS resources could be configured with or could have a/the same RS/resource ID/index as the RS or RS resource associated or specific to a TCI state reported (the TCI state ID/index of the TCI state as a reported beam) in (part of) the UEI report or UEI report content(s)/quantity(s) for the UE reporting initiated or triggered beam(s)/TCI state(s) switching or update according to or following those specified herein in the present disclosure;
   for another example, the TCI state associated or specific to each of the one or more RSs or RS resources could have a/the same TCI state ID/index as that of a TCI state reported (as a reported beam) in (part of) the UEI report or UEI report content(s)/quantity(s) for the UE reporting initiated or triggered beam(s)/TCI state(s) switching or update according to or following those specified herein in the present disclosure.

In this case, the UEI report content(s)/quantity(s) could indicate or comprise multiple (or more than one) reported beams e.g. in terms/form of their corresponding resource indicators such as SSBRI(s) and/or CRI(s) or their corresponding TCI state IDs/indexes for the UE reporting initiated or triggered beam(s)/TCI state(s) switching or update according to or following those specified herein in the present disclosure, and each of the one or more RSs or RS resources could act or serve or could be considered or regarded as an ACK in response to a corresponding/associated reported beam—e.g., in terms/form of a resource indicator such as a SSBRI or a CRI or a TCI state ID/index—in (part of) the UEI report or UEI report content(s)/quantity(s) for the UE reporting initiated or triggered beam(s)/TCI state(s) switching or update.
A bitmap having the same number of entries/bit positions as the number of reported beams—e.g., in terms/form of resource indicator(s) such as SSBRI(s) and/or CRI(s) and/or TCI state ID(s)/index(es)—for the UE reporting initiated or triggered beam(s)/TCI state(s) switching or update according to or following those specified herein in the present disclosure; each of the entries/bit positions in/of the bitmap could be associated or corresponding to a reported beam—e.g., in terms/form of a resource indicator such as a SSBRI or a CRI and/or a TCI state ID/index—in (part of) the UEI report or the UEI report content(s)/quantity(s) for the UE reporting initiated or triggered beam(s)/TCI state(s) switching or update according to or following those specified herein in the present disclosure; in this case, when/if an entry/bit position of the bitmap is set to ‘1’ (or ‘0’), the entry/bit position could act or serve or could be considered/regarded as a one-bit ACK (or NACK) indicator in response to the reported beam associated or corresponding to the entry/bit position for the UE reporting initiated or triggered beam(s)/TCI state(s) switching or update according to or following those specified herein in the present disclosure. For this design example, the UEI report content(s)/quantity(s) could indicate or comprise multiple (or more than one) reported beams e.g. in terms/form of their corresponding resource indicators such as SSBRI(s) and/or CRI(s) or their corresponding TCI state IDs/indexes for the UE reporting initiated or triggered beam(s)/TCI state(s) switching or update according to or following those specified herein in the present disclosure.
One or more index values: each of the one or more index values could correspond to a position or ordering or order or index of a reported beam—e.g., in terms/form of a resource indicator such as a SSBRI or a CRI or a TCI state ID/index—among all the reported beams—e.g., in terms/form of their corresponding resource indicators such as SSBRI(s) and/or CRI(s) and/or TCI state IDs/indexes—in (part of) the UEI report or UEI report content(s)/quantity(s), or among all the reported beams—e.g., in terms/form of their corresponding resource indicators such as SSBRI(s) and/or CRI(s) and/or TCI state IDs/indexes—in (part of) the UEI report or UEI report content(s)/quantity(s) for the UE reporting initiated or triggered beam(s)/TCI state(s) switching or update; in this case, the UEI report content(s)/quantity(s) could indicate or comprise multiple (or more than one) reported beams e.g. in terms/form of their corresponding resource indicators such as SSBRI(s) and/or CRI(s) or their corresponding TCI state IDs/indexes for the UE reporting initiated or triggered beam(s)/TCI state(s) switching or update according to or following those specified herein in the present disclosure, and each of the one or more index values could act or serve or could be considered or regarded as an ACK in response to a corresponding/associated reported beam—e.g., in terms/form of a resource indicator such as a SSBRI or a CRI or a TCI state ID/index—in (part of) the UEI report or UEI report content(s)/quantity(s) for the UE reporting initiated or triggered beam(s)/TCI state(s) switching or update.

The UE could determine or identify value(s) of X1, X2 and/or X3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Additionally, the UE could apply the TCI state(s)
having same TCI state ID(s)/index(es) as that/those of the TCI state(s) (i) reported (as reported beam(s)) in (part of) the UEI report or UEI report content(s)/quantity(s) for the UE reporting initiated or triggered beam(s)/TCI state(s) switching or update, and (ii) acknowledged or ACK'ed by the network via a corresponding NWR according to or following those specified herein in the present disclosure;
associated, specific or corresponding to the RS(s) or RS resource(s) configured with or having same RS/resource ID(s)/index(es) as the RS(s) or RS resource(s), (i) associated with the reported beam(s) e.g. in terms/form of the corresponding resource indicator(s) such as SSBRI(s) and/or CRI(s) in (part of) the UEI report or the UEI report content(s)/quantity(s) for the UE reporting initiated or triggered beam(s)/TCI state(s) switching or update, and (ii) acknowledged or ACK'ed by the network via a corresponding NWR according to or following those specified herein in the present disclosure;
associated, specific or corresponding to the RS(s) or RS resource(s) configured with or having same RS/resource ID(s)/index(es) as the RS(s) or RS resource(s), (i) associated or specific to TCI state(s) reported (the TCI state ID(s)/index(es) of the TCI state(s) as reported beam(s)) in (part of) the UEI report or UEI report content(s)/quantity(s) for the UE reporting initiated or triggered beam(s)/TCI state(s) switching or update, and (ii) acknowledged or ACK'ed by the network via a corresponding NWR according to or following those specified herein in the present disclosure.
according to or following one or more of:
no earlier than Y1 symbol(s)/slot(s) and/or no later than Y2 symbol(s)/slot(s) after a/the last (or first) symbol/slot/etc. of receiving or reception of the NWR
starting from a/the first symbol/slot/etc. that is at least Y3 symbol(s)/slot(s) after a/the last (or first) symbol/slot/etc. of receiving or reception of the NWR
no earlier than Y4 symbol(s)/slot(s) and/or no later than Y5 symbol(s)/slot(s) after a/the last (or first) symbol/slot/etc. of transmitting or transmission(s) of PUCCH(s) and/or PUSCH(s) with positive HARQ-ACK corresponding to the NWR
starting from a/the first symbol/slot/etc. that is at least Y6 symbol(s)/slot(s) after a/the last (or first) symbol/slot/etc. of transmitting or transmission(s) of PUCCH(s) and/or PUSCH(s) with positive HARQ-ACK corresponding to the NWR.

The UE could determine or identify value(s) of Y1, Y2, Y3, Y4, Y5 and/or Y6 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. When/if the NWR is indicated in/via/by a DCI based L1 signaling, the corresponding DCI can be a downlink DCI of format 1_0, 1_3, 1_1 and/or 1_2 with or without DL assignment, an uplink DCI of format 0_0, 0_3, 0_1 and/or 0_2 with or without UL grant, or a dedicated DCI format for TCI state(s) indication, switching and/or update. Furthermore,
The dedicated DCI format—denoted by TCI-DCI format—could comprise at least a TCI field indicating TCI codepoint(s) mapped to one or more joint, DL and/or UL TCI states according to or following those specified/defined herein in the present disclosure for the unified TCI framework and its extensions; in this case, the dedicated TCI-DCI format could be or could correspond to the NWR itself (e.g., act or serve as an ACK/NACK indicator in response to the UE reporting initiated or triggered beam(s)/TCI state(s) switching or update), or the NWR could correspond to a dedicated DCI field in the dedicated TCI-DCI format, or the NWR could be realized or implemented in the dedicated TCI-DCI format by repurposing one or more codepoints of one or more existing DCI fields such as the TCI field in the dedicated TCI-DCI format. Optionally, when/if the NWR corresponds to an ACK/NACK in response to the UE reporting initiated or triggered beam(s)/TCI state(s) switching or update, the ACK/NACK can be implicit based on or according to e.g.: (a) presence/absence of one or more DCI fields in the corresponding DCI format, and/or (b) indicating one or more particular codepoints of one or more DCI fields in the corresponding DCI format—the UE could determine or identify the one or more particular codepoints according to or based on: (i) fixed value(s)/rule(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling(s).
The dedicated DCI format—denoted by DL-TCI-DCI format—could comprise at least a TCI field indicating TCI codepoint(s) mapped to one or more joint and/or DL TCI states according to or following those specified/defined herein in the present disclosure for the unified TCI framework and its extensions; in this case, the dedicated DL-TCI-DCI format could be or could correspond to the NWR itself (e.g., act or serve as an ACK/NACK indicator in response to the UE reporting initiated or triggered beam(s)/TCI state(s) switching or update), or the NWR could correspond to a dedicated DCI field in the dedicated DL-TCI-DCI format, or the NWR could be realized or implemented in the dedicated DL-TCI-DCI format by repurposing one or more codepoints of one or more existing DCI fields such as the TCI field in the dedicated DL-TCI-DCI format. Optionally, when/if the NWR corresponds to an ACK/NACK in response to the UE reporting initiated or triggered beam(s)/TCI state(s) switching or update, the ACK/NACK can be implicit based on or according to e.g.: (a) presence/absence of one or more DCI fields in the corresponding DCI format, and/or (b) indicating one or more particular codepoints of one or more DCI fields in the corresponding DCI format—the UE could determine or identify the one or more particular codepoints according to or based on: (i) fixed value(s)/rule(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling(s);
The dedicated DCI format—denoted by UL-TCI-DCI format—could comprise at least a TCI field indicating TCI codepoint(s) mapped to one or more joint and/or UL TCI states according to or following those specified/defined herein in the present disclosure for the unified TCI framework and its extensions; in this case, the dedicated UL-TCI-DCI format could be or could correspond to the NWR itself (e.g., act or serve as an ACK/NACK indicator in response to the UE reporting initiated or triggered beam(s)/TCI state(s) switching or update), or the NWR could correspond to a dedicated DCI field in the dedicated UL-TCI-DCI format, or the NWR could be realized or implemented in the dedicated UL-TCI-DCI format by repurposing one or more codepoints of one or more existing DCI fields such as the TCI field in the dedicated UL-TCI-DCI format. Optionally, when/if the NWR corresponds to an ACK/NACK in response to the UE reporting initiated or triggered beam(s)/TCI state(s) switching or update, the ACK/NACK can be implicit based on or according to e.g.: (a) presence/absence of one or more DCI fields in the corresponding DCI format, and/or (b) indicating one or more particular codepoints of one or more DCI fields in the corresponding DCI format—the UE could determine or identify the one or more particular codepoints according to or based on: (i) fixed value(s)/rule(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling(s);
When/if the NWR is indicated in/via/by a downlink DCI of format 1_0, 1_3, 1_1 and/or 1_2 with or without DL assignment, and/or an uplink DCI of format 0_0, 0_3, 0_1 and/or 0_2 with or without UL grant, the NWR could correspond to a new/dedicated DCI field in the corresponding DCI format(s)—e.g. a new/dedicated TCI field in an uplink DCI format indicating TCI codepoint(s) that can be mapped to at least one or more UL TCI states according to or following those specified or defined herein in the present disclosure, or the NWR could be realized or implemented by repurposing one or more codepoints of one or more existing DCI fields such as the TCI field in the corresponding DCI format(s)—e.g., a DL DCI format. Optionally, when/if the NWR corresponds to an ACK/NACK in response to the UE reporting initiated or triggered beam(s)/TCI state(s) switching or update, the ACK/NACK can be implicit based on or according to e.g.: (a) presence/absence of one or more DCI fields in the corresponding DCI format, and/or (b) indicating one or more particular codepoints of one or more DCI fields in the corresponding DCI format—the UE could determine or identify the one or more particular codepoints according to or based on: (i) fixed value(s)/rule(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling(s).
In another example, the UE may not expect to receive any NWR(s) to the UEI report, or more specifically, to the UE reporting initiated or triggered beam(s)/TCI state(s) switching or update. In this case, the UE could apply the TCI state(s)
   having same TCI state ID(s)/index(es) as that/those of the TCI state(s) reported (as reported beam(s)) in (part of) the UEI report or UEI report content(s)/quantity(s) for the UE reporting initiated or triggered beam(s)/TCI state(s) switching or update according to or following those specified herein in the present disclosure;
   associated, specific or corresponding to the RS(s) or RS resource(s) configured with or having same RS/resource ID(s)/index(es) as the RS(s) or RS resource(s) associated with the reported beam(s) e.g. in terms/form of the corresponding resource indicator(s) such as SSBRI(s) and/or CRI(s) in (part of) the UEI report or the UEI report content(s)/quantity(s) for the UE reporting initiated or triggered beam(s)/TCI state(s) switching or update according to or following those specified herein in the present disclosure;
   associated, specific or corresponding to the RS(s) or RS resource(s) configured with or having same RS/resource ID(s)/index(es) as the RS(s) or RS resource(s) associated or specific to TCI state(s) reported (the TCI state ID(s)/index(es) of the TCI state(s) as reported beam(s)) in (part of) the UEI report or UEI report content(s)/quantity(s) for the UE reporting initiated or triggered beam(s)/TCI state(s) switching or update according to or following those specified herein in the present disclosure according to or following one or more of:
starting from a/the first symbol/slot/etc. that is at least Z1 symbol(s)/slot(s) after a/the last (or first) symbol/slot/etc. of the PUSCH or PUSCH resource(s) of the second UL channel as in Mode A, Mode B and/or Mode C used or applied to transmit or send the UEI report or the UEI report content(s)/quantity(s) as specified/defined herein in the present disclosure
   no earlier than Z2 symbol(s)/slot(s) and/or no later than Z3 symbol(s)/slot(s) after a/the last (or first) symbol/slot/etc. of the PUSCH or PUSCH resource(s) of the second UL channel as in Mode A, Mode B and/or Mode C used or applied to transmit or send the UEI report or the UEI report content(s)/quantity(s) as specified/defined herein in the present disclosure.

The UE could determine or identify value(s) of Z1, Z2 and/or Z3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified or defined herein in the present disclosure, the UE could report, send or transmit, in (part of) UEI report(s) and/or UEI report content(s)/quantity(s) carried or conveyed via/by/over/on PUSCH(s) or PUSCH resource(s) of the second UL channel as in Step-3 of Mode A and/or Mode C and/or Step-2 of Mode B,
format-i: one or more resource indicators including SSBRI(s) and/or CRI(s)
format-ii: one or more TCI state IDs/indexes
format-iii: one or more resource indicators including SSBRI(s) and/or CRI(s) and one or more TCI state IDs/indexes.

According to or following those specified or defined herein in the present disclosure, one or more of the one or more reported resource indicators as in format-i and/or format-iii can be for the UE reporting initiated or triggered TCI state(s)/beam(s) switching or update as specified/defined herein in the present disclosure, and/or the one or more TCI state IDs/indexes in format-ii and/or format-iii—hence the corresponding one or more TCI states and/or the RS(s)/RS resource(s) associated, specific or corresponding to the one or more TCI states—could be for the UE reporting initiated or triggered TCI state(s)/beam(s) switching or update as specified/defined herein in the present disclosure. In this case, the UE could determine or identify which one or more of the format-i, format-ii and format-iii to use, apply or follow to construct the UEI report(s) and/or UEI report content(s)/quantity(s) according to or based on:
Fixed rule(s)/value(s) in system specification(s) and/or per RRC (re-)configuration: for example, when/if the UE would initiate or trigger TCI state(s)/beam(s) switching or update (via reporting) according to or following those specified herein in the present disclosure, the UE could use, apply or follow the format-ii; for another example, when/if the UE would (1) initiate or trigger TCI state(s)/beam(s) switching or update (via reporting) according to or following those specified herein in the present disclosure and (2) perform or conduct the (UE-initiated/event-driven) beam reporting according to or following those specified herein in the present disclosure, the UE could use, apply or follow the format-iii—in this case, the reported TCI state ID(s)/index(es) could be for the UE reporting initiated or triggered beam(s)/TCI state(s) switching or update, and the reported resource indicator(s) could be for the (UE-initiated/event-driven) beam reporting.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, when/if the UE is provided or configured with a/the higher layer parameter reportQuantity in the higher layer RRC signaling(s)/parameter(s) e.g. CSI-ReportConfig and/or UEI-ReportConfig that provides or configures necessary information and/or resource/reporting setting(s) for the UE-initiated/even-driven beam operations as specified/defined herein in the present disclosure and set to ‘ri-ueiBeamSwitching’, the UE could use, apply or follow the format-i; for example, when/if the UE is provided or configured with a/the higher layer parameter reportQuantity in the higher layer RRC signaling(s)/parameter(s) e.g. CSI-ReportConfig and/or UEI-ReportConfig that provides or configures necessary information and/or resource/reporting setting(s) for the UE-initiated/even-driven beam operations as specified/defined herein in the present disclosure and set to ‘tci-ueiBeamSwitching’, the UE could use, apply or follow the format-ii; for example, when/if the UE is provided or configured with a/the higher layer parameter reportQuantity in the higher layer RRC signaling(s)/parameter(s) e.g. CSI-ReportConfig and/or UEI-ReportConfig that provides or configures necessary information and/or resource/reporting setting(s) for the UE-initiated/even-driven beam operations as specified/defined herein in the present disclosure and set to ‘ri-tci-ueiBeamSwitching’, the UE could use, apply or follow the format-iii.
UE's autonomous determination, which could be further sent to the network, e.g., via/in part of a beam/CSI report or UE's capability signaling(s).

According to or following those specified/discussed herein in the present disclosure, a UE could be provided or configured or indicated by the network, e.g., via higher layer RRC signaling(s)/parameter(s) such as CSI-ReportConfig and/or UEI-ReportConfig that provides or configures necessary information and/or setting(s) for the UE-initiated/event-driven beam operations and/or MAC CE command(s) and/or dynamic DCI based L1 signaling(s) based on or according to corresponding UE's capability(s) or capability signaling(s), to report or send or transmit in a reporting instance/CSI report, a number K1 (0≤K1≤Kmax or 1≤K1≤Kmax, Kmax can be higher layer configured based on a corresponding UE's capability or capability signaling) first report quantity(s) for or specific to the UE reporting triggered or initiated beam(s)/TCI state(s) switching/update as specified/defined herein in the present disclosure, and a number L1 (0≤L1≤Lmax or 1≤L1≤Lmax, Lmax can be higher layer configured based on a corresponding UE's capability or capability signaling) second report quantity(s) for or specific to the (UE-initiated/event-driven) beam reporting—i.e., not for the UE reporting triggered or initiated beam(s)/TCI state(s) switching/update as specified/defined herein in the present disclosure, wherein 1≤(K1+L1)≤Nmax, and Nmax can be higher layer configured based on a corresponding UE's capability or capability signaling; alternatively, UE could be provided or configured or indicated by the network, e.g., via higher layer RRC signaling(s)/parameter(s) such as CSI-ReportConfig and/or UEI-ReportConfig that provides or configures necessary information and/or setting(s) for the UE-initiated/event-driven beam operations and/or MAC CE command(s) and/or dynamic DCI based LI signaling(s) based on or according to corresponding UE's capability(s) or capability signaling(s), to report or send or transmit in a reporting instance/CSI report, a number N (1≤N≤Nmax, Nmax can be higher layer configured based on a corresponding UE's capability or capability signaling) report quantity(s) comprising at least one first report quantity for or specific to the UE reporting triggered or initiated beam(s)/TCI state(s) switching/update as specified/defined herein in the present disclosure; a first report quantity could correspond to or could be (i) a resource indicator such as a SSBRI or a CRI or (ii) a TCI state ID/index of a TCI state; in this case, the UE could determine or identify a first report quantity as (i) a resource indicator such as a SSBRI or a CRI or (ii) a TCI state ID/index of a TCI state according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based LI signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), according to or following those specified herein in the present disclosure. Furthermore, a second report quantity could correspond to or could be a resource indicator such as a SSBRI or a CRI. In addition, the UE could report or send or transmit, in a/the (same) reporting instance/CSI report, one or more beam metrics such as L1-RSRPs/L1-SINRs each associated or specific to a reported first (or second) report quantity as specified/defined herein. Optionally, each of the reported first (or second) report quantities in a reporting instance/CSI report could be associated with a beam metric such as a LI-RSRP/LI-SINR reported in a/the (same) reporting instance/CSI report. The UE could determine or identify to report or transmit or send to the network, in a reporting instance/CSI report, the first report quantity(s) and/or the second report quantity(s)—and therefore the associated beam metric(s)—according to or based on one or more of:
Fixed rule(s)/value(s) in system specification(s) and/or per RRC (re-)configuration.
   For example, by default, the UE could always report, in a/the reporting instance/CSI report, (i) (only) the first report quantity(s), (ii) (only) the second report quantity(s), or (iii) both the first and second report quantities.
   For another example, the UE could report, in a/the reporting instance/CSI report, the first report quantity(s) firstly, followed by the second report quantity(s), followed by the beam metric(s) associated to the first report quantity(s) if any/reported, and followed by the beam metric(s) associated to the second report quantity(s) if any/reported; or, the UE could report, via first CSI field(s) in a/the reporting instance/CSI report, the first report quantity(s), via second CSI field(s) in a/the reporting instance/CSI report, the second report quantity(s), via third CSI field(s) in a/the reporting instance/CSI report, the beam metric(s) associated to the first report quantity(s) if any/reported, and via fourth CSI field(s) in a/the reporting instance/CSI report, the beam metric(s) associated to the second report quantity(s) if any/reported, wherein the UE could determine or identify
      the first CSI field(s) as the first KI CSI field(s) or the CSI field(s) with the KI lowest (or highest) index(es) among all the CSI field(s) in the UEI report or all the CSI field(s) in the UEI report that carries or conveys the first and second report quantities, and
      the second CSI field(s) as the first L1 CSI field(s) after or following the first CSI field(s) or the CSI field(s) with the L1 lowest (or highest) index(es) among all the CSI field(s)—except the first CSI field(s)—in the UEI report or all the CSI field(s)—except the first CSI field(s)—in the UEI report that carries or conveys the first and second report quantities, and
      the third CSI field(s) as the first KI CSI field(s) after or following the second CSI field(s) or the CSI field(s) with the K1 lowest (or highest) index(es) among all the CSI field(s)—except the first and second CSI fields—in the UEI report or all the CSI field(s)—except the first and second CSI fields—in the UEI report that carries or conveys the beam metrics associated to the first and second report quantities, and
      the fourth CSI field(s) as the first L1 CSI field(s) after or following the third CSI field(s) or the CSI field(s) with the L1 lowest (or highest) index(es) among all the CSI field(s)—except the first, second and third CSI fields—in the UEI report or all the CSI field(s)—except the first, second and third CSI fields—in the UEI report that carries or conveys the beam metrics associated to the first and second report quantities.
   For another example, the UE could report, in a/the reporting instance/CSI report, the second report quantity(s) firstly, followed by the first report quantity(s), followed by the beam metric(s) associated to the second report quantity(s) if any/reported, and followed by the beam metric(s) associated to the first report quantity(s) if any/reported; or, the UE could report, via first CSI field(s) in a/the reporting instance/CSI report, the second report quantity(s), via second CSI field(s) in a/the reporting instance/CSI report, the first report quantity(s), via third CSI field(s) in a/the reporting instance/CSI report, the beam metric(s) associated to the second report quantity(s) if any/reported, and via fourth CSI field(s) in a/the reporting instance/CSI report, the beam metric(s) associated to the first report quantity(s) if any/reported, wherein the UE could determine or identify
      the first CSI field(s) as the first L1 CSI field(s) or the CSI field(s) with the L1 lowest (or highest) index(es) among all the CSI field(s) in the UEI report or all the CSI field(s) in the UEI report that carries or conveys the first and second report quantities, and
      the second CSI field(s) as the first K1 CSI field(s) after or following the first CSI field(s) or the CSI field(s) with the K1 lowest (or highest) index(es) among all the CSI field(s)—except the first CSI field(s)—in the UEI report or all the CSI field(s)—except the first CSI field(s)—in the UEI report that carries or conveys the first and second report quantities, and
      the third CSI field(s) as the first L1 CSI field(s) after or following the second CSI field(s) or the CSI field(s) with the L1 lowest (or highest) index(es) among all the CSI field(s)—except the first and second CSI fields—in the UEI report or all the CSI field(s)—except the first and second CSI fields—in the UEI report that carries or conveys the beam metrics associated to the first and second report quantities, and
      the fourth CSI field(s) as the first K1 CSI field(s) after or following the third CSI field(s) or the CSI field(s) with the K1 lowest (or highest) index(es) among all the CSI field(s)—except the first, second and third CSI fields—in the UEI report or all the CSI field(s)—except the first, second and third CSI fields—in the UEI report that carries or conveys the beam metrics associated to the first and second report quantities.
Network's configuration(s)/indication(s) via higher layer RRC signaling(s)/parameter(s) and/or MAC CE command(s) and/or dynamic DCI based L1 signaling(s) based on or according to corresponding UE's capability(s) or capability signaling(s).
   For example, when/if a higher layer RRC parameter beamSwitchingInReport is provided/configured and/or set to ‘enabled’, the UE could be expected to report in a/the reporting instance/CSI report the first report quantity(s); otherwise, i.e., when/if the higher layer RRC parameter beamSwitchingInReport is not provided/configured, or is provided/configured but set to ‘disabled’, the UE may not report in a/the reporting instance/CSI report the first report quantity(s)—in this case, e.g. by default, the UE could report in a/the reporting instance/CSI report one or more of the second report quantity(s).
   For another example, when/if a higher layer RRC parameter beamReportingInReport is provided/configured and/or set to ‘enabled’, the UE could be expected to report in a/the reporting instance/CSI report the second report quantity(s); otherwise, i.e., when/if the higher layer RRC parameter beamReportingInReport is not provided/configured, or is provided/configured but set to ‘disabled’, the UE may not report in a/the reporting instance/CSI report the second report quantity(s)—in this case, e.g. by default, the UE could report in a/the reporting instance/CSI report one or more of the first report quantity(s).
   For another example, when/if a higher layer RRC parameter beamReportingSwitchingInReport is provided/configured and/or set to ‘enabled’, the UE could be expected to report in a/the reporting instance/CSI report both the first and second report quantities; otherwise, i.e., when/if the higher layer RRC parameter beamReportingSwitchingInReport is not provided/configured, or is provided/configured but set to ‘disabled’, the UE may not report in a/the reporting instance/CSI report both the first and second report quantities—in this case, e.g. by default, the UE could report in a/the reporting instance/CSI report one or more of the first (or second) report quantity(s).
   For another example, when/if a/the higher layer parameter reportQuantity in CSI-ReportConfig and/or UEI-ReportConfig that provides or configures necessary information and/or setting(s) for the UE-initiated/event-driven beam operations including beam reporting and/or beam switching is set to ‘beamSwitching’, the UE could be expected to report in a/the reporting instance/CSI report the first report quantity(s), when/if a/the higher layer parameter reportQuantity in CSI-ReportConfig and/or UEI-ReportConfig that provides or configures necessary information and/or setting(s) for the UE-initiated/event-driven beam operations including beam reporting and/or beam switching is set to ‘beamReporting’, the UE could be expected to report in a/the reporting instance/CSI report the second report quantity(s), and when/if a/the higher layer parameter reportQuantity in CSI-ReportConfig and/or UEI-ReportConfig that provides or configures necessary information and/or setting(s) for the UE-initiated/event-driven beam operations including beam reporting and/or beam switching is set to ‘beamSwitchingReporting’, the UE could be expected to report in a/the reporting instance/CSI report both the first and second report quantities. For this design example, when/if a/the higher layer parameter reportQuantity in CSI-ReportConfig and/or UEI-ReportConfig that provides or configures necessary information and/or setting(s) for the UE-initiated/event-driven beam operations including beam reporting and/or beam switching is set to ‘none’, and/or is not provided, present or configured, e.g. by default, the UE could report in a/the reporting instance/CSI report one or more of the first and/or second report quantity(s).
   For another example, when/if K1>0 or ≥1, the UE could be expected to report in a/the reporting instance/CSI report the first report quantity(s), when/if L1>0 or ≥1, the UE could be expected to report in a/the reporting instance/CSI report the second report quantity(s), and when/if K1>0 or ≥1 and L1>0 or ≥1, the UE could be expected to report in a/the reporting instance/CSI report both the first and second report quantities. Optionally, for this design example, when/if K1=0, the UE may not report in a/the reporting instance/CSI report any of the first report quantity(s), and when/if L1=0, the UE may not report in a/the reporting instance/CSI report any of the second report quantity(s).
UE's autonomous determination or selection which could be further sent or transmitted or indicated to the network e.g. via/by/in various UL channels/signals such as CSI/beam report(s) and/or UE's capability signaling(s) and/or (in part of) the UEI report(s) including PN message(s)/trigger(s) transmitted or sent over/by/on PUCCH resource(s) of the first UL channel and/or UEI report content(s)/quantity(s) transmitted or sent over/by/on PUSCH resource(s) of the second UL channel according to or following those specified/defined herein in the present disclosure (or equivalently, the UE could send or transmit to the network, e.g. (in part of) the UEI report(s) including PN message(s)/trigger(s) transmitted or sent over/by/on PUCCH resource(s) of the first UL channel and/or UEI report content(s)/quantity(s) transmitted or sent over/by/on PUSCH resource(s) of the second UL channel according to or following those specified/defined herein in the present disclosure, one or more indicators to indicate which of the report quantity(s) in the UEI report(s) and/or the corresponding UEI report content(s)/quantity(s) could correspond to the first report quantity(s) specific to or for the UE reporting triggered or initiated TCI state(s)/beam(s) switching or update)
   For example, a PN message/trigger transmitted or sent over/by/on PUCCH resource(s) of the first UL channel, and/or the UEI report content(s)/quantity(s) transmitted or sent over/by/on PUSCH resource(s) of the second UL channel could correspond to or comprise or indicate or provide or include or contain a bitmap with each entry/bit position of the bitmap corresponding, associated or specific to a report quantity in (part of) the UEI report content(s)/quantity(s) as specified/defined herein in the present disclosure; in this case, when/if an entry/bit position is set to ‘1’ (or ‘0’), the report quantity corresponding to the entry/bit position could correspond to or could be a first report quantity (and/or its associated or corresponding beam metric), and when/if an entry/bit position is set to ‘0’ (or ‘1’), the report quantity corresponding to the entry/bit position could correspond to or could be a second report quantity (and/or its corresponding or associated beam metric).
   For another example, a report quantity in the UEI report(s) and/or the corresponding UEI report content(s)/quantity(s) transmitted or sent over/by/on PUSCH resource(s) of the second UL channel could be associated or linked or mapped to a one-bit indicator, wherein the one-bit indicator could be indicated, comprised, contained or included in the same UEI report(s) and/or the corresponding UEI report content(s)/quantity(s). For this design example, when/if a one-bit indicator is set to ‘1’ (or ‘0’), the corresponding, associated, linked or mapped report quantity could correspond to a first report quantity dedicated for or specific to the UE reporting triggered or initiated TCI state(s)/beam(s) switching or update, and/or when/if a one-bit indicator is set to ‘0’ (or ‘1’), the corresponding, associated, linked or mapped report quantity could correspond to a second report quantity.
   For another example, the UEI report content(s)/quantity(s) transmitted or sent over/by/on PUSCH resource(s) of the second UL channel could comprise a first indicator set to ‘0’ (or ‘1’ or ‘2’) and a second indicator set to ‘1’ (or ‘0’ or ‘2’). In this case, the report quantity(s) carried or conveyed by the CSI field(s) following or after the CSI field that carries or conveys the first indicator could correspond to the first (or second) report quantity(s)—and therefore the corresponding beam metric(s), and the report quantity(s) carried or conveyed by the CSI field(s) following or after the CSI field that carries or conveys the second indicator could correspond to the second (or first) report quantity(s)—and therefore the corresponding beam metric(s).
   For another example, the UEI report content(s)/quantity(s) transmitted or sent over/by/on PUSCH resource(s) of the second UL channel could comprise a first set of CSI field index(es) and a second set of CSI field index(es). In this case, the CSI field(s) corresponding to the CSI field index(es) in the first set could carry or convey the first report quantity(s)—and therefore the corresponding beam metric(s) if any/reported, and the CSI field(s) corresponding to the CSI field index(es) in the second set could carry or convey the second report quantity(s)—and therefore the corresponding beam metric(s) if any/reported.
   For another example, the UEI report content(s)/quantity(s) transmitted or sent over/by/on PUSCH resource(s) of the second UL channel could comprise a set of CSI field index(es). In this case, the CSI field(s) corresponding to the CSI field index(es) in the set could carry or convey the first (or second) report quantity(s)—and therefore the corresponding beam metric(s) if any/reported, and the CSI field(s)—in the reporting instance/CSI report—other than the CSI field(s) corresponding to the CSI field index(es) in the set could carry or convey the second (or first) report quantity(s)—and therefore the corresponding beam metric(s) if any/reported.
   For another example, a PN message/trigger transmitted or sent over/by/on PUCCH resource(s) of the first UL channel, and/or the UEI report content(s)/quantity(s) transmitted or sent over/by/on PUSCH resource(s) of the second UL channel could correspond to or comprise or indicate or provide or include or contain one or more indicators to indicate information related to the first and/or second report quantity(s), wherein the information could comprise one or more of:
      the number of the first report quantity(s) reported in the reporting instance/CSI report (or equivalently, the UEI report content(s)/quantity(s));
      the number of the second report quantity(s) reported in the reporting instance/CSI report (or equivalently, the UEI report content(s)/quantity(s));
      presence or absence (e.g., via a one-bit indicator set to ‘1’ or ‘0’) of the first report quantity(s) in the reporting instance/CSI report (or equivalently, the UEI report content(s)/quantity(s));
      presence or absence (e.g., via a one-bit indicator set to ‘1’ or ‘0’) of the second report quantity(s) in the reporting instance/CSI report (or equivalently, the UEI report content(s)/quantity(s)).
   For another example, the UEI report content(s)/quantity(s) transmitted or sent over/by/on PUSCH resource(s) of the second UL channel could comprise two-part: part 1 of the two-part UCI/CSI could comprise one or more of:
      the number of the first report quantity(s) reported in part 2 of the reporting instance/CSI report (or equivalently, the UEI report content(s)/quantity(s));
      the number of the second report quantity(s) reported in part 2 of the reporting instance/CSI report (or equivalently, the UEI report content(s)/quantity(s));
      presence or absence (e.g., via a one-bit indicator set to ‘1’ or ‘0’) of the first report quantity(s) in part 2 of the reporting instance/CSI report (or equivalently, the UEI report content(s)/quantity(s));
      presence or absence (e.g., via a one-bit indicator set to ‘1’ or ‘0’) of the second report quantity(s) in part 2 of the reporting instance/CSI report (or equivalently, the UEI report content(s)/quantity(s));
      one or more of the first report quantity(s)—and therefore the corresponding beam metric(s);
      one or more of the second report quantity(s)—and therefore the corresponding beam metric(s).

And part 2 of the two-part UCI/CSI could comprise one or more of the first report quantity(s) and therefore the corresponding beam metric(s), and one or more of the second report quantity(s) and therefore the corresponding beam metric(s).

According to or following those specified herein in the present disclosure, after the UE has sent or transmitted to the network the UEI report(s) e.g. the UEI report content(s)/quantity(s) over/via/on one or more PUSCH resource(s) of the second UL channel as in Step-2 of Mode B and/or Step-3 of Mode A and/or Mode C comprising at least the first report quantity(s) for or specific to the UE reporting triggered or initiated beam(s)/TCI state(s) switching, the UE could expect to receive a corresponding NWR (e.g., in response to the UEI report(s))
no earlier than A1 symbol(s)/slot(s)/etc. and/or no later than A2 symbol(s)/slot(s)/etc. after or starting from a/the last (or first) symbol/slot/etc. of the PUSCH(s) or PUSCH resource(s) of the second UL channel that carries or conveys the UEI report content(s)/quantity(s), and/or
starting from a/the first symbol/slot/etc. that is at least A3 symbol(s)/slot(s)/etc. after or starting from a/the last (or first) symbol/slot/etc. of the PUSCH(s) or PUSCH resource(s) of the second UL channel that carries or conveys the UEI report content(s)/quantity(s),
   wherein the UE could determine or identify the value(s) of A1, A2 and/or A3 according to or based on: (i) fixed value(s) in system specification(s) and/or per RRC (re-)configuration(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore:
In one example, when/if the corresponding NWR comprises acknowledgement(s) to one or more of the first report quantity(s) for or specific to the UE reporting triggered or initiated beam(s)/TCI state(s) update/switching according to or following those specified/defined herein in the present disclosure, the UE could apply the TCI state(s) associated, corresponding, linked or specific to the (network acknowledged) one or more of the first report quantity(s) according to or following those specified/defined herein in the present disclosure according to or following one or more of:
   Beam application time (BAT) setting 1: when a UE would transmit a PUCCH with positive HARQ-ACK or a PUSCH with positive HARQ-ACK corresponding to the DCI (the NWR herein) carrying the TCI state(s) indication (the acknowledgement(s) herein) and without DL assignment, or corresponding to one or more PDSCH(s) scheduled by the DCI (the NWR herein) carrying the TCI state(s) indication (the acknowledgement(s) herein), and if the indicated TCI state(s) associated, corresponding, linked or specific to the (network acknowledged) one or more of the first report quantity(s) is/are different from the previously indicated one(s), the indicated TCI-State(s) and/or TCI-UL-State(s) could be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state(s) carried in the latest DCI, for the corresponding coresetPoolIndex value when applicable, in time corresponding to positive HARQ-ACK value is applied, wherein the first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK.
   BAT setting 2: the TCI state(s) associated, corresponding, linked or specific to the (network acknowledged) one or more of the first report quantity(s) could be applied
      no earlier than B1 symbol(s)/slot(s)/etc. and/or no later than B2 symbol(s)/slot(s) after or starting from a/the last (or first) symbol/slot/etc. of receiving or reception of the NWR, and/or
      starting from a/the first symbol/slot/etc. that is at least B3 symbol(s)/slot(s) after or starting from a/the last (or first) symbol/slot/etc. of receiving or reception of the NWR,
   wherein the UE could determine or identify the value(s) of B1, B2 and/or B3 according to or based on: (i) fixed value(s) in system specification(s) and/or per RRC (re-)configuration(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For example, the UE could be configured with or provided by the network the value(s) of B1, B2 and/or B3 via/by/in one or more higher layer parameters in higher layer RRC signaling(s)/parameter(s) CSI-ReportConfig and/or UEI-ReportConfig that provides or configures necessary information/setting(s) and/or resource and/or reporting setting(s) for the UE-initiated/event-driven beam operations as specified/defined herein in the present disclosure. For another example, the UE could be indicated in the NWR the value(s) of B1, B2 and/or B3; in this case, when/if the NWR is a DCI—e.g., a beam indication DCI of format 1_1/1_2 with or without DL assignment, the value(s) of B1, B2 and/or B3 could be indicated in/by new/dedicated DCI field(s) and/or by repurposing one or more codepoints of one or more existing DCI fields—e.g., the TPMI field(s)—in the corresponding DCI format(s).

The UE could determine or identify which of the BAT setting 1 or setting 2 to use, apply or follow to determine or identify when to use or apply the TCI state(s) associated or specific to the (network acknowledged) one or more of the first report quantity(s) according to or based on:
Fixed rule(s) in system specification(s) and/or per RRC (re-)configuration(s): for example, when/if the number KI of the first report quantity(s) is less (or greater) than or equal to a threshold (e.g., 1), the UE could follow the BAT setting 2 to determine or identify when to use or apply the TCI state(s), and when/if the number K1 of the first report quantity(s) is greater (or less) than or equal to the threshold (e.g. 1), the UE could follow the BAT setting 1 to determine or identify when to use or apply the TCI state(s), wherein the UE could determine or identify the threshold value according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); and/or
Network's configuration(s) and/or indication(s), e.g., via higher layer RRC signaling(s)/parameter(s) and/or MAC CE command(s) and/or dynamic DCI based L1 signaling(s) based on or according to corresponding UE's capability(s) and/or capability signaling(s)
   For example, when/if one or more of the events, e.g., Event-2, as specified/defined herein in the present disclosure is/are configured or enabled, the UE could follow the BAT setting 2 to determine or identify when to use or apply the TCI state(s), and/or when/if one or more of the events, e.g., Event-1, as specified/defined herein in the present disclosure is/are configured or enabled, the UE could follow the BAT setting 2 to determine or identify when to use or apply the TCI state(s).
   For another example, the UE could be provided or configured by the network, e.g., via/by/in higher layer parameter(s)/signaling(s) CSI-ReportConfig and/or UEI-ReportConfig that provides or configures necessary information and/or setting(s) for the UE-initiate/event-driven beam operations including beam(s) reporting and/or beam(s) switching/update according to or following those specified herein in the present disclosure, a higher layer parameter beamAppTimeType; in this case, when/if the higher layer parameter beamAppTimeType is set to ‘BAT1’, the UE could follow the BAT setting 1 to determine or identify when to use or apply the TCI state(s), and when/if the higher layer parameter beamAppTimeType is set to ‘BAT2’, the UE could follow the BAT setting 2 to determine or identify when to use or apply the TCI state(s).
   For another example, the UE could be indicated in the NWR a one-bit indicator; in this case, when/if the one-bit indicator is set to ‘1’(or ‘0’), the UE could follow the BAT setting 1 to determine or identify when to use or apply the TCI state(s), and when/if the one-bit indicator is set to ‘0’(or ‘1’), the UE could follow the BAT setting 2 to determine or identify when to use or apply the TCI state(s); in addition, when/if the NWR is a DCI—e.g., a beam indication DCI of format 1_1/1_2 with or without DL assignment, the one-bit indicator could be indicated in/by new/dedicated DCI field(s) and/or by repurposing one or more codepoints of one or more existing DCI fields—e.g., the TPMI field(s)—in the corresponding DCI format(s).
UE's autonomous determination(s) and/or selection(s), which could be further signaled, sent, transmitted or indicated to the network via various UL channels/signals including CSI/beam report(s), UE's capability signaling(s) and/or etc.: for example, a PN message/trigger transmitted or sent over/by/on PUCCH resource(s) of the first UL channel, and/or the UEI report content(s)/quantity(s) transmitted or sent over/by/on PUSCH resource(s) of the second UL channel could correspond to or comprise or indicate or provide or include or contain a one-bit indicator; in this case, when/if the one-bit indicator is set to ‘1’(or ‘0’), the UE could follow the BAT setting 1 to determine or identify when to use or apply the TCI state(s), and when/if the one-bit indicator is set to ‘0’(or ‘1’), the UE could follow the BAT setting 2 to determine or identify when to use or apply the TCI state(s).
In another example, when/if the UEI report(s) e.g. the UEI report content(s)/quantity(s) also comprises the second report quantity(s) according to or following those specified herein in the present disclosure, and/or when/if the corresponding NWR does not comprise any acknowledgement(s) to any of the first report quantity(s) for or specific to the UE reporting triggered or initiated beam(s)/TCI state(s) update/switching according to or following those specified/defined herein in the present disclosure, and/but comprises acknowledgement(s) to one or more of the second report quantity(s) for or specific to the (UE-initiated/event-driven) beam reporting—i.e., not for or specific to the UE reporting triggered or initiated beam(s)/TCI state(s) update/switching according to or following those specified/defined herein in the present disclosure, the UE could apply the TCI state(s) associated, corresponding, linked or specific to the (network acknowledged) one or more of the second report quantity(s) according to or following those specified/defined herein in the present disclosure according to or following: when a UE would transmit a PUCCH with positive HARQ-ACK or a PUSCH with positive HARQ-ACK corresponding to the DCI (the NWR herein) carrying the TCI state(s) indication (the received acknowledgement(s) herein) and without DL assignment, or corresponding to one or more PDSCH(s) scheduled by the DCI (the NWR herein) carrying the TCI state(s) indication (the received acknowledgement(s) herein), and if the indicated TCI state(s) associated, corresponding, linked or specific to the (network acknowledged) one or more of the second report quantity(s) is/are different from the previously indicated one(s), the indicated TCI-State(s) and/or TCI-UL-State(s) could be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state(s) carried in the latest DCI, for the corresponding coresetPoolIndex value when applicable, in time corresponding to positive HARQ-ACK value is applied, wherein the first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK.

According to or following those specified/defined herein in the present disclosure, a report quantity specific to or for the UE reporting triggered or initiated beam(s)/TCI state(s) switching/update could correspond to or could be in form/terms of (i) a resource indicator including a SSBRI or a CRI, or (ii) a TCI state ID/index. In this case,
when/if the report quantity specific to or for the UE reporting triggered or initiated beam(s)/TCI state(s) switching according to or following those specified/defined herein in the present disclosure corresponds to or is in form/terms of a resource indicator such as a SSBRI or a CRI, the RS or RS resource corresponding to the resource indicator could be (selected or determined) from the (set of) candidate/new beam RS(s) or RS resource(s)—e.g., in terms/form the corresponding RS/resource ID(s)/index(es)—as configured or provided in Event-1, Event-3, Event-4, Event-5, Event-6 and/or Event-7 as specified/defined herein in the present disclosure, and/or
when/if the report quantity specific to or for the UE reporting triggered or initiated beam(s)/TCI state(s) switching according to or following those specified/defined herein in the present disclosure corresponds to or is in form/terms of a TCI state ID/index, the RS(s) or RS resource(s) associated, specific or corresponding to the TCI state that has the TCI state ID/index could be (selected or determined) from the (set of) candidate/new beam RS(s) or RS resource(s)—e.g., in terms/form the corresponding RS/resource ID(s)/index(es)—as configured or provided in Event-1, Event-3, Event-4, Event-5, Event-6 and/or Event-7 as specified/defined herein in the present disclosure.

According to or following those specified/defined herein in the present disclosure, when/if K1=1, or equivalently, when/if the UEI report(s) or the UEI report content(s)/quantity(s) sent or transmitted over/by/on the PUSCH(s)/PUSCH resource(s) of the second UL channel as in Step-3 of Mode A and/or Mode C and/or Step-2 of Mode B comprises only one (i.e., K1=1) first report quantity (and/or its corresponding beam metric if any/reported) for the UE reporting triggered or initiated beam(s)/TCI state(s) switching/update, or optionally, when/if a UE sends or transmits, in a reporting instance/CSI report (e.g., in part of the UEI report content(s)/quantity(s) sent or transmitted over/by/on the PUSCH(s)/PUSCH resource(s) of the second UL channel as in Step-3 of Mode A and/or Mode C and/or Step-2 of Mode B), only one (i.e., K1=1) first report quantity (and/or its corresponding beam metric if any/reported) for the UE reporting triggered or initiated beam(s)/TCI state(s) switching/update according to or following those specified/defined herein in the present disclosure, the NWR could correspond to or could be in form of, e.g., (i) a one-bit ACK indicator in a DCI format (e.g., a beam indication DCI format 1_1/1_2 with or without DL assignment)—in this case, the one-bit ACK indicator could be indicated by/in a new/dedicated DCI field in the DCI format and/or by repurposing one or more codepoints of one or more existing DCI fields (e.g., a/the TCI field and/or a/the TPMI field) in the DCI format, (ii) a TCI state (update) indicated via/by a TCI codepoint in a (unified) TCI state(s) activation/activation MAC CE command and/or of a/the TCI field in a beam indication DCI of format 1_1/1_2 with or without DL assignment—in this case, the indicated TCI state could be specific or associated or corresponding to the reported first report quantity according to or following those specified/defined herein in the present disclosure, (iii) a RS or RS resource ID/index in a DCI format (e.g., a beam indication DCI format 1_1/1_2 with or without DL assignment)—in this case, the indicated RS/RS resource ID/index could be specific or associated or corresponding to the reported first report quantity according to or following those specified herein in the present disclosure, and the RS/RS resource ID/index could be indicated by/in a new/dedicated DCI field in the DCI format and/or by repurposing one or more codepoints of one or more existing DCI fields (e.g., a/the TCI field and/or a/the TPMI field) in the DCI format, and/or (iv) a (small (payload) size) dedicated DCI format, e.g., for beam indication, comprising one or more of the indicators/fields as specified/defined herein in the present disclosure—e.g., those in (i), (ii) and/or (iii) described above, and/or the UE could follow the BAT setting 2 to determine or identify when to use or apply the TCI state(s) associated, specific or corresponding to the first report quantity according to or following those specified/defined herein in the present disclosure.

According to or following those specified or defined herein in the present disclosure, when/if the UEI report(s) or more specifically the UEI report content(s)/quantity(s) sent or transmitted over/by/on one or more PUSCHs/PUSCH resources of the second UL channel as in Step-3 of Mode A and/or Mode C and/or Step-2 of Mode B comprises at least (or only) first report quantity(s)—and/or the corresponding beam metric(s) if any/reported—for the UE reporting triggered or initiated beam(s)/TCI state(s) switching/update according to or following those specified/defined herein in the present disclosure, and/or when/if the UE does not receive a corresponding NWR for or specific to or in response to one or more of the reported first report quantity(s) and/or any type/form of a NWR e.g. before a reference symbol/slot/etc. that is A2 symbol(s)/slot(s)/etc. after or starting from a/the last (or first) symbol/slot/etc. of the (initial/previous) transmission of the PUSCH(s) or PUSCH resource(s) of the second UL channel that carries or conveys the UEI report content(s)/quantity(s),
the UE could (re-)transmit or (re-)send a/the (same) PN message/trigger over/by/on one or more PUCCHs/PUCCH resources of the first UL channel as in Step-1 of Mode A, Mode B and/or Mode C—associated or specific or corresponding to the (initial/previous) transmission of the UEI report content(s)/quantity(s) over/by/on one or more PUSCHs/PUSCH resources of the second UL channel as in Step-3 of Mode A and/or Mode C and/or Step-2 of Mode B according to or following those specified/defined herein in the present disclosure, and/or the (same) UEI report content(s)/quantity(s) comprising at least the (same) first report quantity(s) over/by/on one or more PUSCHs/PUSCH resources of the second UL channel as in Step-3 of Mode A and/or Mode C and/or Step-2 of Mode B
   no earlier than C1 symbol(s)/slot(s)/etc. and/or no later than C2 symbol(s)/slot(s)/etc. after or starting from a/the reference slot/symbol/etc. as specified/defined herein in the present disclosure, and/or
   starting from a/the first symbol/slot/etc. that is at least C3 symbol(s)/slot(s)/etc. after or starting from a/the reference slot/symbol/etc. as specified/defined herein in the present disclosure, and/or
   no earlier than D1 symbol(s)/slot(s)/etc. and/or no later than D2 symbol(s)/slot(s)/etc. after or starting from a/the last (or first) symbol/slot/etc. of the (initial/previous) transmission(s) of the PUSCH(s) or PUSCH resource(s) of the second UL channel that carries or conveys the UEI report content(s)/quantity(s), and/or
   starting from a/the first symbol/slot/etc. that is at least D3 symbol(s)/slot(s)/etc. after or starting from a/the last (or first) symbol/slot/etc. of the (initial/previous) transmission(s) of the PUSCH(s) or PUSCH resource(s) of the second UL channel that carries or conveys the UEI report content(s)/quantity(s),
wherein the UE could determine or identify the value(s) of C1, C2, C3, D1, D2 and/or D3 according to or based on: (i) fixed value(s) in system specification(s) and/or per RRC (re-)configuration(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; in this case, after the UE has (re-)transmitted or (re-)sent a/the (same) PN message/trigger and/or the (same) UEI report content(s)/quantity(s) comprising at least the (same) first report quantity(s) a number of times (higher layer configured), the UE could drop or cancel or stop transmitting or transmission(s) of the (same) PN message/trigger and/or the (same) UEI report content(s)/quantity(s) comprising at least the (same) first report quantity(s); optionally, when/if the UE receives a corresponding NWR for or specific to or in response to one or more of the reported first report quantity(s) after a/the reference slot/symbol/etc. as specified/defined herein in the present disclosure and before the UE could perform or conduct or execute any of the aforementioned (re-)transmission(s) and/or (re-)sending(s), the UE could follow the NWR to use or apply the TCI state(s) associated, specific or corresponding to one or more of the first report quantity(s) acknowledged by the NWR according to or following those specified herein in the present disclosure, and the UE could cancel, stop and/or drop any of the aforementioned (re-)transmission(s) and/or (re-)sending(s); and/or
the UE could apply or use the TCI state(s) associated, specific or corresponding to the first report quantity(s) according to or following those specified herein in the present disclosure,
   no earlier than E1 symbol(s)/slot(s)/etc. and/or no later than E2 symbol(s)/slot(s)/etc. after or starting from a/the reference slot/symbol/etc. as specified/defined herein in the present disclosure, and/or
   starting from a/the first symbol/slot/etc. that is at least E3 symbol(s)/slot(s)/etc. after or starting from a/the reference slot/symbol/etc. as specified/defined herein in the present disclosure, and/or
   no earlier than F1 symbol(s)/slot(s)/etc. and/or no later than F2 symbol(s)/slot(s)/etc. after or starting from a/the last (or first) symbol/slot/etc. of the (initial/previous) transmission(s) of the PUSCH(s) or PUSCH resource(s) of the second UL channel that carries or conveys the UEI report content(s)/quantity(s), and/or
   starting from a/the first symbol/slot/etc. that is at least F3 symbol(s)/slot(s)/etc. after or starting from a/the last (or first) symbol/slot/etc. of the (initial/previous) transmission(s) of the PUSCH(s) or PUSCH resource(s) of the second UL channel that carries or conveys the UEI report content(s)/quantity(s),
wherein the UE could determine or identify the value(s) of E1, E2, E3, F1, F2 and/or F3 according to or based on: (i) fixed value(s) in system specification(s) and/or per RRC (re-)configuration(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; and/or
the UE could apply or use the previously indicated TCI state(s); and/or
when/if the UE receives from the network a NWR e.g. specific to or for or in response to one or more of the second report quantities, if reported, e.g. before the reference symbol/slot/etc., wherein the NWR here could correspond to or could be in form of TCI state(s) update indicated via/by TCI codepoint(s) in a (unified) TCI state(s) activation/activation MAC CE command and/or of a/the TCI field(s) in a beam indication DCI of format 1_1/1_2 with or without DL assignment, the UE could follow the NWR to use or apply the indicated TCI state(s) according to or following those specified herein in the present disclosure, and/or the UE could (re-)transmit or (re-)send a/the (same) PN message/trigger over/by/on one or more PUCCHs/PUCCH resources of the first UL channel as in Step-1 of Mode A, Mode B and/or Mode C—associated or specific or corresponding to the (initial/previous) transmission of the UEI report content(s)/quantity(s) over/by/on one or more PUSCHs/PUSCH resources of the second UL channel as in Step-3 of Mode A and/or Mode C and/or Step-2 of Mode B according to or following those specified/defined herein in the present disclosure, and/or the (same) UEI report content(s)/quantity(s) comprising at least the (same) first report quantity(s) over/by/on one or more PUSCHs/PUSCH resources of the second UL channel as in Step-3 of Mode A and/or Mode C and/or Step-2 of Mode B
   no earlier than GI symbol(s)/slot(s)/etc. and/or no later than G2 symbol(s)/slot(s)/etc. after or starting from a/the last (or first) symbol/slot/etc. of receiving or reception of the NWR, and/or
   starting from a/the first symbol/slot/etc. that is at least G3 symbol(s)/slot(s)/etc. after or starting from a/the last (or first) symbol/slot/etc. of receiving or reception of the NWR,
wherein the UE could determine or identify the value(s) of G1, G2 and/or G3 according to or based on: (i) fixed value(s) in system specification(s) and/or per RRC (re-)configuration(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; in this case, after the UE has (re-)transmitted or (re-)sent a/the (same) PN message/trigger and/or the (same) UEI report content(s)/quantity(s) comprising at least the (same) first report quantity(s) a number of times (higher layer configured), the UE could drop or cancel or stop transmitting or transmission(s) of the (same) PN message/trigger and/or the (same) UEI report content(s)/quantity(s) comprising at least the (same) first report quantity(s); optionally, when/if the UE receives a corresponding NWR for or specific to or in response to one or more of the reported first report quantity(s) after a/the reference slot/symbol/etc. as specified/defined herein in the present disclosure and before the UE could perform or conduct or execute any of the aforementioned (re-)transmission(s) and/or (re-)sending(s), the UE could follow the NWR to use or apply the TCI state(s) associated, specific or corresponding to one or more of the first report quantity(s) acknowledged by the NWR according to or following those specified herein in the present disclosure, and the UE could cancel, stop and/or drop any of the aforementioned (re-)transmission(s) and/or (re-)sending(s).

Throughout the present disclosure, a (first or second) report quantity could correspond to or could comprise one or more of:
a resource indicator such as a SSBRI or a CRI
a TCI state ID/index
a resource indicator such as a SSBRI or a CRI and its corresponding or associated beam metric such as a L1-RSRP or a L1-SINR
a TCI state ID/index and its corresponding or associated beam metric such as a L1-RSRP or a L1-SINR.

Or, when/if a UE reports or transmits or sends, in a reporting instance/CSI report, a first (or second) report quantity as specified/defined herein in the present disclosure, the UE could also report or transmit or send, in the same reporting instance/CSI report, a beam metric such as a L1-RSRP/L1-SINR associated or corresponding to the first (or second) report quantity.

According to or following those specified or defined herein in the present disclosure, (higher layer(s) of) a UE could start a prohibit timer
no earlier than P1 symbol(s)/slot(s) and/or no later than P2 symbol(s)/slot(s) after a/the last (or first) symbol/slot/etc. of a reference timing, and/or
starting from a/the first symbol/slot/etc. that is at least P3 symbol(s)/slot(s) after a/the last (or first) symbol/slot/etc. of a reference timing,
   wherein the reference timing could correspond to or could be in form of one or more of:
   transmitting or transmission of a/the PN message/trigger via/on/over/in one or more PUCCHs or PUCCH resources of the first UL channel as in Step-1 of Mode A, Mode B and/or Mode C, wherein (transmission of) the PN message/trigger could be to (i) request UL resource(s) e.g. PUSCH resource(s) of the second UL channel as in Step-3 of Mode A and/or Mode C for transmitting or sending the UEI report(s) and/or UEI report quantity(s)/content(s) comprising the first and/or second report quantity(s)—and therefore, the corresponding beam metric(s) if any/reported—as specified/defined herein in the present disclosure, or (ii) to notify or indicate transmission(s) of the first and/or second report quantity(s)—and therefore, the corresponding beam metric(s) if any/reported—in (part of) the UEI report(s) and/or the corresponding UEI report content(s)/quantity(s) transmitted or sent over/in/on/by one or more of the (configured) PUSCH resources of the second UL channel as in Step-2 of Mode B;
receiving or reception of a DCI e.g. of DCI format 0_1/0_2 as in Step-2 of Mode A and/or Mode C as specified/defined herein in the present disclosure in response to (transmission of) the PN message/trigger, and provide UL resource(s) e.g. PUSCH resource(s) of the second UL channel as in Step-3 of Mode A and/or Mode C and/or timing assumption(s) e.g. which slot(s) to be used/applied for transmitting or sending the UEI report(s) and/or UEI report quantity(s)/content(s) comprising the first and/or second report quantity(s)—and therefore, the corresponding beam metric(s) if any/reported—as specified/defined herein in the present disclosure;
transmitting or transmission(s) of the UEI report content(s)/quantity(s) comprising the first and/or second report quantity(s)—and therefore, the corresponding beam metric(s) if any/reported—as specified/defined herein in the present disclosure in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s));
   receiving or reception(s) of a NWR as specified/defined herein in the present disclosure in response to, e.g., acknowledging reception(s) of, the UEI report content(s)/quantity(s) comprising the first and/or second report quantity(s)—and therefore, the corresponding beam metric(s) if any/reported—as specified/defined herein in the present disclosure transmitted or sent in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s));
receiving or reception(s) of a NWR as specified/defined herein in the present disclosure in response to, e.g., acknowledging reception(s) of (e.g. in form of a one-bit indicator, TCI state(s) update/indication and/or etc. according to or following those specified herein in the present disclosure), one or more of the first report quantity(s) transmitted or sent in (part of) the UEI report(s) and/or the corresponding UEI report content(s)/quantity(s) specific to or for the UE reporting triggered or initiated TCI state(s)/beam(s) switching and/or update according to or following those specified/defined herein in the present disclosure;
receiving or reception(s) of a NWR as specified/defined herein in the present disclosure in response to, e.g., acknowledging reception(s) of, one or more of the second report quantity(s) transmitted or sent in (part of) the UEI report(s) and/or the corresponding UEI report content(s)/quantity(s) specific to or for the (UE-initiated/event-driven) beam reporting according to or following those specified/defined herein in the present disclosure,
   and the UE could determine or identify value(s) of P1, P2 and/or P3 according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent or transmitted to the network via various UL channels/signals and/or in part of a CSI/beam report and/or UE's capability signaling. When the prohibit timer is running, the UE may not be expected (or allowed or enabled) to:
   transmit or send any PN message(s)/trigger(s) via/on/over/in one or more PUCCHs or PUCCH resources of the first UL channel as in Step-1 of Mode A, Mode B and/or Mode C to (i) request UL resource(s) e.g. PUSCH resource(s) of the second UL channel as in Step-3 of Mode A and/or Mode C for transmitting or sending the UEI report(s) and/or UEI report quantity(s)/content(s) comprising the first and/or second report quantity(s)—and therefore, the corresponding beam metric(s) if any/reported—as specified/defined herein in the present disclosure, or (ii) to notify or indicate transmission(s) of the first and/or second report quantity(s)—and therefore, the corresponding beam metric(s) if any/reported—in (part of) the UEI report(s) and/or the corresponding UEI report content(s)/quantity(s) transmitted or sent over/in/on/by one or more of the (configured) PUSCH resources of the second UL channel as in Step-2 of Mode B; and/or
transmit or send any UEI report content(s)/quantity(s) comprising the first and/or second report quantity(s)—and therefore, the corresponding beam metric(s) if any/reported—as specified/defined herein in the present disclosure in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s)).

Optionally, the aforementioned prohibit timer could be specific to or for the first report quantity(s); in this case, the reference timing could correspond to or could be in form of one or more of:
transmitting or transmission of a/the PN message/trigger via/on/over/in one or more PUCCHs or PUCCH resources of the first UL channel as in Step-1 of Mode A, Mode B and/or Mode C, wherein (transmission of) the PN message/trigger could be to (i) request UL resource(s) e.g. PUSCH resource(s) of the second UL channel as in Step-3 of Mode A and/or Mode C for transmitting or sending the UEI report(s) and/or UEI report quantity(s)/content(s) comprising at least the first report quantity(s)—and therefore, the corresponding beam metric(s) if any/reported—as specified/defined herein in the present disclosure, or (ii) to notify or indicate transmission(s) of at least the first report quantity(s)—and therefore, the corresponding beam metric(s) if any/reported—in (part of) the UEI report(s) and/or the corresponding UEI report content(s)/quantity(s) transmitted or sent over/in/on/by one or more of the (configured) PUSCH resources of the second UL channel as in Step-2 of Mode B;
receiving or reception of a DCI e.g. of DCI format 0_1/0_2 as in Step-2 of Mode A and/or Mode C as specified/defined herein in the present disclosure in response to (transmission of) the PN message/trigger, and provide UL resource(s) e.g. PUSCH resource(s) of the second UL channel as in Step-3 of Mode A and/or Mode C and/or timing assumption(s) e.g. which slot(s) to be used/applied for transmitting or sending the UEI report(s) and/or UEI report quantity(s)/content(s) comprising at least the first report quantity(s)—and therefore, the corresponding beam metric(s) if any/reported—as specified/defined herein in the present disclosure;
transmitting or transmission(s) of the UEI report content(s)/quantity(s) comprising at least the first report quantity(s)—and therefore, the corresponding beam metric(s) if any/reported—as specified/defined herein in the present disclosure in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s));
receiving or reception(s) of a NWR as specified/defined herein in the present disclosure in response to, e.g., acknowledging reception(s) of, the UEI report content(s)/quantity(s) comprising at least the first report quantity(s)—and therefore, the corresponding beam metric(s) if any/reported—as specified/defined herein in the present disclosure transmitted or sent in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s));
receiving or reception(s) of a NWR as specified/defined herein in the present disclosure in response to, e.g., acknowledging reception(s) of (e.g. in form of a one-bit indicator, TCI state(s) update/indication and/or etc. according to or following those specified herein in the present disclosure), one or more of the first report quantity(s) transmitted or sent in (part of) the UEI report(s) and/or the corresponding UEI report content(s)/quantity(s) specific to or for the UE reporting triggered or initiated TCI state(s)/beam(s) switching and/or update according to or following those specified/defined herein in the present disclosure.

When the prohibit timer specific to or for the first report quantity(s) is running, the UE may not be expected (or allowed or enabled) to:
transmit or send any PN message(s)/trigger(s) via/on/over/in one or more PUCCHs or PUCCH resources of the first UL channel as in Step-1 of Mode A, Mode B and/or Mode C to (i) request UL resource(s) e.g. PUSCH resource(s) of the second UL channel as in Step-3 of Mode A and/or Mode C for transmitting or sending the UEI report(s) and/or UEI report quantity(s)/content(s) comprising at least the first report quantity(s)—and therefore, the corresponding beam metric(s) if any/reported—as specified/defined herein in the present disclosure, or (ii) to notify or indicate transmission(s) of at least the first report quantity(s)—and therefore, the corresponding beam metric(s) if any/reported—in (part of) the UEI report(s) and/or the corresponding UEI report content(s)/quantity(s) transmitted or sent over/in/on/by one or more of the (configured) PUSCH resources of the second UL channel as in Step-2 of Mode B; and/or
transmit or send any UEI report content(s)/quantity(s) comprising at least the first report quantity(s)—and therefore, the corresponding beam metric(s) if any/reported—as specified/defined herein in the present disclosure in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s)).

In addition, the aforementioned prohibit timer could be specific to or for the second report quantity(s); in this case, the reference timing could correspond to or could be in form of one or more of:
transmitting or transmission of a/the PN message/trigger via/on/over/in one or more PUCCHs or PUCCH resources of the first UL channel as in Step-1 of Mode A, Mode B and/or Mode C, wherein (transmission of) the PN message/trigger could be to (i) request UL resource(s) e.g. PUSCH resource(s) of the second UL channel as in Step-3 of Mode A and/or Mode C for transmitting or sending the UEI report(s) and/or UEI report quantity(s)/content(s) comprising at least the second report quantity(s)—and therefore, the corresponding beam metric(s) if any/reported—as specified/defined herein in the present disclosure, or (ii) to notify or indicate transmission(s) of at least the second report quantity(s)—and therefore, the corresponding beam metric(s) if any/reported—in (part of) the UEI report(s) and/or the corresponding UEI report content(s)/quantity(s) transmitted or sent over/in/on/by one or more of the (configured) PUSCH resources of the second UL channel as in Step-2 of Mode B;
receiving or reception of a DCI e.g. of DCI format 0_1/0_2 as in Step-2 of Mode A and/or Mode C as specified/defined herein in the present disclosure in response to (transmission of) the PN message/trigger, and provide UL resource(s) e.g. PUSCH resource(s) of the second UL channel as in Step-3 of Mode A and/or Mode C and/or timing assumption(s) e.g. which slot(s) to be used/applied for transmitting or sending the UEI report(s) and/or UEI report quantity(s)/content(s) comprising at least the second report quantity(s)—and therefore, the corresponding beam metric(s) if any/reported—as specified/defined herein in the present disclosure;
transmitting or transmission(s) of the UEI report content(s)/quantity(s) comprising at least the second report quantity(s)—and therefore, the corresponding beam metric(s) if any/reported—as specified/defined herein in the present disclosure in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s));
receiving or reception(s) of a NWR as specified/defined herein in the present disclosure in response to, e.g., acknowledging reception(s) of, the UEI report content(s)/quantity(s) comprising at least the second report quantity(s)—and therefore, the corresponding beam metric(s) if any/reported—as specified/defined herein in the present disclosure transmitted or sent in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s));
receiving or reception(s) of a NWR as specified/defined herein in the present disclosure in response to, e.g., acknowledging reception(s) of, one or more of the second report quantity(s) transmitted or sent in (part of) the UEI report(s) and/or the corresponding UEI report content(s)/quantity(s) specific to or for the (UE-initiated/event-driven) beam reporting according to or following those specified/defined herein in the present disclosure.
When the prohibit timer specific to or for the second report quantity(s) is running, the UE may not be expected (or allowed or enabled) to:
transmit or send any PN message(s)/trigger(s) via/on/over/in one or more PUCCHs or PUCCH resources of the first UL channel as in Step-1 of Mode A, Mode B and/or Mode C to (i) request UL resource(s) e.g. PUSCH resource(s) of the second UL channel as in Step-3 of Mode A and/or Mode C for transmitting or sending the UEI report(s) and/or UEI report quantity(s)/content(s) comprising at least the second report quantity (s)—and therefore, the corresponding beam metric(s) if any/reported—as specified/defined herein in the present disclosure, or (ii) to notify or indicate transmission(s) of at least the second report quantity(s)—and therefore, the corresponding beam metric(s) if any/reported—in (part of) the UEI report(s) and/or the corresponding UEI report content(s)/quantity(s) transmitted or sent over/in/on/by one or more of the (configured) PUSCH resources of the second UL channel as in Step-2 of Mode B; and/or
transmit or send any UEI report content(s)/quantity(s) comprising at least the second report quantity(s)—and therefore, the corresponding beam metric(s) if any/reported—as specified/defined herein in the present disclosure in/on/over/by the PUSCH(s)/PUSCH resource(s) of the second UL channel as in Step-3 of Mode A and/or Mode C (e.g., DG PUSCH(s)/PUSCH resource(s)) and/or Step-2 of Mode B (e.g., CG PUSCH(s)/PUSCH resource(s)).

Throughout the present disclosure, a TCI state associated, specific or corresponding to a RS or RS resource (or vice versa) could correspond to or could be equivalent to or could be referred to/regarded as:
the RS or RS resource could correspond to a QCL source RS or RS resource e.g. a NZP CSI-RS resource or resource configuration provided or indicated in the TCI state; and/or
the RS or RS resource could correspond to a QCL root RS or RS resource e.g. a SSB quasi-co-located (QCL'ed)—e.g., of QCL-TypeD—with a RS or RS resource serving/configured as a QCL source RS e.g. a NZP CSI-RS resource or resource configuration provided or indicated in the TCI state.

According to or following those specified or defined herein in the present disclosure, the UE could report, in a/the (same) reporting instance/CSI report (e.g., in (part of) the aforementioned UEI report(s) and/or the corresponding UEI report content(s)/quantity(s)), or equivalently, the UEI report(s) and/or the corresponding UEI report content(s)/quantity(s) carried or conveyed or transmitted or sent in/by/over/on the PUSCH(s) or PUSCH resource(s) of the second UL channel as in Step-3 of Mode A and/or Mode C and/or Step-2 of Mode B could comprise, report quantity(s) specific to or for the current beam RS(s) or RS resource(s), wherein the report quantity(s) here could be in form of or could correspond to:
resource indicator(s) e.g. SSBRI(s) or CRI(s) corresponding, associated or specific to the current beam RS(s) or RS resource(s); and/or
TCI state ID(s)/index(es) corresponding, associated or specific to the current beam RS(s) or RS resource(s); and/or
beam metric(s) e.g. L1-RSRP(s) or L1-SINR(s) corresponding, associated or specific to the resource indicator(s) and/or TCI state ID(s)/index(es) corresponding, associated or specific to the current beam RS(s) or RS resource(s), reported in the same reporting instance/CSI report, wherein the current beam RS(s)/RS resource(s) could be configured or provided in a/the (same) RS resource set that comprises the candidate/new beam RS(s) or RS resource(s) if applicable for one or more of the events specified/defined herein in the present disclosure such that the UE could determine or identify the current beam RS or RS resource ID(s)/index(es) according to or based on the total number of RS/resource ID(s)/index(es) provided or configured in the RS resource set comprising the RS/resource IDs/indexes for both the current serving beam and candidate/new beam RSs or RS resources, and/or the bitwidth of the current beam RS or RS resource ID(s)/index(es) as ┌log₂(R)┐, wherein R≥1 represents the total number of RS/resource ID(s)/index(es) provided or configured in the RS resource set comprising the RS/resource IDs/indexes for both the current serving beam and candidate/new beam RSs or RS resources, when/if one or more of the following conditions are satisfied or achieved or held:
one or more of the events—e.g., Event-1, Event-2, Event-3, Event-4, Event-5, Event-6 and/or Event-7 as specified/defined herein in the present disclosure—are enabled, configured or provided according to or following those specified/defined herein in the present disclosure
a higher layer parameter currentBeamInReport is provided or configured in higher layer RRC signaling(s)/parameter(s) such as CSI-ReportConfig and/or UEI-ReportConfig that provides or configures necessary information and/or setting(s) for the UE-initiated/event-driven beam operations including beam reporting and/or beam switching, and/or set to ‘enabled’ according to or based on a corresponding UE's capability or capability signaling
the UE has transmitted or sent to the network a capability signaling to indicate their support of including report quantity(s) specific to or for the current serving beam RS(s) or RS resource(s) in (part of) the UEI report(s) and/or the corresponding UEI report content(s)/quantity(s).

According to or following those specified/defined herein in the present disclosure,
the UEI report(s) and/or the corresponding UEI report content(s)/quantity(s) transmitted or sent or conveyed or carried by/in/on/over one or more PUSCHs/PUSCH resources of the second UL channel as in Step-3 of Mode A and/or Mode C and/or Step-2 of Mode B could comprise one or more first indicators each associated, corresponding, linked or mapped to a report quantity, wherein each of the one or more first indicators could indicate whether the associated, corresponding, linked or mapped report quantity is or corresponds to a first report quantity (if reported/present/any) for the UE reporting initiated or triggered beam(s)/TCI state(s) switching as specified/defined herein in the present disclosure or a second report quantity (if reported/present/any) for the (UE-initiated/event-driven) beam reporting as specified/defined herein in the present disclosure;
optionally, the UEI report(s) and/or the corresponding UEI report content(s)/quantity(s) could comprise one or more second indicators each associated, corresponding, linked or mapped to a report quantity, wherein each of the one or more second indicators could indicate whether the associated, corresponding, linked or mapped report quantity is or corresponds to a report quantity specific to or for the current serving beam RS(s)/RS resource(s) or not;
   for example, the one or more second indicators could be in form of or correspond to one or more one-bit indicators; in this case, when/if a one-bit indicator is set to ‘1’(or ‘0’), the report quantity—ssociated, corresponding, linked or mapped to the one-bit indicator—reported in (part of) the UEI report(s) and/or the UEI report content(s)/quantity(s) could be specific to or for the current beam RS(s) or RS resource(s)
   for another example, the one or more second indicators could be in form of or correspond to a bitmap, and in this case, each entry/bit position of the bitmap could be associated, corresponding, linked or mapped to a report quantity: when/if an entry/bit position is set to ‘1’(or ‘0’), the report quantity—associated, corresponding, linked or mapped to the entry/bit position—reported in (part of) the UEI report(s) and/or the UEI report content(s)/quantity(s) could be specific to or for the current beam RS(s) or RS resource(s)
in addition, the UEI report(s) and/or the corresponding UEI report content(s)/quantity(s) could comprise one or more third indicators each associated, corresponding, linked or mapped to a report quantity, wherein each of the one or more third indicators could indicate whether the associated, corresponding, linked or mapped report quantity is determined or identified based on or according to determination, detection or declaration of an event (i.e., satisfying the event condition(s)) according to or following those specified or defined herein in the present disclosure;
   when/if one of the events (or a single event)—e.g., Event-x (x belongs to {1, . . . , 7}) defined/specified herein in the present disclosure—is enabled, configured or provided by the network:
      for example, the one or more third indicators could be in form of or correspond to one or more one-bit indicators; in this case, when/if a one-bit indicator is set to ‘1’(or ‘0’), the report quantity—associated, corresponding, linked or mapped to the one-bit indicator—reported in (part of) the UEI report(s) and/or the UEI report content(s)/quantity(s) could be determined or identified based on or according to determination, detection or declaration of the event or Event-x (i.e., satisfying the event (e.g., the Event-x) condition(s)) according to or following those specified or defined herein in the present disclosure; and/or when/if a one-bit indicator is set to ‘0’ (or ‘1’), the report quantity—associated, corresponding, linked or mapped to the one-bit indicator—reported in (part of) the UEI report(s) and/or the UEI report content(s)/quantity(s) may not satisfy the event (e.g., the Event-x) condition(s);
      for another example, the one or more third indicators could be in form of or correspond to a bitmap, and in this case, each entry/bit position of the bitmap could be associated, corresponding, linked or mapped to a report quantity: when/if an entry/bit position is set to ‘1’ (or ‘0’), the report quantity—associated, corresponding, linked or mapped to the entry/bit position—reported in (part of) the UEI report(s) and/or the UEI report content(s)/quantity(s) could be determined or identified based on or according to determination, detection or declaration of the event or Event-x (i.e., satisfying the event (e.g., the Event-x) condition(s)) according to or following those specified or defined herein in the present disclosure; and/or when/if an entry/bit position is set to ‘0’ (or ‘1’), the report quantity—associated, corresponding, linked or mapped to the entry/bit position—reported in (part of) the UEI report(s) and/or the UEI report content(s)/quantity(s) may not satisfy the event (e.g., the Event-x) condition(s)).
   when/if multiple (e.g., N_e>1) events—e.g., Event-x and Event-y (x and y belong to {1, . . . , 7}, x*y and N_e=2) defined/specified herein in the present disclosure—are enabled, configured or provided by the network,
      for example, the one or more third indicators could be in form of or correspond to one or more one/multi-bit (e.g., k-bit with k=┌log₂N_e┐) indicators; for N_e=2, the one or more third indicators could be in form of or could correspond to one or more one-bit indicators: in this case, when/if a one-bit indicator is set to ‘1’ (or ‘0’), the report quantity—associated, corresponding, linked or mapped to the one-bit indicator—reported in (part of) the UEI report(s) and/or the UEI report content(s)/quantity(s) could be determined or identified based on or according to determination, detection or declaration of the Event-x (i.e., satisfying the event (i.e., the Event-x) condition(s)) according to or following those specified or defined herein in the present disclosure; and/or when/if a one-bit indicator is set to ‘0’ (or ‘1’), the report quantity—associated, corresponding, linked or mapped to the one-bit indicator—reported in (part of) the UEI report(s) and/or the UEI report content(s)/quantity(s) could be determined or identified based on or according to determination, detection or declaration of the Event-y (i.e., satisfying the event (i.e., the Event-y) condition(s)) according to or following those specified or defined herein in the present disclosure;
      for another example, the one or more third indicators could be in form of or correspond to one or more (e.g., N_e) bitmaps with each bitmap corresponding, specific, associated or linked to an event, and each entry/bit position of a bitmap corresponding, specific, associated, linked or mapped to a report quantity; for N_e=2, the one or more third indicators could be in form of or could correspond to a first bitmap and a second bitmap: in this case, when/if an entry/bit position of/in the first bitmap is set to ‘1’ (or ‘0’), the report quantity—associated, corresponding, linked or mapped to the entry/bit position of/in the first bitmap—reported in (part of) the UEI report(s) and/or the UEI report content(s)/quantity(s) could be determined or identified based on or according to determination, detection or declaration of the Event-x (i.e., satisfying the event (i.e., the Event-x) condition(s)) according to or following those specified or defined herein in the present disclosure; and/or when/if an entry/bit position of/in the second bitmap is set to ‘1’ (or ‘0’), the report quantity—associated, corresponding, linked or mapped to the entry/bit position of/in the second bitmap—reported in (part of) the UEI report(s) and/or the UEI report content(s)/quantity(s) could be determined or identified based on or according to determination, detection or declaration of the Event-y (i.e., satisfying the event (i.e., the Event-y) condition(s)) according to or following those specified or defined herein in the present disclosure.

As aforementioned, a report quantity sent, transmitted or reported in (part of) the UEI report(s) and/or the corresponding UEI report content(s)/quantity(s) as specified/defined herein in the present disclosure could be associated, linked, mapped, corresponding or specific to,
only the first indicator,
only the second indicator,
only the third indicator,
both the first and second indicators,
both the first and third indicators,
both the second and third indicators,
all the first, second and third indicators
   according to or following those specified herein in the present disclosure; furthermore, a report quantity here could correspond to or could be in form of: (a) a first report quantity, (b) a second report quantity(s), (c) a beam metric including a L1-RSRP/L1-SINR corresponding, associated, mapped, linked or specific to a first report quantity, or (d) a beam metric including a L1-RSRP/L1-SINR corresponding, associated, mapped, linked or specific to a second report quantity.

According to or following those specified/defined herein in the present disclosure,
when/if the number of the (configured, and/or to be reported) first report quantity(s), i.e., KI, in the UEI report(s) and/or the corresponding UEI report content(s)/quantity(s) is greater than or equal to a threshold, and/or the number of the (configured, and/or to be reported) second report quantity(s), i.e., LI, in the UEI report(s) and/or the corresponding UEI report content(s)/quantity(s) is greater than or equal to a threshold, and/or the total number of the (configured, and/or to be reported) first and second report quantities, i.e., K1+L1, in the UEI report(s) and/or the corresponding UEI report content(s)/quantity(s) is greater than or equal to a threshold, and/or the total number of the (configured, and/or to be reported) report quantity(s), i.e., N, in the UEI report(s) and/or the corresponding UEI report content(s)/quantity(s) is greater than or equal to a threshold, and/or when/if the UE-initiated/event-driven beam operations including beam reporting and/or beam switching is enabled according to or following those specified herein in the present disclosure, and/or when/if one or more of the events as specified/defined herein in the present disclosure is configured, provided and/or enabled, differential L1-RSRP/L1-SINR reporting could be enabled for the UE-initiated/event-driven beam reporting and/or UE reporting triggered or initiated beam(s)/TCI state(s) switching and/or update according to or following those specified herein in the present disclosure, such that for differential RSRP reporting of the measured L1-RSRPs specific to or for at least the first and/or second report quantity(s), the largest measured value of L1-RSRP is quantized to a 7-bit value in the range [−140, −44] dBm with 1 dB step size, and the differential L1-RSRP is quantized to a 4-bit value; the differential L1-RSRP value is computed with 2 dB step size with a reference to the largest measured L1-RSRP value which is part of the same LI-RSRP reporting instance and/or UEI report(s) and/or UEI report content(s)/quantity(s) that comprises the first and/or second report quantity(s), and for differential SINR reporting of the measured L1-SINRs specific to or for at least the first and/or second report quantity(s), the largest measured value of L1-SINR is quantized to a 7-bit value in the range [−23, 40] dB with 0.5 dB step size, and the differential L1-SINR is quantized to a 4-bit value. The differential L1-SINR is computed with 1 dB step size with a reference to the largest measured L1-SINR value which is part of the same L1-SINR reporting instance and/or UEI report(s) and/or UEI report content(s)/quantity(s) that comprises the first and/or second report quantity(s). When NZP CSI-RS is configured for channel measurement and/or interference measurement, the reported L1-SINR values should not be compensated by the power offset(s) given by higher layer parameter powerControOffsetSS or powerControlOffset.
otherwise, for L1-RSRP reporting, the reported L1-RSRP value is defined by a 7-bit value in the range [−140, −44] dBm with 1 dB step size; and for L1-SINR reporting, the reported L1-SINR value is defined by a 7-bit value in the range [−23, 40] dB with 0.5 dB step size,
   wherein the UE could determine or identify the threshold value(s) according to or based on (i) fixed value(s), e.g., 1, in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Optionally, for the differential L1-RSRP/L1-SINR reporting as specified/defined herein in the present disclosure, the UE could transmit, send or report, in the UEI report(s) and/or the corresponding UEI report content(s)/quantity(s) as specified/defined herein in the present disclosure in a reporting instance/CSI report, or equivalently, the UEI report(s) and/or the corresponding UEI report content(s)/quantity(s) as specified/defined herein in the present disclosure sent, transmitted or reported in a reporting instance/CSI report could comprise one or more of:
a first indicator to indicate whether the largest measured value of L1-RSRP/L1-SINR as specified/defined herein in the present disclosure is specific to or for the current serving beam RS(s)/RS resource(s), if reported; for instance, when/if the first indicator is set to ‘1’ (or ‘0’), the largest measured value of L1-RSRP/L1-SINR as specified/defined herein in the present disclosure could be specific to or for the current serving beam RS(s)/RS resource(s), if reported; otherwise, i.e., when/if the first indicator is set to ‘0’ (or ‘1’), the largest measured value of L1-RSRP/L1-SINR as specified/defined herein in the present disclosure may not be specific to or for the current serving beam RS(s)/RS resource(s); the first indicator could be present or absent in the UEI report(s) and/or the corresponding UEI report content(s)/quantity(s) as specified or defined herein in the present disclosure—e.g., when/if transmitting, sending and/or reporting report quantity(s) related, specific, associated or corresponding to the current beam RS(s) or RS resource(s) is enabled according to or following those specified herein in the present disclosure, the first indicator could be present in the corresponding L1-RSRP/L1-SINR reporting instance and/or UEI report(s) and/or UEI report content(s)/quantity(s) that comprises the first and/or second report quantity(s); otherwise, the first indicator could be absent in/from the corresponding L1-RSRP/L1-SINR reporting instance and/or UEI report(s) and/or UEI report content(s)/quantity(s) that comprises the first and/or second report quantity(s).
a second indicator to indicate whether the largest measured value of L1-RSRP/L1-SINR as specified/defined herein in the present disclosure is specific, associated, corresponding, linked or mapped to a first or a second report quantity, if reported; for instance, when/if the second indicator is set to ‘1’ (or ‘0’), the largest measured value of L1-RSRP/L1-SINR as specified/defined herein in the present disclosure could be specific, corresponding, associated, linked or mapped to a first report quantity, if reported; otherwise, i.e., when/if the second indicator is set to ‘0’ (or ‘1’), the largest measured value of L1-RSRP/L1-SINR as specified/defined herein in the present disclosure could be specific, associated, linked, corresponding or mapped to a second report quantity, if reported; the second indicator could be present or absent in the UEI report(s) and/or the corresponding UEI report content(s)/quantity(s) as specified or defined herein in the present disclosure—e.g., when/if transmitting, sending and/or reporting both the first and second report quantities in a/the (same) reporting instance/CSI report that comprises the UEI report(s) and/or the corresponding UEI report content(s)/quantity(s) is enabled, and/or the UE could transmit or send, in a/the (same) reporting instance/CSI report and/or UEI report(s) and/or the corresponding UEI report content(s)/quantity(s) carried or conveyed by/in/over/on one or more PUSCHs/PUSCH resources of the second UL channel as in Step-3 of Mode A and/or Mode C and/or Step-2 of Mode B, both the first and second report quantities according to or following those specified herein in the present disclosure, the second indicator could be present in the corresponding L1-RSRP/L1-SINR reporting instance and/or UEI report(s) and/or UEI report content(s)/quantity(s) that comprises the first and/or second report quantity(s); otherwise, the second indicator could be absent in/from the corresponding L1-RSRP/L1-SINR reporting instance and/or UEI report(s) and/or UEI report content(s)/quantity(s) that comprises the first and/or second report quantity(s).
a third indicator to indicate whether the largest measured value of L1-RSRP/L1-SINR as specified/defined herein in the present disclosure is specific, associated, corresponding, linked or mapped to a configured/enabled event; in this case, when/if multiple (e.g., N_e>1) events—e.g., Event-x and Event-y (x and y belong to {1, . . . , 7}, x*y and N_e=2) defined/specified herein in the present disclosure—are enabled, configured or provided by the network, the third indicator could be in form of or correspond to a one/multi-bit (e.g., k-bit with k=┌log₂N_e┐) indicator:
   for example, for N_e=2, when/if the third indicator is set to ‘1’ (or ‘0’), the largest measured value of L1-RSRP/L1-SINR as specified/defined herein in the present disclosure could be specific, corresponding, associated, linked or mapped to the Event-x; otherwise, i.e., when/if the third indicator is set to ‘0’ (or ‘1’), the largest measured value of L1-RSRP/L1-SINR as specified/defined herein in the present disclosure could be specific, associated, linked, corresponding or mapped to the Event-y, wherein x and y belong to {1, . . . , 7}, x*y, and x could be smaller (or larger) than y;
   for another example, for N_e>2, when/if the third indicator is set to a/the first codepoint of a/the k-bit indicator, the largest measured value of L1-RSRP/L1-SINR as specified/defined herein in the present disclosure could be specific, corresponding, associated, linked or mapped to the Event-x, when/if the third indicator is set to a/the second codepoint of a/the k-bit indicator, the largest measured value of L1-RSRP/L1-SINR as specified/defined herein in the present disclosure could be specific, associated, linked, corresponding or mapped to the Event-y, when/if the third indicator is set to a/the third codepoint of a/the k-bit indicator, the largest measured value of L1-RSRP/L1-SINR as specified/defined herein in the present disclosure could be specific, associated, linked, corresponding or mapped to the Event-z, and so on, wherein x, y and z belong to {1, . . . , 7}, x*y*z, and x could be smaller (or larger) than y with y smaller (or larger) than z.

According to or following those specified or defined herein in the present disclosure, the third indicator could be present or absent in the UEI report(s) and/or the corresponding UEI report content(s)/quantity(s) as specified or defined herein in the present disclosure—e.g., when/if multiple (more than one) events are enabled, configured or provided by the network, the third indicator could be present in the corresponding L1-RSRP/L1-SINR reporting instance and/or UEI report(s) and/or UEI report content(s)/quantity(s) that comprises the first and/or second report quantity(s); otherwise, i.e., when/if only one (or a single) event is enabled, configured or provided by the network, the third indicator could be absent in/from the corresponding L1-RSRP/L1-SINR reporting instance and/or UEI report(s) and/or UEI report content(s)/quantity(s) that comprises the first and/or second report quantity(s).
As aforementioned, the UEI report(s) and/or the corresponding UEI report content(s)/quantity(s) as specified/defined herein in the present disclosure sent, transmitted or reported in a reporting instance/CSI report could comprise:
only the first indicator,
only the second indicator,
only the third indicator,
both the first and second indicators,
both the first and third indicators,
both the second and third indicators,
all the first, second and third indicators,
   specific to or for the largest measured value of L1-RSRP/L1-SINR according to or following those specified/defined herein in the present disclosure.

According to or following those specified/defined herein in the present disclosure, the NWR to the UE reporting triggered or initiated beam(s)/TCI state(s) switching or update could correspond to or could be in form of: (1) RS or RS resource ID(s)/index(es) corresponding, associated or specific to the current serving beam RS(s) or RS resource(s), (2) TCI state(s)—e.g., in terms/form of the corresponding TCI state ID(s)/index(es) and/or TCI codepoint(s) as specified/defined herein in the present disclosure—associated, corresponding or specific to the current serving beam RS(s) or RS resource(s), and/or (3) a TCI codepoint mapped to the TCI state(s) associated, corresponding or specific to the current serving beam RS(s) or RS resource(s), wherein the UE could report, in the UEI report(s) and/or the corresponding UEI report content(s)/quantity(s), information related to the current serving beam RS(s) or RS resource(s) according to or following those specified or defined herein in the present disclosure; here, the information could comprise or could be in form of or could correspond to: (a) resource indicator(s) such as SSBRI(s) and/or CRI(s) associated, specific or corresponding to the current serving beam RS(s) or RS resource(s), (b) TCI state ID(s)/index(es) of the TCI state(s) associated, specific or corresponding to the current serving beam RS(s) or RS resource(s), (c) index of a TCI codepoint mapped to the TCI state(s) associated, specific or corresponding to the current serving beam RS(s) or RS resource(s), and/or (d) beam metric(s) such as L1-RSRP(s)/L1-SINR(s) specific or corresponding or associated to the current serving beam RS(s) or RS resource(s). In this case, the UE could continue applying the indicated TCI state(s)—i.e., the TCI state(s) associated, specific or corresponding to the current serving beam RS(s) or RS resource(s)
after or starting from the last (or first) symbol/slot/etc. of receiving or reception(s) of the NWR, and/or
after or starting from beam application time (determined or identified according to or based on the BAT setting 1 or the BAT setting2 according to or following those specified/defined herein in the present disclosure) after or starting from the last (or first) symbol/slot/etc. of receiving or reception(s) of the NWR.

In one embodiment, a/the UE could transmit or send to the network one or more indicators to indicate whether the UE could or would like to receive from the network activation/deactivation of TCI state(s) and/or update/switching/indication of TCI state(s), wherein the activation/deactivation of TCI state(s) could be indicated or provided in/by (unified) TCI state(s) activation/deactivation MAC CE command(s), and the update/switching/indication of TCI state(s) could be indicated by/in one or more TCI codepoints indicated or provided or activated in/by e.g. TCI state(s) activation/deactivation MAC CE command(s) and/or TCI field(s) of beam indication DCI(s) of format(s) 1_1/1_2 with or without DL assignment.
In one example, the one or more indicators could correspond to or could be in form of a one-bit indicator; in this case, when/if the one-bit indicator is set to ‘1’ (or ‘0’), the UE could indicate to the network that the UE could or would like to receive from the network the activation/deactivation of TCI state(s) and/or update/switching/indication of TCI state(s); otherwise, i.e., when/if the one-bit indicator is set to ‘0’ (or ‘1’), the UE could indicate to the network that the UE may not or would not like to receive from the network any activation(s)/deactivation(s) of TCI state(s) and/or any update(s)/switching(s)/indication(s) of TCI state(s);
In another example, the one or more indicators could correspond to or could be in form of information related to the current serving beam RS(s) or RS resource(s) according to or following those specified or defined herein in the present disclosure; here, the information could comprise or could be in form of or could correspond to: (a) resource indicator(s) such as SSBRI(s) and/or CRI(s) associated, specific or corresponding to the current serving beam RS(s) or RS resource(s), (b) TCI state ID(s)/index(es) of the TCI state(s) associated, specific or corresponding to the current serving beam RS(s) or RS resource(s), (c) index of a TCI codepoint mapped to the TCI state(s) associated, specific or corresponding to the current serving beam RS(s) or RS resource(s), and/or (d) beam metric(s) such as L1-RSRP(s)/L1-SINR(s) specific or corresponding or associated to the current serving beam RS(s) or RS resource(s).

In this case, the UE could (only) transmit or send, via/by/in (form of) the PN message/trigger transmitted or sent via/by/in/on/over the PUCCH(s)/PUCCH resource(s) of the first UL channel as in Step-1 of Mode A, Mode B and/or Mode C and/or in (part of) the UEI report(s) and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B, the one or more indicators—i.e., the UE may not transmit or indicate or send to the network any first report quantity(s).

According to or following those specified/defined herein in the present disclosure,
In one example, when/if a reported first report quantity is in form of a resource indicator such as a SSBRI or a CRI for or specific to the UE reporting triggered or initiated beam(s)/TCI state(s) switching/update as specified/defined herein in the present disclosure, the TCI state that is indicated or triggered or initiated by the reported first report quantity could be associated, corresponding or specific to the RS or RS resource such as a SSB or a NZP CSI-RS resource corresponding to the resource indicator,
   For example, the TCI state could (or shall) be mapped to a TCI codepoint activated or indicated by/in a/the (unified) TCI state(s) activation/deactivation MAC CE command indicated for the (UE-initiated/event-driven) beam reporting; for this design example, the NWR to the UE reporting triggered or initiated beam(s)/TCI state(s) switching or update could be indicating the TCI state by/via the TCI codepoint, e.g., in/by a/the (unified) TCI state(s) activation/deactivation MAC CE command and/or a/the TCI field of a beam indication DCI of format 1_1/1_2 with or without DL assignment. In this case, the reported first report quantity could be specific, corresponding or associated to TCI codepoint(s) activated or indicated by/in the (unified) TCI state(s) activation/deactivation MAC CE command indicated for the (UE-initiated/event-driven) beam reporting.
   For another example, the TCI state may not be mapped to any TCI codepoint(s) activated or indicated by/in any (unified) TCI state(s) activation/deactivation MAC CE command(s) indicated for the (UE-initiated/event-driven) beam reporting; for this design example, the NWR to the UE reporting triggered or initiated beam(s)/TCI state(s) switching or update could be in form of:
      a one-bit ACK/NACK indicator in response to the reported first report quantity (the resource indicator here) according to or following those specified/defined herein in the present disclosure
      a/the RS or RS resource index/ID specific to or for the RS or RS resource corresponding to the resource indicator
      a bitmap with a corresponding entry/bit position of the bitmap set to ‘1’ (or ‘0’) in response to the reported first report quantity (the resource indicator here) according to or following those specified/defined herein in the present disclosure
      an index value pointing to the resource indicator
      a/the TCI state ID/index corresponding or specific to the TCI state, wherein bitwidth of the TCI state ID/index could be ┌log₂Nt┐, and Nt represents the total number of TCI state ID(s)/index(es)—and therefore the corresponding TCI state(s)—in a/the list/set/pool of TCI state ID(s)/index(es) that is (higher layer) provided or configured to the UE
      a/the TCI state ID/index corresponding or specific to the TCI state, wherein bitwidth of the TCI state ID/index could be ┌log₂T┐, and T represents the total number of TCI state ID(s)/index(es)—and therefore the corresponding TCI state(s)—in a list/set/pool of TCI state ID(s)/index(es) that is (higher layer) provided or configured to the UE for the UE reporting triggered or initiated beam(s)/TCI state(s) switching or update, wherein T could be less than or equal to Tmax, wherein the UE could determine or identify the value of Tmax according to or based on: (i) fixed value(s) in system specification(s) and/or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In this case, the reported first report quantity may not be specific, corresponding or associated to TCI codepoint(s) activated or indicated by/in the (unified) TCI state(s) activation/deactivation MAC CE command indicated for the (UE-initiated/event-driven) beam reporting.
For another example, the TCI state may not be mapped to any TCI codepoint(s) activated or indicated by/in a first (unified) TCI state(s) activation/deactivation MAC CE command indicated for the (UE-initiated/event-driven) beam reporting; for this design example, the NWR to the UE reporting triggered or initiated beam(s)/TCI state(s) switching or update could be indicating the TCI state e.g. in form/terms of the corresponding TCI state ID/index, and/or the TCI state by/via a TCI codepoint in/by a/the TCI field of a beam indication DCI of format 1_1/1_2 with or without DL assignment; in this case:
   for example, the UE could determine or identify the TCI state ID/index in this design example from a set of one or more (candidate) TCI state IDs/indexes indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   for another example, the UE could determine or identify the TCI codepoint in this design example from a set of one or more (candidate) TCI codepoints—each mapped to one or more TCI states in terms/form the corresponding TCI state ID(s)/index(es)—indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   for another example, the UE could determine or identify the RS(s) or RS resource(s) corresponding, specific or associated to the TCI state according to or following those specified or defined herein in the present disclosure from a set of one or more (candidate) RS or RS resource ID(s)/index(es) indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   for another example, the TCI codepoint could be activated or indicated by/in a second (unified) TCI state(s) activation/deactivation MAC CE command indicated for the UE reporting triggered or initiated beam(s)/TCI state(s) switching or update according to or following those specified/defined herein in the present disclosure.

In this case, the reported first report quantity may not be specific, corresponding or associated to TCI codepoint(s) activated or indicated by/in the first (unified) TCI state(s) activation/deactivation MAC CE command indicated for the (UE-initiated/event-driven) beam reporting.
In another example, when/if a reported first report quantity is in form of a TCI state ID/index for or specific to the UE reporting triggered or initiated beam(s)/TCI state(s) switching/update as specified/defined herein in the present disclosure, the TCI state that is indicated or triggered or initiated by the reported first report quantity could be that associated with or having the TCI state ID/index,
   For example, the TCI state could (or shall) be mapped to a TCI codepoint activated or indicated by/in a/the (unified) TCI state(s) activation/deactivation MAC CE command indicated for the (UE-initiated/event-driven) beam reporting; for this design example, the NWR to the UE reporting triggered or initiated beam(s)/TCI state(s) switching or update could be indicating the TCI state by/via the TCI codepoint, e.g., in/by a/the (unified) TCI state(s) activation/deactivation MAC CE command and/or a/the TCI field of a beam indication DCI of format 1_1/1_2 with or without DL assignment. In this case, the reported first report quantity could be specific, corresponding or associated to TCI codepoint(s) activated or indicated by/in the (unified) TCI state(s) activation/deactivation MAC CE command indicated for the (UE-initiated/event-driven) beam reporting.
   For another example, the TCI state may not be mapped to any TCI codepoint(s) activated or indicated by/in any (unified) TCI state(s) activation/deactivation MAC CE command(s) indicated for the (UE-initiated/event-driven) beam reporting; for this design example, the NWR to the UE reporting triggered or initiated beam(s)/TCI state(s) switching or update could be in form of:
      a one-bit ACK/NACK indicator in response to the reported first report quantity (the TCI state ID/index here) according to or following those specified/defined herein in the present disclosure
      a/the RS or RS resource index/ID specific to or for the RS or RS resource associated, linked, corresponding, mapped or specific to the TCI state according to or following those specified/defined herein in the present disclosure
      a bitmap with a corresponding entry/bit position of the bitmap set to ‘1’ (or ‘0’) in response to the reported first report quantity (the TCI state ID/index here) according to or following those specified/defined herein in the present disclosure
      an index value pointing to the TCI state ID/index
      a/the TCI state ID/index corresponding or specific to the TCI state, wherein bitwidth of the TCI state ID/index could be ┌log₂Nt┐, and Nt represents the total number of TCI state ID(s)/index(es)—and therefore the corresponding TCI state(s)—in a/the list/set/pool of TCI state ID(s)/index(es) that is (higher layer) provided or configured to the UE
      a/the TCI state ID/index corresponding or specific to the TCI state, wherein bitwidth of the TCI state ID/index could be ┌log₂T┐, and T represents the total number of TCI state ID(s)/index(es)—and therefore the corresponding TCI state(s)—in a list/set/pool of TCI state ID(s)/index(es) that is (higher layer) provided or configured to the UE for the UE reporting triggered or initiated beam(s)/TCI state(s) switching or update, wherein T could be less than or equal to Tmax, wherein the UE could determine or identify the value of Tmax according to or based on: (i) fixed value(s) in system specification(s) and/or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In this case, the reported first report quantity may not be specific, corresponding or associated to TCI codepoint(s) activated or indicated by/in the (unified) TCI state(s) activation/deactivation MAC CE command indicated for the (UE-initiated/event-driven) beam reporting.
For another example, the TCI state may not be mapped to any TCI codepoint(s) activated or indicated by/in a first (unified) TCI state(s) activation/deactivation MAC CE command indicated for the (UE-initiated/event-driven) beam reporting; for this design example, the NWR to the UE reporting triggered or initiated beam(s)/TCI state(s) switching or update could be indicating the TCI state e.g. in form/terms of the corresponding TCI state ID/index, and/or the TCI state by/via a TCI codepoint in/by a/the TCI field of a beam indication DCI of format 1_1/1_2 with or without DL assignment; in this case:
   for example, the UE could determine or identify the TCI state ID/index in this design example from a set of one or more (candidate) TCI state IDs/indexes indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   for another example, the UE could determine or identify the TCI codepoint in this design example from a set of one or more (candidate) TCI codepoints—each mapped to one or more TCI states in terms/form the corresponding TCI state ID(s)/index(es)—indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   for another example, the UE could determine or identify the RS(s) or RS resource(s) corresponding, specific or associated to the TCI state according to or following those specified or defined herein in the present disclosure from a set of one or more (candidate) RS or RS resource ID(s)/index(es) indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   for another example, the TCI codepoint could be activated or indicated by/in a second (unified) TCI state(s) activation/deactivation MAC CE command indicated for the UE reporting triggered or initiated beam(s)/TCI state(s) switching or update according to or following those specified/defined herein in the present disclosure.

In this case, the reported first report quantity may not be specific, corresponding or associated to TCI codepoint(s) activated or indicated by/in the (unified) TCI state(s) activation/deactivation MAC CE command indicated for the (UE-initiated/event-driven) beam reporting.
In another example, when/if a reported first report quantity is in form of a TCI codepoint index for or specific to the UE reporting triggered or initiated beam(s)/TCI state(s) switching/update as specified/defined herein in the present disclosure, the TCI state that is indicated or triggered or initiated by the reported first report quantity could be that mapped to the TCI codepoint,
   For example, the TCI codepoint could be activated or indicated by/in a/the (unified) TCI state(s) activation/deactivation MAC CE command indicated for the (UE-initiated/event-driven) beam reporting; for this design example, the NWR to the UE reporting triggered or initiated beam(s)/TCI state(s) switching or update could be indicating the TCI codepoint (hence the TCI state mapped to the TCI codepoint), e.g., in/by a/the (unified) TCI state(s) activation/deactivation MAC CE command and/or a/the TCI field of a beam indication DCI of format 1_1/1_2 with or without DL assignment. In this case, the reported first report quantity could be specific, corresponding or associated to TCI codepoint(s) activated or indicated by/in the (unified) TCI state(s) activation/deactivation MAC CE command indicated for the (UE-initiated/event-driven) beam reporting.
   For another example, the TCI codepoint may not be activated or indicated by/in any (unified) TCI state(s) activation/deactivation MAC CE command(s) indicated for the (UE-initiated/event-driven) beam reporting; for this design example, the NWR to the UE reporting triggered or initiated beam(s)/TCI state(s) switching or update could be in form of:
      a one-bit ACK/NACK indicator in response to the reported first report quantity (the TCI codepoint index here) according to or following those specified/defined herein in the present disclosure
      a/the RS or RS resource index/ID specific to or for the RS or RS resource associated, linked, corresponding, mapped or specific to the TCI state that is mapped to the TCI codepoint according to or following those specified/defined herein in the present disclosure
      a bitmap with a corresponding entry/bit position of the bitmap set to ‘1’ (or ‘0’) in response to the reported first report quantity (the TCI codepoint index here) according to or following those specified/defined herein in the present disclosure
      an index value pointing to the TCI codepoint index
      a/the TCI state ID/index corresponding or specific to the TCI state that is mapped to the TCI codepoint, wherein bitwidth of the TCI state ID/index could be ┌log₂Nt┐, and Nt represents the total number of TCI state ID(s)/index(es)—and therefore the corresponding TCI state(s)—in a/the list/set/pool of TCI state ID(s)/index(es) that is (higher layer) provided or configured to the UE
      a/the TCI state ID/index corresponding or specific to the TCI state, wherein bitwidth of the TCI state ID/index could be ┌log₂T┐, and T represents the total number of TCI state ID(s)/index(es)—and therefore the corresponding TCI state(s)—in a list/set/pool of TCI state ID(s)/index(es) that is (higher layer) provided or configured to the UE for the UE reporting triggered or initiated beam(s)/TCI state(s) switching or update, wherein T could be less than or equal to Tmax, wherein the UE could determine or identify the value of Tmax according to or based on: (i) fixed value(s) in system specification(s) and/or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In this case, the reported first report quantity may not be specific, corresponding or associated to TCI codepoint(s) activated or indicated by/in the (unified) TCI state(s) activation/deactivation MAC CE command indicated for the (UE-initiated/event-driven) beam reporting.
For another example, the TCI codepoint may not be activated or indicated by/in a first (unified) TCI state(s) activation/deactivation MAC CE command indicated for the (UE-initiated/event-driven) beam reporting; for this design example, the NWR to the UE reporting triggered or initiated beam(s)/TCI state(s) switching or update could be indicating the TCI state e.g. in form/terms of the corresponding TCI state ID/index that is mapped to the TCI codepoint, and/or the TCI codepoint (hence the TCI state mapped to the TCI codepoint) in/by a/the TCI field of a beam indication DCI of format 1_1/1_2 with or without DL assignment; in this case:
   for example, the UE could determine or identify the TCI state ID/index in this design example from a set of one or more (candidate) TCI state IDs/indexes indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   For another example, the UE could determine or identify the TCI codepoint in this design example from a set of one or more (candidate) TCI codepoints—each mapped to one or more TCI states in terms/form the corresponding TCI state ID(s)/index(es)—indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   for another example, the UE could determine or identify the RS(s) or RS resource(s) corresponding, specific or associated to the TCI state according to or following those specified or defined herein in the present disclosure from a set of one or more (candidate) RS or RS resource ID(s)/index(es) indicated, transmitted or sent from the UE to the network, e.g., in a/the reporting instance/CSI report that carries or conveys the UEI report(s) and/or the corresponding UEI report content(s)/quantity(s) transmitted or sent over/in/by/on one or more PUSCHs/PUSCH resources of the second UL channel as in Step-3 of Mode A and/or Mode C and/or Step-2 of Mode B according to or following those specified or defined herein in the present disclosure, as report quantity(s) for UE reporting triggered or initiated beam(s)/TCI state(s) activation/deactivation;
   for another example, the TCI codepoint could be activated or indicated by/in a second (unified) TCI state(s) activation/deactivation MAC CE command indicated for the UE reporting triggered or initiated beam(s)/TCI state(s) switching or update according to or following those specified/defined herein in the present disclosure.

In this case, the reported first report quantity may not be specific, corresponding or associated to TCI codepoint(s) activated or indicated by/in the first (unified) TCI state(s) activation/deactivation MAC CE command indicated for the (UE-initiated/event-driven) beam reporting.

Here, the second (unified) TCI state(s) activation/deactivation MAC CE command (hence the TCI codepoint(s) indicated/activated therein), if indicated or provided to the UE, could be different or separate from the first (unified) TCI state(s) activation/deactivation MAC CE command (hence the TCI codepoint(s) indicated/activated therein), if indicated or provided to the UE.

According to or following those specified or defined herein in the present disclosure, the UE could determine or identify whether to report a first report quantity specific to or for the UE reporting initiated or triggered beam(s)/TCI state(s) switching or update specific, corresponding or associated to TCI codepoint(s) activated or indicated by/in the (unified) TCI state(s) activation/deactivation MAC CE command indicated for the (UE-initiated/event-triggered) beam reporting according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In one example, the UE could be provided or configured by the network, e.g., via/in/by higher layer parameter(s)/signaling(s) CSI-ReportConfig and/or UEI-ReportConfig that provides or configures necessary information and/or setting(s) for the UE-initiated/event-driven beam operations including beam reporting and/or beam switching, a higher layer parameter reportActivatedBeam. In this case, when/if the higher layer parameter reportActivatedBeam is configured or provided, and/or set to ‘enabled’, the UE could report a first report quantity specific to or for the UE reporting initiated or triggered beam(s)/TCI state(s) switching or update specific, corresponding or associated to TCI codepoint(s) activated or indicated by/in the (unified) TCI state(s) activation/deactivation MAC CE command indicated for the (UE-initiated/event-triggered) beam reporting; otherwise, i.e., when/if the higher layer parameter reportActivatedBeam is not configured or provided, and/or is configured or provided but set to ‘disabled’, the UE may not report a first report quantity specific to or for the UE reporting initiated or triggered beam(s)/TCI state(s) switching or update specific, corresponding or associated to any TCI codepoint(s) activated or indicated by/in any (unified) TCI state(s) activation/deactivation MAC CE command(s) indicated for the (UE-initiated/event-triggered) beam reporting.
In another example, the UE could be provided or configured by the network, e.g., via/in/by higher layer parameter(s)/signaling(s) CSI-ReportConfig and/or UEI-ReportConfig that provides or configures necessary information and/or setting(s) for the UE-initiated/event-driven beam operations including beam reporting and/or beam switching, a higher layer parameter reportQuantityType. In this case, when/if the higher layer parameter reportQuantityType is set to ‘activated’, the UE could report a first report quantity specific to or for the UE reporting initiated or triggered beam(s)/TCI state(s) switching or update specific, corresponding or associated to TCI codepoint(s) activated or indicated by/in the (unified) TCI state(s) activation/deactivation MAC CE command indicated for the (UE-initiated/event-triggered) beam reporting; otherwise, i.e., when/if the higher layer parameter reportQuantityType is set to ‘nonActivated’, the UE may not report a first report quantity specific to or for the UE reporting initiated or triggered beam(s)/TCI state(s) switching or update specific, corresponding or associated to any TCI codepoint(s) activated or indicated by/in any (unified) TCI state(s) activation/deactivation MAC CE command(s) indicated for the (UE-initiated/event-triggered) beam reporting.
In another example, the UE could transmit, send or indicate to the network, e.g., via/by/in (form of) the PN message/trigger transmitted or sent via/by/in/on/over the PUCCH(s)/PUCCH resource(s) of the first UL channel as in Step-1 of Mode A, Mode B and/or Mode C, a one-bit indicator. In this case, when/if the one-bit indicator is set to ‘1’ (or ‘0’), (all of) the first report quantity(s) reported in (part of) the UEI report(s) and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B specific to or for the UE reporting initiated or triggered beam(s)/TCI state(s) switching or update could be specific, corresponding or associated to TCI codepoint(s) activated or indicated by/in the (unified) TCI state(s) activation/deactivation MAC CE command indicated for the (UE-initiated/event-triggered) beam reporting; otherwise, i.e., when/if the one-bit indicator is set to ‘0’ (or ‘1’), (all of) the first report quantity(s) reported in (part of) the UEI report(s) and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B specific to or for the UE reporting initiated or triggered beam(s)/TCI state(s) switching or update may not be specific, corresponding or associated to TCI codepoint(s) activated or indicated by/in the (unified) TCI state(s) activation/deactivation MAC CE command indicated for the (UE-initiated/event-triggered) beam reporting.
In another example, the UE could transmit, send or indicate to the network, e.g., via/by/in (form of) the PN message/trigger transmitted or sent via/by/in/on/over the PUCCH(s)/PUCCH resource(s) of the first UL channel as in Step-1 of Mode A, Mode B and/or Mode C and/or in (part of) the UEI report(s) and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B, one or more one-bit indicators each associated to a first report quantity reported in (part of) the UEI report(s) and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B. For this design example, when/if a one-bit indicator is set to ‘1’ (or ‘0’), the corresponding or associated first report quantity specific to or for the UE reporting initiated or triggered beam(s)/TCI state(s) switching or update could be specific, corresponding or associated to TCI codepoint(s) activated or indicated by/in the (unified) TCI state(s) activation/deactivation MAC CE command indicated for the (UE-initiated/event-triggered) beam reporting; otherwise, i.e., when/if a one-bit indicator is set to ‘0’ (or ‘1’), the corresponding or associated first report quantity specific to or for the UE reporting initiated or triggered beam(s)/TCI state(s) switching or update may not be specific, corresponding or associated to TCI codepoint(s) activated or indicated by/in the (unified) TCI state(s) activation/deactivation MAC CE command indicated for the (UE-initiated/event-triggered) beam reporting.
In another example, the UE could transmit, send or indicate to the network, e.g., via/by/in (form of) the PN message/trigger transmitted or sent via/by/in/on/over the PUCCH(s)/PUCCH resource(s) of the first UL channel as in Step-1 of Mode A, Mode B and/or Mode C and/or in (part of) the UEI report(s) and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B, a bitmap with each entry/bit position of the bitmap associated to a first report quantity reported in (part of) the UEI report(s) and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B. For this design example, when/if an entry/bit position of the bitmap is set to ‘1’ (or ‘0’), the corresponding or associated first report quantity specific to or for the UE reporting initiated or triggered beam(s)/TCI state(s) switching or update could be specific, corresponding or associated to TCI codepoint(s) activated or indicated by/in the (unified) TCI state(s) activation/deactivation MAC CE command indicated for the (UE-initiated/event-triggered) beam reporting; otherwise, i.e., when/if an entry/bit position of the bitmap is set to ‘0’ (or ‘1’), the corresponding or associated first report quantity specific to or for the UE reporting initiated or triggered beam(s)/TCI state(s) switching or update may not be specific, corresponding or associated to TCI codepoint(s) activated or indicated by/in the (unified) TCI state(s) activation/deactivation MAC CE command indicated for the (UE-initiated/event-triggered) beam reporting.

The corresponding UE's capability(s) or capability signaling(s) could comprise component(s) indicating whether the UE could support reporting the first report quantity(s) not specific, corresponding or associated to TCI codepoint(s) activated or indicated by/in the (unified) TCI state(s) activation/deactivation MAC CE command indicated for the (UE-initiated/event-triggered) beam reporting.

According to or following those specified or defined in the present disclosure, a NWR to the UE reporting triggered or initiated beam(s)/TCI state(s) switching or update could be in form of a RS or RS resource ID/index, wherein the RS or RS resource corresponding or specific to the RS or RS resource ID/index could be associated, specific or corresponding to a/the TCI state according to or following those specified herein in the present disclosure initiated or triggered or indicated by the UE for TCI state(s)/beam(s) switching or update—i.e., the UE reporting triggered or initiated TCI state(s)/beam(s) switching or update. Here, the bitwidth of the RS or RS resource ID/index—hence the bitwidth of the DCI codepoint used or applied for indicating the RS or RS resource ID/index when/if the NWR is indicated in a DCI according to or following those specified or defined herein in the present disclosure—could be determined or computed or calculated or identified as ┌log₂R┐, wherein
in one example, R could represent or denote the total number of candidate/new beam RS(s) or RS resource(s)—e.g. in form/terms of RS/resource ID(s)/index(es)—in a/the set/list/pool of candidate/new beam RS(s) or RS resource(s) or RS/resource ID(s)/indexes higher layer provided or configured to the UE according to or following those specified or defined herein in the present disclosure;
in another example, R could represent or denote the total number of (1) candidate/new beam RS(s) or RS resource(s)—e.g. in form/terms of the corresponding RS/resource ID(s)/index(es) and (2) current serving beam RS(s) or RS resource(s)—e.g. in form/terms of the corresponding RS/resource ID(s)/index(es), wherein the candidate/new beam RS or RS resource ID(s)/index(es) and the current serving beam RS or RS resource ID(s)/index(es) could be provided or configured in a/the (same) set/list/pool of RS(s) or RS resource(s) or RS/resource ID(s)/index(es) higher layer provided or configured to the UE according to or following those specified or defined herein in the present disclosure;
in another example, R could represent or denote the total number of RS(s) or RS resource(s)—e.g. in form/terms of the corresponding RS/resource ID(s)/index(es)—provided or configured in a/the (same) set/list/pool of RS(s) or RS resource(s) or RS/resource ID(s)/index(es) higher layer provided or configured to the UE according to or following those specified or defined herein in the present disclosure for the UE reporting triggered or initiated beam(s)/TCI state(s) switching or update.

Here, R could be less than or equal to Rmax, wherein the UE could determine or identify the value of Rmax according to or based on: (i) fixed value(s) in system specification(s) and/or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

According to or following those specified or defined in the present disclosure, a NWR to the UE reporting triggered or initiated beam(s)/TCI state(s) switching or update could be in form of a TCI state ID/index, wherein the RS or RS resource corresponding or specific to the RS or RS resource ID/index could be associated, specific or corresponding to a/the TCI state according to or following those specified herein in the present disclosure initiated or triggered or indicated by the UE for TCI state(s)/beam(s) switching or update—i.e., the UE reporting triggered or initiated TCI state(s)/beam(s) switching or update. Here, the bitwidth of the RS or RS resource ID/index—hence the bitwidth of the DCI codepoint used or applied for indicating the RS or RS resource ID/index when/if the NWR is indicated in a DCI according to or following those specified or defined herein in the present disclosure—could be determined or computed or calculated or identified as ┌log₂R┐, wherein
in one example, R could represent or denote the total number of candidate/new beam RS(s) or RS resource(s)—e.g. in form/terms of RS/resource ID(s)/index(es)—in a/the set/list/pool of candidate/new beam RS(s) or RS resource(s) or RS/resource ID(s)/indexes higher layer provided or configured to the UE according to or following those specified or defined herein in the present disclosure;
in another example, R could represent or denote the total number of (1) candidate/new beam RS(s) or RS resource(s)—e.g. in form/terms of the corresponding RS/resource ID(s)/index(es) and (2) current serving beam RS(s) or RS resource(s)—e.g. in form/terms of the corresponding RS/resource ID(s)/index(es), wherein the candidate/new beam RS or RS resource ID(s)/index(es) and the current serving beam RS or RS resource ID(s)/index(es) could be provided or configured in a/the (same) set/list/pool of RS(s) or RS resource(s) or RS/resource ID(s)/index(es) higher layer provided or configured to the UE according to or following those specified or defined herein in the present disclosure;
in another example, R could represent or denote the total number of RS(s) or RS resource(s)—e.g. in form/terms of the corresponding RS/resource ID(s)/index(es)—provided or configured in a/the (same) set/list/pool of RS(s) or RS resource(s) or RS/resource ID(s)/index(es) higher layer provided or configured to the UE according to or following those specified or defined herein in the present disclosure for the UE reporting triggered or initiated beam(s)/TCI state(s) switching or update.

Here, R could be less than or equal to Rmax, wherein the UE could determine or identify the value of Rmax according to or based on: (i) fixed value(s) in system specification(s) and/or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

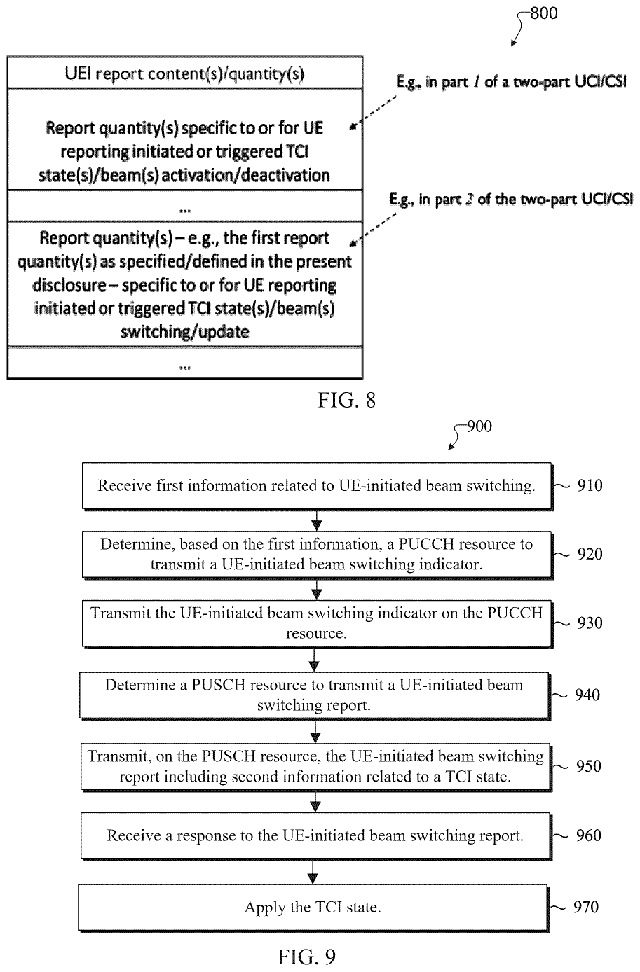

FIG. 8 illustrates an example of UE initiated report contents 800 according to embodiments of the present disclosure. This example is for illustration only and other embodiments can be used without departing from the scope of the present disclosure.

According to or following those specified or defined herein in the present disclosure, the UEI report(s)—or the corresponding reporting instance/CSI report—and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B could comprise two parts. Furthermore, the first report quantity(s) specific to or for the UE reporting triggered or initiated TCI state(s)/beam(s) switching or update and the report quantity(s) specific to or for the UE reporting triggered or initiated TCI state(s)/beam(s) activation/deactivation could be reported in the (same) UEI report(s)—or the corresponding reporting instance/CSI report—and/or the corresponding UEI report content(s)/quantity(s). In this case, part 1 of the two-part UCI/CSI could comprise one or more of the report quantity(s) specific to or for the UE reporting triggered or initiated TCI state(s)/beam(s) activation/deactivation, and part 2 of the two-part UCI/CSI could comprise one or more of the first report quantity(s). One conceptual example of the UEI report content(s)/quantity(s) as specified/defined herein in the present disclosure is provided in FIG. 7.

According to or following those specified or defined herein in the present disclosure, the UE could transmit, send or indicate to the network, e.g., via/by/in (form of) the PN message/trigger transmitted or sent via/by/in/on/over the PUCCH(s)/PUCCH resource(s) of the first UL channel as in Step-1 of Mode A, Mode B and/or Mode C and/or in (part of) the UEI report(s) and/or the corresponding UEI report content(s)/quantity(s) transmitted or sent via/by/in/on/over the PUSCH(s)/PUSCH resource(s) of the second UL channel as in Step-3 of Mode A and/or Mode C and/or Step-2 of Mode B, one or more indicators to indicate to the network that at least one of report quantity(s) in (part of) the UEI report(s) and/or the corresponding UEI report content(s)/quantity(s) could be for the UE reporting triggered or initiated beam(s)/TCI state(s) activation/deactivation and/or beam(s)/TCI state(s) switching/update.
In one example, the one or more indicators here could correspond to or could be in form of a one-bit indicators: when/if the one-bit indicator is set to ‘1’ (or ‘0’), the UE could indicate to the network that at least one of the report quantity(s) in (part of) the UEI report(s) and/or the corresponding UEI report content(s)/quantity(s) could be for the UE reporting triggered or initiated beam(s)/TCI state(s) activation/deactivation; otherwise, i.e., when/if the one-bit indicator is set to ‘0’ (or ‘1’), the UE could indicate to the network that none of the report quantity(s) in (part of) the UEI report(s) and/or the corresponding UEI report content(s)/quantity(s) could be for the UE reporting triggered or initiated beam(s)/TCI state(s) activation/deactivation.
In another example, the one or more indicators here could correspond to or could be in form of a one-bit indicators: when/if the one-bit indicator is set to ‘1’ (or ‘0’), the UE could indicate to the network that at least one of the report quantity(s) in (part of) the UEI report(s) and/or the corresponding UEI report content(s)/quantity(s) could be for the UE reporting triggered or initiated beam(s)/TCI state(s) switching/update; otherwise, i.e., when/if the one-bit indicator is set to ‘0’ (or ‘1’), the UE could indicate to the network that none of the report quantity(s) in (part of) the UEI report(s) and/or the corresponding UEI report content(s)/quantity(s) could be for the UE reporting triggered or initiated beam(s)/TCI state(s) switching/update.
In another example, the one or more indicators here could correspond to or could be in form of a two-bit indicators: when/if the two-bit indicator is set to ‘00’ (or ‘01’ or ‘10’ or ‘11’), the UE could indicate to the network that at least one of the report quantity(s) in (part of) the UEI report(s) and/or the corresponding UEI report content(s)/quantity(s) could be for the UE reporting triggered or initiated beam(s)/TCI state(s) activation/deactivation, when/if the two-bit indicator is set to ‘01’ (or ‘00’ or ‘10’ or ‘11’), the UE could indicate to the network that none of the report quantity(s) in (part of) the UEI report(s) and/or the corresponding UEI report content(s)/quantity(s) could be for the UE reporting triggered or initiated beam(s)/TCI state(s) activation/deactivation, when/if the two-bit indicator is set to ‘10’ (or ‘00’ or ‘01’ or ‘11’), the UE could indicate to the network that at least one of the report quantity(s) in (part of) the UEI report(s) and/or the corresponding UEI report content(s)/quantity(s) could be for the UE reporting triggered or initiated beam(s)/TCI state(s) switching/update, and/or when/if the two-bit indicator is set to ‘11’ (or ‘00’ or ‘01’ or ‘10’), the UE could indicate to the network that none of the report quantity(s) in (part of) the UEI report(s) and/or the corresponding UEI report content(s)/quantity(s) could be for the UE reporting triggered or initiated beam(s)/TCI state(s) switching/update.

According to or following those specified/defined herein in the present disclosure, the UEI report(s) and/or the corresponding UEI report content(s)/quantity(s) as specified/defined herein in the present disclosure transmitted or sent via/by/in/on/over one or more (DG and/or CG Type1/2) PUSCH resources of the second UL channel as in Step-3 of Mode A and/or Mode C and/or Step-2 of Mode B could comprise:
Format-1: only first report quantity(s) as specified/defined herein in the present disclosure for the UE reporting triggered or initiated beam(s)/TCI state(s) switching or update
   Format-1a: only one first report quantity as specified/defined herein in the present disclosure for the UE reporting triggered or initiated beam(s)/TCI state(s) switching or update
   Format-1b: multiple (i.e., more than one) first report quantities as specified/defined herein in the present disclosure for the UE reporting triggered or initiated beam(s)/TCI state(s) switching or update
Format-2: first report quantity(s) as specified/defined herein in the present disclosure for the UE reporting triggered or initiated beam(s)/TCI state(s) switching or update and one or more second report quantities
   Format-2a: only one first report quantity as specified/defined herein in the present disclosure for the UE reporting triggered or initiated beam(s)/TCI state(s) switching or update and the one more second report quantities
   Format-2b: multiple (i.e., more than one) first report quantities as specified/defined herein in the present disclosure for the UE reporting triggered or initiated beam(s)/TCI state(s) switching or update and the one or more second report quantities

Here, the one or more second report quantities may or may not comprise report quantity(s)—e.g., in terms/form of resource indicator(s) such as SSBRI(s)/CRI(s), TCI state ID(s)/index(es) and/or the corresponding beam metric(s) such as L1-RSRP(s)/L1-SINR(s)—related to the current (serving) beam RS(s) or RS resource(s) depending/based on or according to network's configuration(s) e.g. via higher layer RRC signaling(s)/parameter(s). This is, presence or absence of the report quantity(s)—e.g., in terms/form of resource indicator(s) such as SSBRI(s)/CRI(s), TCI state ID(s)/index(es) and/or the corresponding beam metric(s) such as L1-RSRP(s)/L1-SINR(s)—related to the current (serving) beam RS(s) or RS resource(s) in (part of) the one or more second report quantities (or in general, the UEI report(s) and/or the corresponding UEI report content(s)/quantity(s)) could be enabled (or disabled) and/or configured/provided by a higher layer RRC signaling/parameter e.g. provided or configured in higher layer parameter(s)/signaling(s) CSI-ReportConfig and/or UEI-ReportConfig that provides or configures necessary information and/or setting(s) for the UE-initiated/event-driven beam operations including beam reporting and/or switching/update according to or following those specified/defined herein in the present disclosure.

The UE could determine or identify which one or more of Format-1a, Format-1b, Format-2a and Format-2b to use or apply for the UE reporting triggered or initiated beam(s)/TCI state(s) switching or update according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
For example, the UE could be provided or configured by the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam operations including beam reporting and/or switching/update, a higher layer parameter e.g. denoted by beamSwitchingOnly. In this case, when/if the higher layer parameter beamSwitchingOnly is configured/provided and/or set to ‘enabled’, the UE could use or apply Format-1 (i.e., Format-1a and/or Format-1b) for the UE reporting triggered or initiated beam(s)/TCI state(s) switching or update. Otherwise, e.g., when/if the higher layer parameter beamSwitchingOnly is not configured/provided and/or is configured/provided but set to ‘disabled’, the UE could use or apply Format-1 (i.e., Format-1a and/or Format-1b) and/or Format-2 (i.e., Format-2a and/or Format-2b) for the UE reporting triggered or initiated beam(s)/TCI state(s) switching or update.
For another example, the UE could be provided or configured by the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam operations including beam reporting and/or switching/update, a higher layer parameter e.g. denoted by reportQuantityType. In this case, when/if the higher layer parameter reportQuantityType is set to ‘beamSwitchingOnly’, the UE could use or apply Format-1 (i.e., Format-1a and/or Format-1b) for the UE reporting triggered or initiated beam(s)/TCI state(s) switching or update, when/if the higher layer parameter reportQuantityType is set to ‘bothBeamSwitchingReporting’, the UE could use or apply Format-2 (i.e., Format-2a and/or Format-2b) for the UE reporting triggered or initiated beam(s)/TCI state(s) switching or update, and/or when/if the higher layer parameter reportQuantityType is set to ‘upToUE’, the UE could use or apply Format-1 (i.e., Format-1a and/or Format-1b) and/or Format-2 (i.e., Format-2a and/or Format-2b) for the UE reporting triggered or initiated beam(s)/TCI state(s) switching or update. Optionally, when/if the higher layer parameter reportQuantityType is not provided or configured, the UE could use or apply Format-1 (i.e., Format-1a and/or Format-1b) and/or Format-2 (i.e., Format-2a and/or Format-2b) for the UE reporting triggered or initiated beam(s)/TCI state(s) switching or update.
For another example, when/if L1 as specified/defined herein in the present disclosure is set to 0 (i.e., L1=0), the UE could use or apply Format-1 (i.e., Format-1a and/or Format-1b) for the UE reporting triggered or initiated beam(s)/TCI state(s) switching or update, and/or when/if L1 is set to a value greater than or equal to 1 (i.e., L1≥1), the UE could use or apply Format-2 (i.e., Format-2a and/or Format-2b) for the UE reporting triggered or initiated beam(s)/TCI state(s) switching or update. Optionally, when/if L1 is not provided or configured or is absent, the UE could use or apply Format-1 (i.e., Format-1a and/or Format-1b) and/or Format-2 (i.e., Format-2a and/or Format-2b) for the UE reporting triggered or initiated beam(s)/TCI state(s) switching or update.
For example, the UE could be provided or configured by the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam operations including beam reporting and/or switching/update, a higher layer parameter e.g. denoted by onlyOneBeamForSwitching. In this case, when/if the higher layer parameter onlyOneBeamForSwitching is configured/provided and/or set to ‘enabled’, the UE could use or apply Format-1a and/or Format-2a for the UE reporting triggered or initiated beam(s)/TCI state(s) switching or update. Otherwise, e.g., when/if the higher layer parameter onlyOneBeamForSwitching is not configured/provided and/or is configured/provided but set to ‘disabled’, the UE could use or apply Format-1 (i.e., Format-1a and/or Format-1b) and/or Format-2 (i.e., Format-2a and/or Format-2b) for the UE reporting triggered or initiated beam(s)/TCI state(s) switching or update.
For another example, the UE could be provided or configured by the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam operations including beam reporting and/or switching/update, a higher layer parameter e.g. denoted by numBeamForSwitching. In this case, when/if the higher layer parameter numBeamForSwitching is set to ‘single’, the UE could use or apply Format-1a and/or Format-2a for the UE reporting triggered or initiated beam(s)/TCI state(s) switching or update, when/if the higher layer parameter numBeamForSwitching is set to ‘multiple’, the UE could use or apply Format-1b and/or Format-2b for the UE reporting triggered or initiated beam(s)/TCI state(s) switching or update, and/or when/if the higher layer parameter numBeamForSwitching is set to ‘onOrMore’, the UE could use or apply Format-1 (i.e., Format-1a and/or Format-1b) and/or Format-2 (i.e., Format-2a and/or Format-2b) for the UE reporting triggered or initiated beam(s)/TCI state(s) switching or update. Optionally, when/if the higher layer parameter numBeamForSwitching is not provided or configured, the UE could use or apply Format-1 (i.e., Format-1a and/or Format-1b) and/or Format-2 (i.e., Format-2a and/or Format-2b) for the UE reporting triggered or initiated beam(s)/TCI state(s) switching or update.
For another example, when/if K1 as specified/defined herein in the present disclosure is set to 1 (i.e., K1=1), the UE could use or apply Format-1a and/or Format-2a for the UE reporting triggered or initiated beam(s)/TCI state(s) switching or update, and/or when/if K1 is set to a value greater than or equal to 2 (i.e., K1≥2), the UE could use or apply Format-1b and/or Format-2b for the UE reporting triggered or initiated beam(s)/TCI state(s) switching or update. Optionally, when/if K1 is not provided or configured or is absent, the UE could use or apply Format-1 (i.e., Format-1a and/or Format-1b) and/or Format-2 (i.e., Format-2a and/or Format-2b) for the UE reporting triggered or initiated beam(s)/TCI state(s) switching or update.

According to or following those specified/defined herein in the present disclosure, the UE could send or transmit to the network one or more indicators to indicate which of the report quantity(s) in the UEI report(s) and/or the corresponding UEI report content(s)/quantity(s) could correspond to the first report quantity(s) specific to or for the UE reporting triggered or initiated TCI state(s)/beam(s) switching or update. The one or more indicators here could also indicate which of the report quantity(s) in the UEI report(s) and/or the corresponding UEI report content(s)/quantity(s) could satisfy condition(s) of the corresponding event(s) or not.

According to or following those specified or defined herein in the present disclosure, a UE could be provided or configured by the network via/by/in higher layer RRC signaling(s)/parameter(s) such as CSI-ReportConfig and/or UEI-ReportConfig that provides or configures necessary information and/or setting(s) for the UE-initiated/event-driven beam operations including beam reporting and/or switching as specified/defined herein in the present disclosure, a list/set/pool of candidate/new beam RS(s) or RS resource(s)—in terms/form the corresponding RS/RS resource ID(s) or index(es)—for event(s) evaluation(s), beam(s) measurement/reporting, beam(s) activation/deactivation and/or beam(s) switching/update. In this case, the first (or second) report quantity(s) could be associated, corresponding, linked, mapped or specific to one or more candidate/new beam RSs or RS resources as specified/defined herein in the present disclosure. For instance, when/if the first (or second) report quantity(s) is in form of resource indicator(s) such as SSBRI(s) and/or CRI(s), it could select RS(s) or RS resource(s) from the list/set/pool of candidate/new beam RS(s) or RS resource(s) specified/defined herein in the present disclosure. Furthermore, the candidate/new beam RS(s) or RS resource(s) associated, corresponding, linked, mapped or specific to the first report quantity(s)—e.g., the candidate/new beam RS(s) or RS resource(s) selected by the first report quantity(s) in form of resource indicator(s) such as SSBRI(s) and/or CRI(s) from the list/set/pool of candidate/new beam RS(s) or RS resource(s)—could satisfy condition(s) of the corresponding event(s), or equivalently, the UE could determine the corresponding event(s) according to those specified/defined herein in the present disclosure based on at least the candidate/new beam RS(s) or RS resource(s) associated, corresponding, linked, mapped or specific to the first report quantity(s)—e.g., the candidate/new beam RS(s) or RS resource(s) selected by the first report quantity(s) in form of resource indicator(s) such as SSBRI(s) and/or CRI(s) from the list/set/pool of candidate/new beam RS(s) or RS resource(s).

According to or following those specified or defined herein in the present disclosure, the first report quantity(s) could be associated, corresponding, linked, mapped or specific to one or more candidate/new beam RSs or RS resources for TCI state(s)/beam(s) switching or update (e.g., in terms of event(s) evaluation(s) and/or corresponding beam(s) reporting) as specified/defined herein in the present disclosure. For instance, when/if the first report quantity(s) is in form of resource indicator(s) such as SSBRI(s) and/or CRI(s), it could select RS(s) or RS resource(s) from the (set of) candidate/new beam RS(s) or RS resource(s) for TCI state(s)/beam(s) switching or update specified/defined herein in the present disclosure. Furthermore, the candidate/new beam RS(s) or RS resource(s) associated, corresponding, linked, mapped or specific to the first report quantity(s)—e.g., the candidate/new beam RS(s) or RS resource(s) selected by the first report quantity(s) in form of resource indicator(s) such as SSBRI(s) and/or CRI(s) from the set of candidate/new beam RS(s) or RS resource(s) for TCI state(s)/beam(s) switching/update—could satisfy condition(s) of the corresponding event(s), or equivalently, the UE could determine the corresponding event(s) according to those specified/defined herein in the present disclosure based on at least the candidate/new beam RS(s) or RS resource(s) associated, corresponding, linked, mapped or specific to the first report quantity(s)—e.g., the candidate/new beam RS(s) or RS resource(s) selected by the first report quantity(s) in form of resource indicator(s) such as SSBRI(s) and/or CRI(s) from the set of candidate/new beam RS(s) or RS resource(s) for TCI state(s)/beam(s) switching or update. The UE could determine or identify the candidate/new beam RS(s) or RS resource(s) for TCI state(s)/beam(s) switching or update—e.g., when/if the UE reporting triggered or initiated TCI state(s)/beam(s) switching or update is enabled—according to or based on or following:
In one example, the candidate/new beam RS(s) or RS resource(s) for TCI state(s)/beam(s) switching or update could correspond to or could comprise one or more (or all) of the RS(s) or RS resource(s)—in terms/form the corresponding RS or RS resource ID(s)/index(es)—associated, specific or corresponding to one or more (or all) of the TCI state(s) activated or indicated or provided by/in a/the (unified) TCI state(s) activation/deactivation MAC CE command according to or following those specified/defined herein in the present disclosure.
In another example, according to or following those specified/defined herein in the present disclosure, a UE could be provided or configured by the network via/by/in higher layer RRC signaling(s)/parameter(s) such as CSI-ReportConfig and/or UEI-ReportConfig that provides or configures necessary information and/or setting(s) for the UE-initiated/event-driven beam operations including beam reporting and/or switching as specified/defined herein in the present disclosure, a list/set/pool of candidate/new beam RS(s) or RS resource(s)—in terms/form the corresponding RS/RS resource ID(s) or index(es)—for event(s) evaluation(s), beam(s) measurement/reporting, beam(s) activation/deactivation and/or beam(s) switching/update. In this case, the UE could determine or identify the RS(s) or RS resource(s) from the list/set/pool of candidate/new beam RS(s) or RS resource(s) that has the same value(s) as one or more (or all) of the RS(s) or RS resource(s)—in terms/form the corresponding RS or RS resource ID(s)/index(es)—associated, specific or corresponding to one or more (or all) of the TCI state(s) activated or indicated or provided by/in a/the (unified) TCI state(s) activation/deactivation MAC CE command according to or following those specified/defined herein in the present disclosure as the candidate/new beam RS(s) or RS resource(s) for TCI state(s)/beam(s) switching or update.
In another example, according to or following those specified/defined herein in the present disclosure, a UE could be provided or configured by the network via/by/in higher layer RRC signaling(s)/parameter(s) such as CSI-ReportConfig and/or UEI-ReportConfig that provides or configures necessary information and/or setting(s) for the UE-initiated/event-driven beam operations including beam reporting and/or switching as specified/defined herein in the present disclosure, a list/set/pool of candidate/new beam RS(s) or RS resource(s)—in terms/form the corresponding RS/RS resource ID(s) or index(es)—for event(s) evaluation(s), beam(s) measurement/reporting, beam(s) activation/deactivation and/or beam(s) switching/update. In this case, when/if a RS or RS resource—in terms/form the corresponding RS/RS resource ID or index—associated, specific or corresponding to a TCI state activated or indicated or provided by/in a/the (unified) TCI state(s) activation/deactivation MAC CE command according to or following those specified/defined herein in the present disclosure is not in the list/set/pool, the UE could incorporate, include or comprise the RS or RS resource in the list/set/pool. The UE could then determine or identify the RS(s) or RS resource(s) from the list/set/pool that has the same value(s) as one or more (or all) of the RS(s) or RS resource(s)—in terms/form the corresponding RS or RS resource ID(s)/index(es)—associated, specific or corresponding to one or more (or all) of the TCI state(s) activated or indicated or provided by/in a/the (unified) TCI state(s) activation/deactivation MAC CE command according to or following those specified/defined herein in the present disclosure as the candidate/new beam RS(s) or RS resource(s) for TCI state(s)/beam(s) switching or update.

Furthermore, when/if the UE determines or identifies a candidate/new beam RS or RS resource for TCI state(s)/beam(s) switching or update according to a RS or RS resource—in terms/form the corresponding RS or RS resource ID/index—associated, specific or corresponding to a TCI state activated or indicated or provided by/in a/the (unified) TCI state(s) activation/deactivation MAC CE command according to or following those specified/defined herein in the present disclosure, the UE could be indicated or configured or provided by the network e.g. via higher layer RRC signaling(s)/parameter(s) e.g. CSI-ReportConfig, UEI-ReportConfig and/or etc. that provides or configures necessary information and/or setting(s) for the UE-initiated/event-driven beam operations including beam(s) reporting and/or switching, whether the candidate/new beam RS or RS resource for TCI state(s)/beam(s) switching or update could be or could correspond to a SSB or a NZP CSI-RS. For instance,
when/if a higher layer parameter candidateRsType provided or configured in the higher layer RRC signaling(s)/parameter(s) e.g. CSI-ReportConfig, UEI-ReportConfig and/or etc. that provides or configures necessary information and/or setting(s) for the UE-initiated/event-driven beam operations including beam(s) reporting and/or switching is set to ‘csirs’, the UE could determine or identify the candidate/new beam RS or RS resource for TCI state(s)/beam(s) switching or update according to or as a QCL source RS or RS resource e.g. an NZP CSI-RS resource or resource configuration provided or configured or indicated in a TCI state activated or indicated or provided by/in a/the (unified) TCI state(s) activation/deactivation MAC CE command according to or following those specified/defined herein in the present disclosure, and/or
when/if the higher layer parameter candidateRsType provided or configured in the higher layer RRC signaling(s)/parameter(s) e.g. CSI-ReportConfig, UEI-ReportConfig and/or etc. that provides or configures necessary information and/or setting(s) for the UE-initiated/event-driven beam operations including beam(s) reporting and/or switching is set to ‘ssb’, the UE could determine or identify the candidate/new beam RS or RS resource for TCI state(s)/beam(s) switching or update according to or as a QCL root RS or RS resource e.g. a SSB quasi-co-located (QCL'ed)—e.g., of QCL-TypeD—with a RS or RS resource serving/configured as a QCL source RS e.g. a NZP CSI-RS resource or resource configuration provided or indicated a TCI state activated or indicated or provided by/in a/the (unified) TCI state(s) activation/deactivation MAC CE command according to or following those specified/defined herein in the present disclosure.

In addition, the candidate/new beam RS(s) or RS resource(s) associated, corresponding, linked, mapped or specific to the second report quantity(s)—e.g., the candidate/new beam RS(s) or RS resource(s) selected by the second report quantity(s) in form of resource indicator(s) such as SSBRI(s) and/or CRI(s) from the list/set/pool of candidate/new beam RS(s) or RS resource(s) and/or the set of candidate/new beam RS(s) or RS resource(s) for TCI state(s)/beam(s) switching/update—may not satisfy condition(s) of the corresponding event(s), or equivalently, the UE may not determine the corresponding event(s) according to those specified/defined herein in the present disclosure based on the candidate/new beam RS(s) or RS resource(s) associated, corresponding, linked, mapped or specific to the second report quantity(s)—e.g., the candidate/new beam RS(s) or RS resource(s) selected by the second report quantity(s) in form of resource indicator(s) such as SSBRI(s) and/or CRI(s) from the list/set/pool of candidate/new beam RS(s) or RS resource(s) and/or the set of candidate/new beam RS(s) or RS resource(s) for TCI state(s)/beam(s) switching/update.

Throughout the present disclosure, a candidate/new beam RS or RS resource could be equivalent to or could correspond to or could be referred to as a candidate/new beam RS or RS resource for TCI state(s)/beam(s) switching/update (e.g., in terms of event(s) evaluation(s) and/or corresponding beam(s) reporting) or vice versa, wherein the candidate/new beam RS or RS resource for TCI state(s)/beam(s) switching/update could be used or applied to determine or identify a first report quantity as specified/defined herein in the present disclosure and/or determine corresponding event(s) according to or following those specified/defined herein in the present disclosure.

According to or following those specified/defined herein in the present disclosure, the UE could (expect or assume to) receive from the network a one-bit ACK/NACK indicator (as an NWR) in response to the reported first report quantity(s), when/if:
there is only one reported first report quantity—i.e., Format-1a and/or Format-2a as specified/defined herein in the present disclosure—for or specific to the UE reporting triggered or initiated TCI state(s)/beam(s) switching/update, and/or
the TCI state(s)—and/or the RS(s) or RS resource(s) corresponding, associated or specific to the TCI state(s) associated, corresponding or specific to or indicated by the reported first report quantity(s) is from the activated TCI state(s)—and therefore, the RS(s) or RS resource(s) corresponding, associated or specific to the activated TCI state(s)—indicated by/in a/the (unified) TCI state(s) activation or deactivation MAC CE, and/or
the TCI state(s)—and/or the RS(s) or RS resource(s) corresponding, associated or specific to the TCI state(s)—associated, corresponding or specific to or indicated by the reported first report quantity(s) is not from the activated TCI state(s)—and therefore, the RS(s) or RS resource(s) corresponding, associated or specific to the activated TCI state(s)—by/in a/the (unified) TCI state(s) activation or deactivation MAC CE.

According to or following those specified/defined herein in the present disclosure, the one-bit ACK/NACK indicator could be realized/implemented by/via repurposing one or more codepoints of one or more existing DCI fields (e.g., a/the TPMI field and/or a/the TCI field) in the corresponding DCI format(s). For instance, the one-bit ACK/NACK indicator could correspond to the LSB (or MSB) of the TPMI/TCI field in the corresponding DCI format(s)—in this case, when/if the NWR is a multi-bit (e.g. u-bit with u>1) indicator as specified/defined herein in the present disclosure, it could correspond to the u>1 LSBs (or u>1 MSBs) of the TPMI/TCI field in the corresponding DCI format(s).

Optionally, according to or following those specified/defined herein in the present disclosure, the UE could (expect or assume to) receive from the network TCI state(s) update (as an NWR) in response to the reported first report quantity(s) wherein the TCI state(s) could be indicated by a TCI codepoint in the TCI field of a beam indication DCI (e.g., DCI format 1_1/1_2 with or without DL assignment), when/if:
there is only one reported first report quantity—i.e., Format-1a and/or Format-2a as specified/defined herein in the present disclosure—for or specific to the UE reporting triggered or initiated TCI state(s)/beam(s) switching/update, and/or
there are multiple (or more than one) reported first report quantities—i.e., Format-1b and/or Format-2b as specified/defined herein in the present disclosure—for or specific to the UE reporting triggered or initiated TCI state(s)/beam(s) switching/update, and/or
the TCI state(s)—and/or the RS(s) or RS resource(s) corresponding, associated or specific to the TCI state(s)—associated, corresponding or specific to or indicated by the reported first report quantity(s) is from the activated TCI state(s)—and therefore, the RS(s) or RS resource(s) corresponding, associated or specific to the activated TCI state(s)—indicated by/in a/the (unified) TCI state(s) activation or deactivation MAC CE.

According to or following those specified or defined herein in the present disclosure, when/if
the candidate/new beam RS(s) or RS resource(s) for TCI state(s)/beam(s) switching or update corresponds to or comprises one or more (or all) of the RS(s) or RS resource(s)—in terms/form the corresponding RS or RS resource ID(s)/index(es)—associated, specific or corresponding to one or more (or all) of the TCI state(s) activated or indicated or provided by/in a/the (unified) TCI state(s) activation/deactivation MAC CE command according to or following those specified/defined herein in the present disclosure, and/or
the UE determines or identifies the RS(s) or RS resource(s) from the list/set/pool of candidate/new beam RS(s) or RS resource(s) that has the same value(s) as one or more (or all) of the RS(s) or RS resource(s)—in terms/form the corresponding RS or RS resource ID(s)/index(es)—associated, specific or corresponding to one or more (or all) of the TCI state(s) activated or indicated or provided by/in a/the (unified) TCI state(s) activation/deactivation MAC CE command according to or following those specified/defined herein in the present disclosure as the candidate/new beam RS(s) or RS resource(s) for TCI state(s)/beam(s) switching or update,
   the UE could (expect or assume to) receive from the network TCI state(s) update (as an NWR) in response to the reported first report quantity(s) wherein the TCI state(s) could be indicated by a TCI codepoint in the TCI field of a beam indication DCI (e.g., DCI format 1_1/1_2 with or without DL assignment), and/or a one-bit ACK/NACK indicator (as an NWR) in response to the reported first report quantity(s).

According to or following those specified or defined herein in the present disclosure, when/if
the candidate/new beam RS(s) or RS resource(s) for TCI state(s)/beam(s) switching or update does not correspond to or comprise any of the RS(s) or RS resource(s)—in terms/form the corresponding RS or RS resource ID(s)/index(es)—associated, specific or corresponding to any of the TCI state(s) activated or indicated or provided by/in a/the (unified) TCI state(s) activation/deactivation MAC CE command according to or following those specified/defined herein in the present disclosure, and/or
the UE would not or does not or is not expected to or is not configured/enabled to determine or identify any RS(s) or RS resource(s) from the list/set/pool of candidate/new beam RS(s) or RS resource(s) that has the same value(s) as one or more (or all) of the RS(s) or RS resource(s)—in terms/form the corresponding RS or RS resource ID(s)/index(es)—associated, specific or corresponding to one or more (or all) of the TCI state(s) activated or indicated or provided by/in a/the (unified) TCI state(s) activation/deactivation MAC CE command according to or following those specified/defined herein in the present disclosure as the candidate/new beam RS(s) or RS resource(s) for TCI state(s)/beam(s) switching or update,
   the UE could (expect or assume to) receive a one-bit ACK/NACK indicator (as an NWR) in response to the reported first report quantity(s).

For Mode A, Mode B and/or Mode C as specified/defined herein in the present disclosure, the UE could determine or identify one or more periodic PUCCH resources (or transmission occasions (TOs)) of the first UL channel as in Step-1 to send or transmit a PN message/trigger (or a UE-initiated transmission indicator (UEITI) or a UE-initiated report request (UEIRR)) to (i) request UL grant/resource(s) in form of e.g. DG PUSCH(s) to carry or convey UEI report(s) and/or the corresponding UEI report content(s)/quantity(s) comprising at least first report quantity(s) for or specific to the UE reporting triggered or initiated TCI state(s)/beam(s) switching/update, or (ii) notify or indicate transmission(s) of UEI report(s) and/or the corresponding UEI report content(s)/quantity(s) comprising at least first report quantity(s) for or specific to the UE reporting triggered or initiated TCI state(s)/beam(s) switching/update over/on/by/in one or more (CG Type1/2) PUSCH resources of the second UL channel as in Step-2 of Mode B associated, mapped, linked or specific to the one or more periodic PUCCH resources (or TOs).
The UE could determine or identify that the one or more periodic PUCCH resources of the first UL channel could be dedicated for the UE reporting triggered or initiated TCI state(s)/beam(s) switching or update according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). For example, higher layer parameter(s)/signaling(s) that provides or configures the one or more periodic PUCCH resources—e.g., PUCCH-Config, PUCCH-Resource and/or etc.—could configure, provide or comprise a higher layer parameter firstPucchForBeamSwitching and/or set to ‘enabled’. For another example, the UE could be provided or configured or indicated by the network, e.g., via/in/by a CSI reporting setting that provides or configures necessary information and/or setting(s) for the UE reporting triggered or initiated TCI state(s)/beam(s) switching or update, the one or more PUCCH resources dedicated for the UE reporting triggered or initiated TCI state(s)/beam(s) switching or update, wherein higher layer parameter(s)/signaling(s) that provides or configures the CSI reporting setting—e.g., CSI-ReportConfig, UEI-ReportConfig and/or etc.—could configure, provide or comprise a higher layer parameter firstPucchForBeamSwitching and/or set to ‘enabled’. For another example, according to or following those specified herein in the present disclosure, the UE could be provided or configured or indicated by the network, e.g., via/in/by a CSI reporting setting that provides or configures necessary information and/or setting(s) for the UE-initiated/event-driven beam operations including beam(s) reporting and/or switching, one or more PUCCH resources (or TOs) for transmitting the PN message/trigger (or the UEITI/UEIRR); in this case, the higher layer parameter(s)/signaling(s) that provides or configures the CSI reporting setting—e.g., CSI-ReportConfig, UEI-ReportConfig and/or etc.—could configure, provide or comprise a bitmap with each entry/bit position of the bitmap corresponding or specific or associated to a PUCCH resource (or TO); when/if an entry/bit position of the bitmap is set to ‘1’(or ‘0’), the PUCCH resource/TO associated, corresponding or specific to the entry/bit position could correspond to a PUCCH resource dedicated for the UE reporting triggered or initiated TCI state(s)/beam(s) switching or update.
The UE could expect to receive a trigger state—indicated by the CSI request field of/in the corresponding DCI as in Step-2 of Mode A/C—dedicated for or specific to the UE reporting triggered or initiated TCI state(s)/beam(s) switching or update (hence, the CSI reporting setting(s) corresponding, associated or specific to the trigger state could be dedicated for or specific to the UE reporting triggered or initiated TCI state(s)/beam(s) switching or update). The UE could determine or identify that the trigger state (hence, the corresponding CSI reporting setting(s)) could be dedicated for the UE reporting triggered or initiated TCI state(s)/beam(s) switching or update according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). For instance, higher layer parameter(s)/signaling(s) that provides or configures the CSI reporting setting(s)—e.g., CSI-ReportConfig(s), UEI-ReportConfig(s) and/or etc.—could configure, provide or comprise a higher layer parameter firstPucchForBeamSwitching and/or set to ‘enabled’. Optionally, the trigger state can be from a list of trigger state(s) higher layer configured/provided to the UE (specifically or dedicated) for the UE reporting triggered or initiated TCI state(s)/beam(s) switching or update.
The UE could determine or identify that the one or more PUSCH resources of the second UL channel could be dedicated for the UE reporting triggered or initiated TCI state(s)/beam(s) switching or update according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). For example, for Mode A/C, the UE could determine or identify the DG PUSCH(s) is for or specific to the UE reporting triggered or initiated TCI state(s)/beam(s) switching or update when/if the corresponding trigger state (and/or the corresponding CSI reporting setting(s)) indicated by the CSI request field in the corresponding scheduled DCI is associated or corresponding or specific to or for the UE reporting triggered or initiated beam(s)/TCI state(s) switching or update according to or following those specified/defined herein in the present disclosure. For another example, for Mode B, the UE could determine or identify the CG PUSCH(s) is for or specific to the UE reporting triggered or initiated TCI state(s)/beam(s) switching or update when/if the PUCCH(s) of the first UL channel associated or linked or mapped to the CG PUSCH(s) of the second UL channel is associated or corresponding or specific to or for the UE reporting triggered or initiated beam(s)/TCI state(s) switching or update according to or following those specified/defined herein in the present disclosure. For example, higher layer parameter(s)/signaling(s) that provides or configures the one or more PUSCH resources—e.g., PUSCH-Config, ConfiguredGrant, PUSCH-Resource and/or etc.—could configure, provide or comprise a higher layer parameter secondPuschForBeamSwitching and/or set to ‘enabled’. For another example, the UE could be provided or configured or indicated by the network, e.g., via/in/by a CSI reporting setting that provides or configures necessary information and/or setting(s) for the UE reporting triggered or initiated TCI state(s)/beam(s) switching or update, the one or more PUSCH resources dedicated for the UE reporting triggered or initiated TCI state(s)/beam(s) switching or update, wherein higher layer parameter(s)/signaling(s) that provides or configures the CSI reporting setting—e.g., CSI-ReportConfig, UEI-ReportConfig and/or etc.—could configure, provide or comprise a higher layer parameter secondPuschForBeamSwitching and/or set to ‘enabled’. For another example, according to or following those specified herein in the present disclosure, the UE could be provided or configured or indicated by the network, e.g., via/in/by a CSI reporting setting that provides or configures necessary information and/or setting(s) for the UE-initiated/event-driven beam operations including beam(s) reporting and/or switching, one or more PUSCH resources (or TOs) for transmitting the UEI report(s) and/or the corresponding UEI report content(s)/quantity(s); in this case, the higher layer parameter(s)/signaling(s) that provides or configures the CSI reporting setting—e.g., CSI-ReportConfig, UEI-ReportConfig and/or etc.—could configure, provide or comprise a bitmap with each entry/bit position of the bitmap corresponding or specific or associated to a PUSCH resource (or TO); when/if an entry/bit position of the bitmap is set to ‘1’ (or ‘0’), the PUSCH resource/TO associated, corresponding or specific to the entry/bit position could correspond to a PUSCH resource dedicated for the UE reporting triggered or initiated TCI state(s)/beam(s) switching or update.

Throughput the present disclosure, when/if an NWR e.g. in form/terms of a one-bit ACK/NACK indicator is indicated by/in a DCI, presence or absence of the NWR in the corresponding DCI format(s) could be enabled (or disabled) and/or configured or provided by the network e.g. via/by/in corresponding higher layer RRC signaling(s)/parameter(s). For instance, when/if a higher layer parameter oneBitIndicator is provided or configured in the higher layer RRC signaling(s)/parameter(s) e.g. CSI-ReportConfig, UEI-ReportConfig and/or etc. that provides or configures necessary information and/or setting(s) for the UE-initiated/event-driven beam operations including beam(s) reporting and/or switching and/or is set to ‘enabled’, the UE could expect or assume to receive an NWR e.g. in form/terms of a one-bit ACK/NACK indicator as specified/defined herein in the present disclosure by/in the corresponding DCI format(s); otherwise, e.g., when/if the higher layer parameter oneBitIndicator is not provided/configured, or is provided/configured but set to ‘disabled’, in the higher layer RRC signaling(s)/parameter(s) e.g. CSI-ReportConfig, UEI-ReportConfig and/or etc. that provides or configures necessary information and/or setting(s) for the UE-initiated/event-driven beam operations including beam(s) reporting and/or switching, the UE may not expect or assume to receive an NWR e.g. in form/terms of a one-bit ACK/NACK indicator as specified/defined herein in the present disclosure by/in the corresponding DCI format(s)—in this case, instead, the UE could expect or assume to receive another (or a different) NWR e.g. in form/terms of TCI state(s) update via TCI codepoint(s) of the corresponding TCI field(s) in/by the corresponding DCI.

Throughout the present disclosure, a (first or second) report quantity could correspond to or could comprise one or more of:
a resource indicator such as a SSBRI or a CRI
a TCI state ID/index
a resource indicator such as a SSBRI or a CRI and its corresponding or associated beam metric such as a L1-RSRP or a L1-SINR
a TCI state ID/index (or a TCI codepoint ID/index mapped to a TCI state ID/index) and its corresponding or associated beam metric such as a L1-RSRP or a L1-SINR.

Or, when/if a UE reports or transmits or sends, in a reporting instance/CSI report, a first (or second) report quantity as specified/defined herein in the present disclosure, the UE could also report or transmit or send, in the same reporting instance/CSI report, a beam metric such as a L1-RSRP/L1-SINR associated or corresponding to the first (or second) report quantity. Furthermore, throughout the present disclosure, a (reported) beam could also be equivalent to or referred to as a (reported) first (or second) report quantity—and/or the corresponding beam metric—as specified/defined herein in the present disclosure. Hence, when/if a TCI state is indicated by or associated, mapped, linked, corresponding or specific to a (first or second) report quantity,
when/if the (first or second) report quantity is in form/terms of a TCI state ID/index, the TCI state has the same TCI state ID/index
when/if the (first or second) report quantity is in form/terms of TCI codepoint ID/index (mapped to a TCI state ID/index), the TCI state has the same TCI state ID/index
when/if the (first or second) report quantity is in form/terms of a resource indicator such as a SSBRI/CRI, the resource indicator could correspond to a RS or RS resource associated, specific or corresponding to the TCI state according to or following those specified/defined herein in the present disclosure.

Throughout the present disclosure, a TCI state associated, specific or corresponding to a RS or RS resource (or vice versa) could correspond to or could be equivalent to or could be referred to/regarded as:
the RS or RS resource could correspond to a QCL source RS or RS resource e.g. a NZP CSI-RS resource or resource configuration provided or indicated in the TCI state; and/or
the RS or RS resource could correspond to a QCL root RS or RS resource e.g. a SSB quasi-co-located (QCL'ed)—e.g., of QCL-TypeD—with a RS or RS resource serving/configured as a QCL source RS e.g. a NZP CSI-RS resource or resource configuration provided or indicated in the TCI state.

Throughout the present disclosure, indication, signaling and/or transmission (from/to a/the UE and/or the network) of a TCI state ID/index corresponding or associated or specific to a TCI state could be equivalent to indication, signaling and/or transmission (from/to a/the UE and/or the network) of a TCI codepoint index corresponding or associated or specific to a TCI codepoint mapped to or comprising the TCI state, and vice versa. For example, according to or following those specified or defined herein in the present disclosure, a first report quantity corresponding to or in form of a TCI state ID/index corresponding or associated or specific to a TCI state could be equivalent to a first report quantity corresponding to or in form of a TCI codepoint index corresponding or associated or specific to a TCI codepoint mapped to or comprising the TCI state, and vice versa. For another example, according to or following those specified or defined herein in the present disclosure, an NWR as specified/defined herein in the present disclosure corresponding to or in form of a TCI state ID/index corresponding or associated or specific to a TCI state could be equivalent to an NWR corresponding to or in form of a TCI codepoint index corresponding or associated or specific to a TCI codepoint mapped to or comprising the TCI state, and vice versa.

Throughout the present disclosure, indication, signaling and/or transmission (from/to a/the UE and/or the network) of a RS or RS resource ID/index specific to or for a RS or RS resource corresponding or associated or specific to a TCI state could be equivalent to indication, signaling and/or transmission (from/to a/the UE and/or the network) of a TCI codepoint index corresponding or associated or specific to a TCI codepoint mapped to or comprising the TCI state, and vice versa. For example, according to or following those specified or defined herein in the present disclosure, a first report quantity corresponding to or in form of a RS or RS resource ID/index specific to or for a RS or RS resource corresponding or associated or specific to a TCI state could be equivalent to a first report quantity corresponding to or in form of a TCI codepoint index corresponding or associated or specific to a TCI codepoint mapped to or comprising the TCI state, and vice versa. For another example, according to or following those specified or defined herein in the present disclosure, an NWR as specified/defined herein in the present disclosure corresponding to or in form of a RS or RS resource ID/index specific to or for a RS or RS resource corresponding or associated or specific to a TCI state could be equivalent to an NWR corresponding to or in form of a TCI codepoint index corresponding or associated or specific to a TCI codepoint mapped to or comprising the TCI state, and vice versa.

Throughout the present disclosure, a PN message/trigger as specified/defined herein in the present disclosure (e.g., in both Mode A and Mode B) could be associated to one or more CSI reporting settings each provided by CSI-ReportConfig or UEI-ReportConfig. The UE could determine or identify the association according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). For instance, a/the first PN message/trigger as specified/defined herein in the present disclosure could be associated to a first CSI reporting setting provided by CSI-ReportConfig (with a first reportConfigId), and a/the second PN message/trigger as specified/defined herein in the present disclosure could be associated to a second CSI reporting setting provided by CSI-ReportConfig (with a second reportConfigId), wherein the first reportConfigId could be identical to/the same as or different/separate from the second reportConfigId. In this case, the UE could determine or identify UL resource(s)/occasion(s) for transmitting a/the first (UEI) beam report triggered or indicated by the first PN message/trigger according to or following those specified herein in the present disclosure based on or according to the information and/or setting(s) and/or parameter(s) provided or configured in the first CSI reporting setting, and/or the UE could determine or identify UL resource(s)/occasion(s) for transmitting a/the second (UEI) beam report triggered or indicated by the second PN message/trigger according to or following those specified herein in the present disclosure based on or according to the information and/or setting(s) and/or parameter(s) provided or configured in the second CSI reporting setting. Furthermore, a NWR could be associated or corresponding or specific to a NWR ID such that the higher layer parameter(s)/signaling(s) that provides or configures the NWR (e.g., TCI-State that configures or provides a TCI state) could comprise, include, contain, provide or configure the corresponding NWR ID (e.g., a TCI State ID/index)—or equivalently, a configuration ID/index value could be provided or configured or comprised or included or contained in higher layer parameter(s)/signaling(s) that provides or configures a NWR (e.g., TCI-State that configures or provides a TCI state), and in this case, the configuration ID/index could be regarded/referred to as a/the NWR ID associated, specific, corresponding or linked to the NWR.

Throughout the present disclosure, transmitting or transmission(s) of or re-transmission(s) of a PUCCH of the first UL channel as in Step-1 of Mode A, Mode B and/or Mode C according to or following those specified/defined herein in the present disclosure could be equivalent to transmitting or transmission(s) of or re-transmission(s) of a PN message/trigger over/in/by a PUCCH resource of the first UL channel as in Step-1 of Mode A, Mode B and/or Mode C according to or following those specified/defined herein in the present disclosure. Similarly, transmitting, transmission(s) of or re-transmission(s) of beam report(s), e.g., the UEI beam report(s) as specified/defined herein in the present disclosure, via/by/in (DG or CG) PUSCH resource(s) of the second UL channel as in Step-2 of Mode B and/or Step-3 of Mode A and/or Mode C according to or following those specified/defined herein in the present disclosure is equivalent to transmitting, transmission(s) of or re-transmission(s) of PUSCH(s) or PUSCH resource(s) of the second UL channel as in Step-2 of Mode B and/or Step-3 of Mode A and/or Mode C carrying beam report(s), e.g., the UEI beam report(s) as specified/defined herein in the present disclosure, according to or following those specified/defined herein in the present disclosure. The UE could be provided or configured by the network, e.g., via higher layer RRC signalling(s)/parameter(s) e.g.firstPUCCHResourceConfg-UEIBR, a configuration for PUCCH transmission of the first UL channel as in Step-1 of Mode A, Mode B and/or Mode C with a/the report notification (RN) or report resource request (RRR), wherein a/the RN or RRR could be of a UCI type/parameter. Furthermore, the UE could be provided or configured by the network, e.g., via higher layer RRC signalling(s)/parameter(s) e.g. secondPUSCHResourceConfig-UEIBR, a configuration for PUSCH transmission of the second UL channel as in Step-2 of Mode B.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc. A/the higher layer parameter CSI-ReportConfig and/or UEI-ReportConfig could correspond to or could be equivalent to or referred to a/the higher layer parameter CSI-AssociatedReportConfigInfo, and vice versa, such that they could be used or applied exchangeably or in similar/same manner(s) throughout the present disclosure. Additionally, a CSI reporting setting not (dedicated) for the UE-initiated/event-driven beam reporting as specified/defined herein in the present disclosure could correspond to or could be equivalent to or could be referred to a CSI reporting setting for (legacy) aperiodic CSI/beam reporting or a CSI reporting setting for L1/L2 triggered mobility (LTM), and vice versa. In addition, a CSI reporting setting corresponding to another CSI reporting setting could be equivalent to the CSI reporting setting comprising, containing, including and/or providing the another CSI reporting setting.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s). Furthermore, a CSI report setting/CSI report configuration is equivalent to a CSI reporting setting/CSI reporting configuration and vice versa.

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE receiving first information related to UE-initiated beam switching (910). The UE then determines, based on the first information, a PUCCH resource to transmit a UE-initiated beam switching indicator (920). The UE then transmits the UE-initiated beam switching indicator on the PUCCH resource (930).

The UE then determines a PUSCH resource to transmit a UE-initiated beam switching report (940). In various embodiments, the first information includes a first configuration of an event for UE-initiated beam switching and a second configuration of one or more PUCCH resources. The UE determines an event based on the second configuration. The PUCCH resource is determined based on the event and the second configuration. The UE-initiated beam switching indicator is one bit. In various embodiments, the PUSCH resource is a dynamic grant PUSCH resource or a configured grant PUSCH resource where configuration of the configured grant PUSCH resource is included in the first information.

The UE then transmits, on the PUSCH resource, the UE-initiated beam switching report including second information related to a TCI state (950). In various embodiments, the second information includes a TCI state ID for the TCI state, a SSBRI corresponding to the TCI state, or a CRI corresponding to the TCI state. In some examples, the SSBRI corresponds to a SS/PBCH block QCLed with a reference signal in the TCI state and the CRI corresponds to a reference signal in the TCI state.

The UE then receives a response to the UE-initiated beam switching report (960). In various embodiments, the response is received within a time duration (T_{offset}) after completion of transmission of the report. The response is one of a one-bit ACK or the second information. T_{offset} is higher layer configured. The UE then applies the TCI state (970). In various embodiments, the TCI state is applied after a time duration (T_{gap}) from an end of reception of the response and T_{gap} is higher layer configured.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive first information related to UE-initiated beam switching; and
a processor operably coupled with the transceiver, the processor configured to determine, based on the first information, a physical uplink control channel (PUCCH) resource to transmit a UE-initiated beam switching indicator,
wherein the transceiver is further configured to transmit the UE-initiated beam switching indicator on the PUCCH resource,
wherein the processor is further configured to determine a physical uplink shared channel (PUSCH) resource to transmit a UE-initiated beam switching report,
wherein the transceiver is further configured to:
transmit, on the PUSCH resource, the UE-initiated beam switching report including second information related to a transmission configuration indication (TCI) state; and
receive a response to the UE-initiated beam switching report, and
wherein the processor is further configured to apply the TCI state.

2. The UE of claim 1, wherein:
the first information includes:
a first configuration of an event for UE-initiated beam switching; and
a second configuration of one or more PUCCH resources,
the processor is further configured to determine an event based on the second configuration,
the PUCCH resource is determined based on the event and the second configuration, and
the UE-initiated beam switching indicator is one bit.

3. The UE of claim 1, wherein the PUSCH resource is:
a dynamic grant PUSCH resource, or
a configured grant PUSCH resource where configuration of the configured grant PUSCH resource is included in the first information.

4. The UE of claim 1, wherein the second information includes:
a TCI state identity (ID) for the TCI state,
a synchronization signal/physical broadcast channel (SS/PBCH) block resource indicator (SSBRI) corresponding to the TCI state, or
a channel state information reference signal (CSI-RS) resource indicator (CRI) corresponding to the TCI state.

5. The UE of claim 4, wherein:
the SSBRI corresponds to a SS/PBCH block quasi-co-located (QCLed) with a reference signal in the TCI state, and
the CRI corresponds to a reference signal in the TCI state.

6. The UE of claim 1, wherein:
the response is received within a time duration (T_{offset}) after completion of transmission of the report,
the response is one of:
a one-bit acknowledgement (ACK), or
the second information, and
T_{offset} is higher layer configured.

7. The UE of claim 1, wherein:
the TCI state is applied after a time duration (T_{gap}) from an end of reception of the response, and
T_{gap} is higher layer configured.

8. A base station (BS), comprising:
a processor; and
a transceiver operably coupled with the transceiver, the transceiver configured to:
transmit first information related to a user equipment (UE)-initiated beam switching, wherein the first information indicates a physical uplink control channel (PUCCH) resource for a UE-initiated beam switching indicator;
receive the UE-initiated beam switching indicator on the PUCCH resource;
receive, on a physical uplink shared channel (PUSCH) resource, a UE-initiated beam switching report including second information related to a transmission configuration indication (TCI) state; and
transmit a response to the UE-initiated beam switching report.

9. The BS of claim 8, wherein:
the first information includes:
a first configuration of an event for UE-initiated beam switching; and
a second configuration of one or more PUCCH resources,
an event is indicated based on the second configuration,
the PUCCH resource is based on the event and the second configuration, and
the UE-initiated beam switching indicator is one bit.

10. The BS of claim 8, wherein the PUSCH resource is:
a dynamic grant PUSCH resource, or
a configured grant PUSCH resource where configuration of the configured grant PUSCH resource is included in the first information.

11. The BS of claim 8, wherein the second information includes:
a TCI state identity (ID) for the TCI state,
a synchronization signal/physical broadcast channel (SS/PBCH) block resource indicator (SSBRI) corresponding to the TCI state, or
a channel state information reference signal (CSI-RS) resource indicator (CRI) corresponding to the TCI state.

12. The BS of claim 11, wherein:
the SSBRI corresponds to a SS/PBCH block quasi-co-located (QCLed) with a reference signal in the TCI state, and
the CRI corresponds to a reference signal in the TCI state.

13. The BS of claim 8, wherein:
the response is transmitted within a time duration (T_{offset}) after completion of reception of the report,
the response is one of:
a one-bit acknowledgement (ACK), or
the second information, and
T_{offset} is higher layer configured.

14. The BS of claim 8, wherein:
the TCI state is applied after a time duration (T_{gap}) from an end of transmission of the response, and
T_{gap} is higher layer configured.

15. A method performed by a user equipment (UE), the method comprising:
receiving first information related to UE-initiated beam switching;
determining, based on the first information, a physical uplink control channel (PUCCH) resource to transmit a UE-initiated beam switching indicator;
transmitting the UE-initiated beam switching indicator on the PUCCH resource;
determining a physical uplink shared channel (PUSCH) resource to transmit a UE-initiated beam switching report;
transmitting, on the PUSCH resource, the UE-initiated beam switching report including second information related to a transmission configuration indication (TCI) state;
receiving a response to the UE-initiated beam switching report; and
applying the TCI state.

16. The method of claim 15, wherein:
the first information includes:
a first configuration of an event for UE-initiated beam switching; and
a second configuration of one or more PUCCH resources,
the method further comprises determining an event based on the second configuration,
the PUCCH resource is determined based on the event and the second configuration, and
the UE-initiated beam switching indicator is one bit.

17. The method of claim 15, wherein the PUSCH resource is:
a dynamic grant PUSCH resource, or
a configured grant PUSCH resource where configuration of the configured grant PUSCH resource is included in the first information.

18. The method of claim 15, wherein the second information includes:
a TCI state identity (ID) for the TCI state,
a synchronization signal/physical broadcast channel (SS/PBCH) block resource indicator (SSBRI) corresponding to the TCI state, or
a channel state information reference signal (CSI-RS) resource indicator (CRI) corresponding to the TCI state.

19. The method of claim 18, wherein:
the SSBRI corresponds to a SS/PBCH block quasi-co-located (QCLed) with a reference signal in the TCI state, and
the CRI corresponds to a reference signal in the TCI state.

20. The method of claim 15, wherein:
the response is received within a time duration (T_{offset}) after completion of transmission of the report,
the response is one of:
a one-bit acknowledgement (ACK), or
the second information, and
T_{offset} is higher layer configured.
